(19) United States
(12) Patent Application Publication
(10) Pub. No.: US 2016/0377139 A1
(43) Pub. Date: Dec. 29, 2016

(54) VIBRATION DAMPENING MATERIAL

(71) Applicant: Robert A. Vito, Kennett Square, PA (US)

(72) Inventor: Robert A. Vito, Kennett Square, PA (US)

(21) Appl. No.: 15/085,274

(22) Filed: Mar. 30, 2016

Related U.S. Application Data
(63) Continuation-in-part of application No. 13/944,131, filed on Jul. 17, 2013.
Application No. 13/944,131 is a division of application No. 13/084,866, filed on Apr. 12, 2011, now abandoned.
Application No. 13/084,866 is a continuation-in-part of application No. 12/570,499, filed on Sep. 30, 2009, now abandoned.
Application No. 12/570,499 is a continuation-in-part of application No. 11/873,825, filed on Oct. 17, 2007, now Pat. No. 8,413,262.
Application No. 11/873,825 is a continuation-in-part of application No. 11/635,939, filed on Dec. 8, 2006, now abandoned.
Application No. 11/635,939 is a continuation-in-part of application No. 11/304,995, filed on Dec. 15, 2005, now abandoned.
Application No. 11/304,995 is a continuation-in-part of application No. 11/019,568, filed on Dec. 22, 2004, now Pat. No. 7,171,697.
Application No. 11/635,939 is a continuation-in-part of application No. 11/304,079, filed on Dec. 15, 2005, now abandoned.
Application No. 11/304,079 is a continuation-in-part of application No. 11/019,568, filed on Dec. 22, 2004, now Pat. No. 7,171,697.
Application No. 11/019,568 is a continuation-in-part of application No. 10/999,246, filed on Nov. 30, 2004, now abandoned.
Application No. 10/999,246 is a continuation-in-part of application No. 10/958,745, filed on Oct. 5, 2004, now Pat. No. 8,142,382.
Application No. 10/958,745 is a continuation-in-part of application No. 10/856,215, filed on May 28, 2004, now Pat. No. 6,942,586.
Application No. 10/999,246 is a continuation-in-part of application No. 10/958,952, filed on Oct. 5, 2004, now abandoned.
Application No. 10/958,952 is a continuation-in-part of application No. 10/856,215, filed on May 28, 2004, now Pat. No. 6,942,586.
Application No. 10/999,246 is a continuation-in-part of application No. 10/958,767, filed on Oct. 5, 2004, now abandoned.
Application No. 10/958,767 is a continuation-in-part of application No. 10/856,215, filed on May 28, 2004, now Pat. No. 6,942,586.
Application No. 10/999,246 is a continuation-in-part of application No. 10/958,941, filed on Oct. 5, 2004, now abandoned.
Application No. 10/958,941 is a continuation-in-part of application No. 10/856,215, filed on May 28, 2004, now Pat. No. 6,942,586.
Application No. 10/999,246 is a continuation-in-part of application No. 10/958,611, filed on Oct. 5, 2004, now Pat. No. 7,150,113.
Application No. 10/958,611 is a continuation-in-part of application No. 10/856,215, filed on May 28, 2004, now Pat. No. 6,942,586.
Application No. 10/856,215 is a continuation of application No. 10/659,560, filed on Sep. 10, 2003, now Pat. No. 6,935,973.
Application No. 10/659,560 is a division of application No. 09/939,319, filed on Aug. 27, 2001, now Pat. No. 6,652,398.
(60) Provisional application No. 62/269,723, filed on Dec. 18, 2015.
(60) Provisional application No. 62/155,193, filed on Apr. 30, 2015.

(51) Int. Cl. F16F 3/093; B32B 25/02; B32B 25/14; B32B 25/18; B32B 25/20; A41D 13/015; F41C 23/10; F41C 23/18; A41B 1/08; A41D 1/06; A41D 13/05; B32B 5/18; B25G 1/01

(52) U.S. Cl. CPC F16F 3/093; B32B 5/18; B32B 25/02; B32B 25/14; B32B 25/18; B32B 25/20; B25G 1/01; F41C 23/10; F41C 23/18; A41B 1/08; A41D 1/06; A41D 13/0518; A41D 13/015; B32B 2266/08; B32B 2262/0269; B32B 2262/101; B60K 5/1208

(57) ABSTRACT

A vibration reducing assembly including a flexible headgear and at least one panel of vibration reducing material secured to the flexible headgear. The at least one panel of vibration reducing material includes at least a first elastomer layer and a reinforcement layer comprising a high tensile strength fibrous material.

### CROSS REFERENCE TO RELATED APPLICATIONS

This application is a continuation-in-part of U.S. patent application Ser. No. 13/944,131, filed Jul. 17, 2013, which is a Divisional of U.S. patent application Ser. No. 13/084,866, filed Apr. 12, 2011 which is a Continuation-in-Part of U.S. patent application Ser. No. 12/570,499 filed Sep. 30, 2009 which is a Continuation-in-Part of U.S. patent application Ser. No. 11/873,825 filed Oct. 17, 2007 (now U.S. Pat. No. 8,413,262, issued Apr. 9, 2003) and a Continuation-in-Part of U.S. patent application Ser. No. 11/635,939 filed Dec. 8, 2006 (Abandoned) which is a Continuation-in-Part of U.S. patent application Ser. No. 11/304,079 filed Dec. 15, 2005 (Abandoned) and a Continuation-in-Part of U.S. patent application Ser. No. 11/304,995 filed Dec. 15, 2005 (Abandoned), both of which are a Continuation-in-Part of U.S. patent application Ser. No. 11/019,568 filed Dec. 22, 2004 (now U.S. Pat. No. 7,171,697, issued Feb. 6, 2007), which is a Continuation-in-Part of U.S. patent application Ser. No. 10/999,246 filed Nov. 30, 2004, which is a Continuation-in-Part of U.S. patent application Ser. No. 10/958,611 filed Oct. 5, 2004 (now U.S. Pat. No. 7,150,113, issued Dec. 19, 2006), U.S. patent application Ser. No. 10/958,941 filed Oct. 5, 2004 (Abandoned), U.S. patent application Ser. No. 10/958,767 filed Oct. 5, 2004 (Abandoned), U.S. patent application Ser. No. 10/958,952 filed Oct. 5, 2004 (Abandoned) and U.S. patent application Ser. No. 10/958,745 filed Oct. 5, 2004 (now U.S. Pat. No. 8,142,382, issued Mar. 27, 2012), all of which are a Continuation-in-Part of U.S. patent application Ser. No. 10/856,215 filed May 28, 2004 (now U.S. Pat. No. 6,942,586, issued Sep. 13, 2005) which is a Continuation of U.S. patent application Ser. No. 10/659,560 filed Sep. 10, 2003 (now U.S. Pat. No. 6,935,973, issued Aug. 30, 2005) which is a Divisional of U.S. patent application Ser. No. 09/939,319 filed Aug. 27, 2001 (now U.S. Pat. No. 6,652,398, issued Nov. 25, 2003). This application also claims priority to U.S. 62/269,723, filed Dec. 18, 2015. Each of the aforementioned applications is incorporated herein by reference in its entirety.

### FIELD OF INVENTION

The present invention is directed to a material adapted to reduce vibration and, more specifically, to a multi-layer material adapted to dissipate and distribute vibrations.

### BACKGROUND

Handles of sporting equipment, bicycles, hand tools, etc. are often made of wood, metal or polymer that transmit vibrations that can make the items uncomfortable for prolonged gripping. Sporting equipment, such as bats, balls, shoe insoles and sidewalls, also transmit vibrations during the impact that commonly occurs during athletic contests. These vibrations can be problematic in that they can potentially distract the player's attention, adversely effect performance, and/or injure a portion of a player's body.

Rigid polymer materials are typically used to provide grips for tools and sports equipment. The use of rigid polymers allows users to maintain control of the equipment but is not very effective at reducing vibrations. While it is known that softer materials provide better vibration regulation characteristics, such materials do not have the necessary rigidity for incorporation into sporting equipment, hand tools, shoes or the like. This lack of rigidity allows unintended movement of the equipment encased by the soft material relative to a user's hand or body.

Prolonged or repetitive contact with excessive vibrations can injure a person. The desire to avoid such injury can result in reduced athletic performance and decreased efficiency when working with tools.

In another aspect, noise control solutions are becoming increasing critical in a vast array of fields including commercial and industrial equipment, consumer electronics, transportation, as well as countless other specialty areas. These applications require an efficient and economical sound insulating material with the ability to be adapted to fill a wide variety of damping requirements.

Viscoelastic materials are typically used in sound damping applications to provide hysteretic energy dissipation, meaning damping provided by the yielding or straining of the molecules of the material. These materials offer somewhat limited damping efficiency as a result of providing very few avenues for energy dissipation and absorption. Viscoelastic materials that do possess acceptable levels of energy dissipation do so at the expense of increased material thickness and further, fail to provide the structural stiffness required in many of today's applications. In contrast, conventional composite materials have high stiffness-to-weight ratios however they generally exhibit very poor damping characteristics.

### SUMMARY

The present invention provides a material that in at least one embodiment comprises a composite vibration dissipating and isolating material including first and second elastomer layers. A reinforcement layer is disposed between and generally separates the first and second elastomer layers.

### BRIEF DESCRIPTION OF THE DRAWINGS

The foregoing summary, as well as the following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentality shown. In the drawings:

FIG. 1 is a cross-sectional view of a preferred embodiment of the material of the present invention;

FIG. 2 is perspective view of the material of FIG. 1 configured to form a grip;

FIG. 2B is a perspective view of the material of FIG. 1 configured to form an alternative grip;

FIG. 3 is an elevational view of a baseball bat having a cover in the form of a sleeve on the handle area in accordance with this invention;

FIG. 4 is an enlarged fragmental cross-sectional view of the bat and sleeve shown in FIG. 3;

FIG. 5 is a schematic diagram showing the results in the application of shock forces on a cover in accordance with this invention;

FIG. 6 is a view similar to FIG. 4 showing an alternative sleeve mounted on a different implement;

FIG. 7 is a view similar to FIGS. 4 and 6 showing still yet another form of sleeve in accordance with this invention;

FIG. 8 is a cross-sectional longitudinal view showing an alternative cover in accordance with this invention mounted on a further type of implement

FIG. 9 is a cross-sectional end view of yet another cover in accordance with this invention;

FIG. 10 is an elevational view of a hammer incorporating a vibration dampening handle in accordance with this invention;

FIG. 11 is an elevational view showing a portion of a handlebar incorporating a vibration dampening cover in accordance with this invention; the handlebar grip can include an attached insert (that is also formed of the material of the present invention) that is located inside of a hollow in the handlebar to effectively cause the handlebar structure to become another layer of the material of the present invention (for example, if the handlebar is formed of a composite, then the composite material would just form another layer of the material of the present invention);

FIG. 12 is a view similar to FIG. 11 of yet another practice of this invention;

FIGS. 13-16 are plan views of various forms of the intermediate force dissipating layer which is used in certain practices of this invention; FIG. 13A is a cross-sectional view illustrating the stiffening layer as an impervious sheet applied to the elastomeric layer;

FIG. 17 is a perspective view of a portable electronic device case having a panel formed from the material of the present invention; the panel can form the entire case, or just portions of the case, without departing from the scope of the present invention; the illustrated case can be used with laptops, cell phones, GPS devices, portable music playing devices, such as MP3 players, walkie talkies, hand held video games, or the like without departing from the present invention;

FIG. 18 is a plan view of a shoe insert formed from the material of the present invention;

FIG. 19 is a perspective view of a shoe having a panel formed from the material of the present invention; while the panel is shown proximate to the heel of the shoe, the panel's size and placement can vary without departing from the scope of the present invention; for example, the panel can be positioned along a sidewall of the shoe, in the sole or mid-sole of the shoe, on the toe of the shoe, in the tongue of the shoe, or the panel can form the entire upper portion of the shoe, or the like;

FIG. 20 is a perspective view of a firearm with a grip having at least a panel formed by the material of the present invention; the grip can be entirely formed by the material of the present invention; while the grip is shown on a handgun, those of ordinary skill in the art will appreciate that the grip can be used on any rifle, shotgun, paint ball gun, or projectile launching device without departing from the present invention; the firearm grip can be a separate wrap around grip or can be a grip attached and/or molded to the firearm;

FIG. 21 is a perspective view of a sock having panels formed by the material of the present invention; the panels can be of any size and configuration; the panels can form the sock itself or be attached to an underlying fabric, such as a cotton weave;

FIG. 22 is a perspective view of a kneepad having a panel formed by the material of the present invention; the panel can be of any size and configuration; the panels that are formed by the material of the present invention can be integrated in any type of kneepad or other article of clothing;

FIG. 23 is a cross-sectional view illustrating one embodiment of the material of the present invention that may be used to form a panel, covering, casing, or container as taken along the line 23-23 of FIGS. 17-22 and 24-30;

FIG. 24 is a perspective view illustrating a panel formed by the material of the present invention used to cover a dashboard, and/or a floorboard of an automobile; the panel can be used in a boat, plane, motorcycle, all terrain vehicle, train, racing vehicle, or the like and can be used in any part of a vehicle, such as a seat, roll bar, floor panel, speaker insulation, engine mounts, or the like without departing from the present invention;

FIG. 25 is a perspective view of a roll bar for use with a vehicle that incorporates the material of the present invention as padding thereover; the roll bar padding may include a panel of the material of the present invention or may be formed entirely of the material of the present invention;

FIGS. 26-30 are perspective views of tape or other wrapping material that may include a panel of or that may be entirely made of the material of the present invention;

FIG. 31 is a perspective view of a headband formed, at least in part, by the material of the present invention;

FIG. 32 is a cross-sectional view of a portion of the headband of FIG. 31 as taken along the line 32-32 in FIG. 31;

FIG. 33 is a side elevational view of a helmet including panels formed by the material of the present invention;

FIGS. 33A-33C are side elevational views of a flexible headgear including panels formed by the material of the present invention with FIG. 33A illustrating a “durag” or “skull cap”, FIG. 33B illustrating a ski cap and FIG. 33C illustrating a ski mask;

FIG. 34 is a perspective, partially broken away view of a cycling helmet incorporating the material of the present invention;

FIG. 35 is a perspective view of a glove suitable for use with at least one of a baseball and a softball; the glove incorporates the material of the present invention;

FIG. 36 is a perspective view of a weightlifting glove that incorporates the material of the present invention;

FIG. 37 is a front elevation view of a jersey incorporating the material of the present invention;

FIG. 38 is an elevational view of athletic shorts incorporating the material of the present invention;

FIG. 39 is a elevational view of a golf glove incorporating the material of the present invention;

FIG. 40 is a elevational view of a rope handling glove or a rescue services glove incorporating the material of the present invention;

FIG. 41 is a elevational view of a batting glove incorporating the material of the present invention;

FIG. 42 is a elevational view of a lady's dress glove incorporating the material of the present invention;

FIG. 43 is a elevational view of a ski mitten incorporating the material of the present invention;

FIG. 44 is a elevational view of a lacrosse glove incorporating the material of the present invention;

FIG. 45 is a elevational view of boxing glove incorporating the material of the present invention;

FIG. 46 is a cross-sectional view of another embodiment of the material of the present invention illustrating a single layer vibration dissipating material with a support structure embedded therein, the material extends along a longitudinal portion of an implement and covers a proximal end thereof;

FIG. 47 is a cross-sectional view of the material of FIG. 46 separate from any implement, padding, equipment or the like;

FIG. 47A is a cross-sectional view of another embodiment of the material of the present invention with the support structure embedded thereon and the vibration dissipating material penetrating the support structure;

FIG. 47B is cross-sectional view of another embodiment of the material of the present invention with the support structure embedded within the vibration dissipating material and the vibration dissipating material penetrating the support structure, the support structure is positioned off center within the vibration dissipating material;

FIG. 48 is a cross-sectional view of an embodiment of the support structure as taken along the lines 48-48 of FIG. 47, the support structure is formed of polymer and/or elastomer and/or fibers, either of which may contain fibers, passageways extend through the support structure allowing the vibration dissipating material to penetrate the support structure;

FIG. 49 is cross-sectional view of an alternate embodiment of the support structure as viewed in a manner similar to that of FIG. 48 illustrating a support structure formed by woven fibers, passageways through the woven fibers allow the support structure to be penetrated by the vibration dissipating material;

FIG. 50 is cross-sectional view of another alternate support structure as viewed in a manner similar to that of FIG. 48, the support structure formed by plurality of fibers, passageways past the fibers allow the vibration dissipating material to penetrate the support structure;

FIG. 51 is a side elevational view of the support structure of FIG. 48;

FIG. 52 is a cross-sectional view of another embodiment of the material of the present invention illustrating a single layer vibration dissipating material with a support structure embedded therein, the material extends along a longitudinal portion of an implement and covers a proximal end thereof;

FIG. 53 is a cross-sectional view of the material of FIG. 52 separate from any implement, padding, equipment or the like;

FIG. 53A is a cross-sectional view of another embodiment of the material of the present invention with the support structure embedded thereon and the vibration dissipating material penetrating the support structure;

FIG. 53B is cross-sectional view of another embodiment of the material of the present invention with the support structure embedded within the vibration dissipating material and the vibration dissipating material penetrating the support structure, the support structure is positioned off center within the vibration dissipating material;

FIG. 54 is a cross-sectional view of yet another embodiment of the material of the present invention illustrating a single layer of vibration dissipating material with a support structure embedded therein; the support structure is disposed within the vibration dissipating material generally along a longitudinal axis in an at least partially non linear fashion so that a length of the support structure, as measured along a surface thereof, is greater than the length of the vibration dissipating material as measured along the longitudinal axis, of the material body;

FIG. 55 is an enlarged broken away view of the area enclosed by the dashed lines labeled “FIG. 55” in FIG. 54 and illustrates that the “overall support structure” can actually be formed by a plurality of individual stacked support structures (which can be the same or different from each other) or a successive plurality of stacked fibers and/or a successive plurality of stacked cloth layers;

FIG. 56 is a cross-sectional view of the material of FIG. 54 stretched along the longitudinal axis into a second position, in which the material body is elongated by a predetermined amount relative to the first position; the straightening of the support structure causes energy to be dissipated and preferably generally prevents further elongation of the material along the longitudinal axis past the second position;

FIG. 57 is a cross-sectional view of another embodiment of the material of the present invention illustrating a more linear support structure within the material while the material is in the first position; the more linear arrangement of the support structure in the material, relative to that shown in FIG. 54, reduces the amount of elongation that is possible before the material stops stretching and effectively forms a brake on further movement;

FIG. 58 is a cross-sectional view of the material of FIG. 57 stretched along the longitudinal axis into the second position, in which the material is elongated along the longitudinal axis by a predetermined amount; because the support structure was more linear while the material was in the first position, relative to the material shown in FIG. 56, it is preferred that the amount of elongation of the material when the material is in the second position is reduced relative to the material shown in FIGS. 54 and 56;

FIG. 59 is a cross-sectional view of another embodiment of the material of the present invention illustrating the support structure with an adhesive layer generally over its major surfaces to allow the elastomer material to be secured thereto rather than molded and/or extruded thereover;

FIG. 60 is a cross-sectional view of another embodiment of the material of the present invention illustrating the support structure, or ribbon material, positioned between two spaced elastomer layers with the support structure's peaks molded, fastened, and/or otherwise affixed to the elastomer layer at a plurality of locations; air gaps are preferably present about the support structure to facilitate longitudinal stretching of the material; alternatively, the support structure can be secured only at its lateral ends (i.e., the left and right ends of the support structure viewed in FIG. 60) to the elastomer layers so that the remainder of the support structure moves freely within an outer sheath of elastomer material and functions as a spring/elastic member to limit the elongation of the material;

FIG. 61 is another embodiment of the vibration dissipating material of the present invention and is similar to the material shown in FIG. 60, except that the support structure's peaks are secured to the elastomer layers via an adhesive layer;

FIG. 62 is another embodiment of the vibration dissipating material of the present invention and illustrates the vibration dissipating material and any accompanying adhesive actually physically breaking when the support structure is elongated into the second position; the breaking of the vibration dissipating material results in further energy dissipation and vibration absorption in addition to that dissipated by the support structure;

FIG. 63 is another embodiment of the vibration dissipating material of the present invention and illustrates that the support structure, or ribbon material, can be disposed in any geometry within the vibration dissipating material; additionally, individually rigid squares, buttons, or plates (not shown) can be positioned on one side of the material to further spread impact force along the surface of the material prior to the dissipation of vibration by the material in general; additionally, such buttons, plates, or other rigid surfaces can be attached directly to a mesh or other flexible layer that is disposed over the material shown in FIG. 63 so that impact force on one of the rigid members causes deflection of the entire mesh or other layer for energy absorption prior to vibration absorption by the material; the section line labeled 53-53 in this Figure signifies that it is possible that the support structure shown in FIG. 63 is generally the same as that illustrated in FIG. 53;

FIG. 64 is a cross-sectional view of another embodiment of the material of the present invention and illustrates that the support structure can be positioned generally along an outer surface of the vibration dissipating material without departing from the scope of the present invention; FIG. 64 also illustrates that a breakable layer (i.e., a paper layer) or a self fusing adhesive layer can be located on one surface of the material; when a self fusing layer is located on one surface of the material, the material can be wrapped so as to allow multiple adjacent wrappings of the material to fuse together to form an integral piece; if desired, the integral piece may be waterproof for use with swimming or the like;

FIG. 65 is a cross-sectional view of another embodiment of the vibration dissipating material with a shrinkable layer of material disposed on a major surface thereof; the shrinkable material can be a heat shrinkable material or any other type of shrinking material suitable for use with the present invention; once the material is properly positioned, the shrinkable layer can be used to fix the material in position and, preferably, can also be used as a separate breakable layer to further dissipate vibration in a fashion similar to the breakable layer described in connection with FIG. 62;

FIG. 66 is another embodiment of the vibration dissipating material of the present invention and illustrates the shrinkable layer disposed within the vibration dissipating material; the shrinkable layer can be a solid layer, a perforated layer, a mesh or netting, or shrinkable fibers;

FIG. 67 is another embodiment of the vibration absorbing material of the present invention and illustrates the shrinkable layer being disposed over peaks of the support structure with an optional vibration absorbing layer thereover;

FIG. 68 is a cross-sectional view of the material of FIG. 67 when the shrinkable layer has been shrunk down over the support structure after the material is placed in a desired configuration; although the optional additional vibration absorbing material is not shown in FIG. 68, it can be left in position above the shrinkable layer to form a protective sheath or also pulled down into the gaps between the peaks of the support structure;

FIG. 69 illustrates the material of the present invention configured as athletic tape with an optional adhesive layer;

FIG. 70 illustrates the material of the present invention as a roll of material/padding/wide wrap material or the like with an optional adhesive layer thereon;

FIG. 71 illustrates the material of the present invention configured as a knee bandage;

FIG. 72 illustrates the material of the present invention with an optional adhesive layer configured as a finger and/or joint bandage; while various bandages, wraps, padding, materials, tapes, or the like are shown, the material of the present invention can be used for any purpose or application without departing from the scope of the present invention;

FIG. 73 illustrates the material of the present invention used to form a foot brace;

FIG. 74 illustrates the material of the present invention wrapped to form a knee supporting brace;

FIG. 75 illustrates additional layers of material used to brace the ligaments in a person's leg;

FIG. 76 illustrates the material of the present invention used to form a hip support;

FIG. 77 illustrates the material of the present invention used to form a shoulder brace;

FIG. 78 illustrates the material of the present invention wrapped to form a hand and wrist brace; while the material of the present invention has been shown in conjunction with various portions of the person's body, those of ordinary skill in the art will appreciate from this disclosure that the material of the present invention can be used as an athletic brace, a medical support, or a padding for any portion of a person's body without the departing from the scope of the present invention;

FIG. 79 is a cross-sectional view of another embodiment of the material of the invention;

FIG. 79a is a cross-sectional view of another embodiment of the material of the invention;

FIG. 80 shows the material of FIG. 80 closed upon itself in a tube;

FIG. 81 is a cross section through the lines 81-81 in FIG. 80;

FIG. 81a is an alternate material cross section through the lines 81-81 in FIG. 80;

FIG. 82 is a toroidal shaped embodiment of the invention;

FIG. 83 is an open cylinder-shaped embodiment using the material of the invention;

FIG. 84 shows the open cylinder embodiment as applied in an engine mount;

FIG. 85 shows an open cylinder embodiment as applied as a shock absorber;

FIGS. 86 and 87 show variant embodiments of the material of FIG. 79 as used in a flooring surface;

FIG. 88 shows a cross section of another material embodiment of the invention;

FIG. 89 shows a top view of the material of FIG. 88 with grooves formed therein;

FIG. 90 is a cross section of FIG. 89 along the lines 90-90;

FIG. 91 shows a top view of the material of FIG. 88 with grooves formed therein;

FIG. 92 is a cross section of FIG. 91 along the lines 92-92;

FIG. 93 shows the material of FIG. 88 as used with a protective vest;

FIG. 94 is a cross section view of an alternative material in accordance with the present invention;

FIG. 95 is a cross section view of yet another an alternative material in accordance with the present invention;

FIG. 96 is a top plan view of an alternative material in accordance with the present invention;

FIG. 97 is a cross section along the line 97-97 in FIG. 96;

FIG. 98 is a top plan view of another alternative material in accordance with the present invention;

FIGS. 99-103 illustrate various embodiments of material incorporating the present embodiment and useful for facilitating retro-fitting of existing products with vibration regulating material of the present invention;

FIG. 104 is a cross-sectional view of a material used as a padding between a wall and a mounting stud;

FIG. 105 is a partial side elevation view of a baseball bat handle;

FIG. 106 is a cross-sectional view of the bat of FIG. 105 through the line 106-106;

FIG. 107 is a partial side elevation of a tennis racquet handle; and

FIG. 108 is a cross-sectional view of the bat of FIG. 107 through the line 108-108.

FIG. 109 is a cross-sectional view of another embodiment of the invention, wherein a panel is comprised of a semi rigid polypropylene polymer, an aramid coated on both sides, and a closed cell, high density elastomer, in varying degrees of thickness.

FIG. 110 is a cross-sectional view of another embodiment of the invention, wherein a panel is comprised of an aramid coated on both sides, and a closed cell, high density elastomer, in varying degrees of thickness.

FIG. 111 is a cross-sectional view of another embodiment of the invention, wherein a panel is comprised of a semi rigid polypropylene polymer, an aramid coated on both sides, a closed cell, high density elastomer and a closed cell, low density elastomer, in varying degrees of thickness.

FIG. 112 is a cross-sectional view of another embodiment of the invention, wherein a panel is comprised of a semi rigid polypropylene polymer, an aramid coated on both sides, a closed cell, high density elastomer and a closed cell, low density elastomer, in varying degrees of thickness.

FIG. 113 is a cross-sectional view of another embodiment of the invention, wherein a panel is comprised of a semi rigid polypropylene polymer, an aramid coated on both sides, a closed cell, high density elastomer and a closed cell, low density elastomer, in varying degrees of thickness.

FIG. 114 is a cross-sectional view of another embodiment of the invention, wherein a panel is comprised of a semi rigid polypropylene polymer, an aramid coated on both sides, a closed cell, high density elastomer and a closed cell, low density elastomer, in varying degrees of thickness.

FIG. 115 is a cross-sectional view of another embodiment of the invention, wherein a panel is comprised of an aramid coated on both sides and an open cell memory elastomer, in varying degrees of thickness.

FIG. 116 is a cross-sectional view of another embodiment of the invention, wherein a panel is comprised of a semi rigid polypropylene polymer, an aramid coated on both sides and an open cell memory elastomer, in varying degrees of thickness.

FIG. 117 is a cross-sectional view of another embodiment of the invention, wherein a panel is comprised of an aramid coated on both sides and an open cell memory elastomer, in varying degrees of thickness.

FIG. 118 is a cross-sectional view of another embodiment of the invention, wherein a panel is comprised of a semi rigid polypropylene polymer, an aramid coated on both sides, a closed cell, high density elastomer and an open cell memory elastomer, in varying degrees of thickness.

FIG. 119 is a cross-sectional view of another embodiment of the invention, wherein a panel is comprised of a semi rigid polypropylene polymer, an aramid coated on both sides, a closed cell, high density elastomer and an open cell memory elastomer, in varying degrees of thickness.

FIG. 120 is a cross-sectional view of another embodiment of the invention, wherein a panel is comprised of a semi rigid polypropylene polymer, an aramid coated on both sides, a closed cell, high density elastomer and an open cell memory elastomer, in varying degrees of thickness.

FIG. 121 is a summary table from a recent study of various embodiments of the present invention conducted at Tufts Medical Center, entitled “Development of a Chest Wall Protector Effective in Preventing Sudden Cardiac Death by Chest Wall Impact (Commotio Cordis).

FIG. 122 is an embodiment of the present invention, wherein one or more panels comprising a composite material of the present invention are configured as protective equipment for association with an athletics shirt, and are capable of interlocking with complementary panels comprising a composite material of the present invention; and FIGS. 123-125 illustrate exemplary embodiments of the invention.

### DETAILED DESCRIPTION OF THE PREFERRED EMBODIMENTS

Certain terminology is used in the following description for convenience only and is not limiting. The term “implement,” as used in the specification and in the claims, means “any one of a baseball bat, racket, hockey stick, softball bat, sporting equipment, firearm, or the like.” The above terminology includes the words above specifically mentioned, derivatives thereof, and words of similar import. Additionally, the words “a” and “one” are defined as including one or more of the referenced item unless specifically stated otherwise.

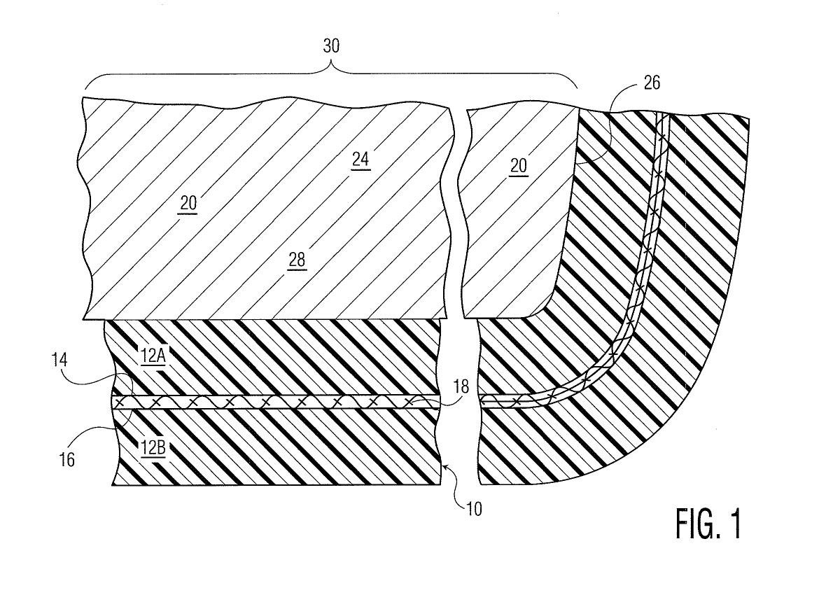

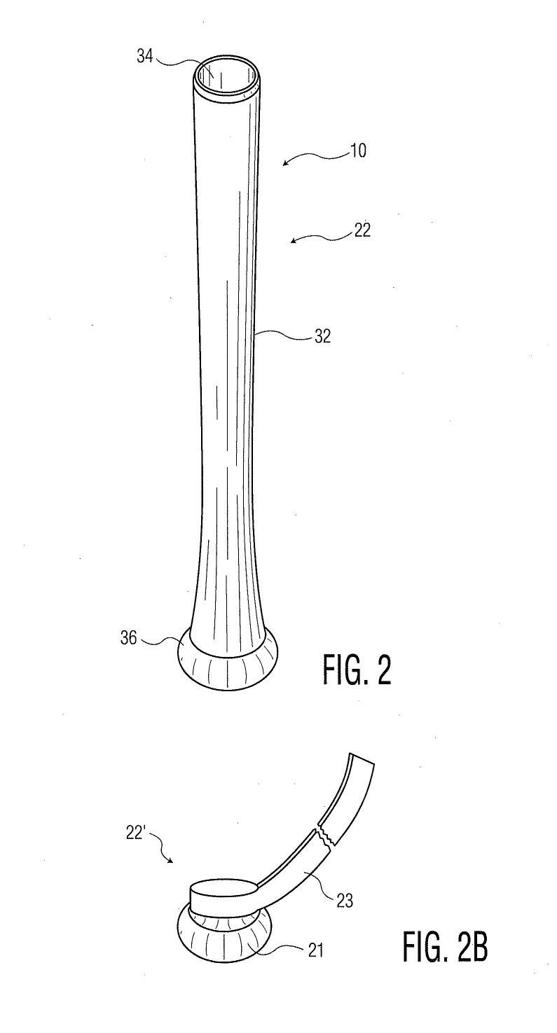

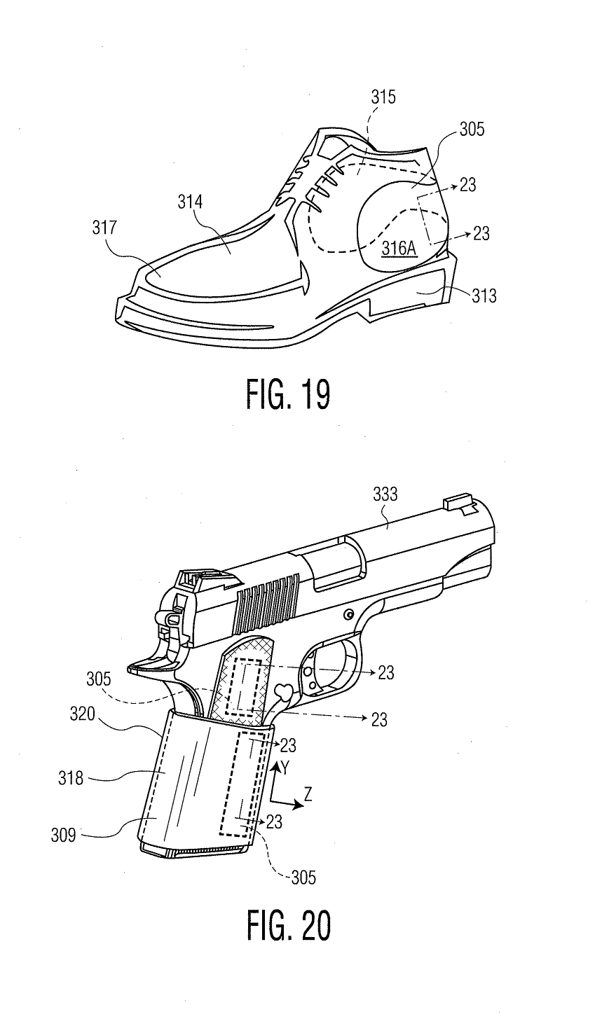

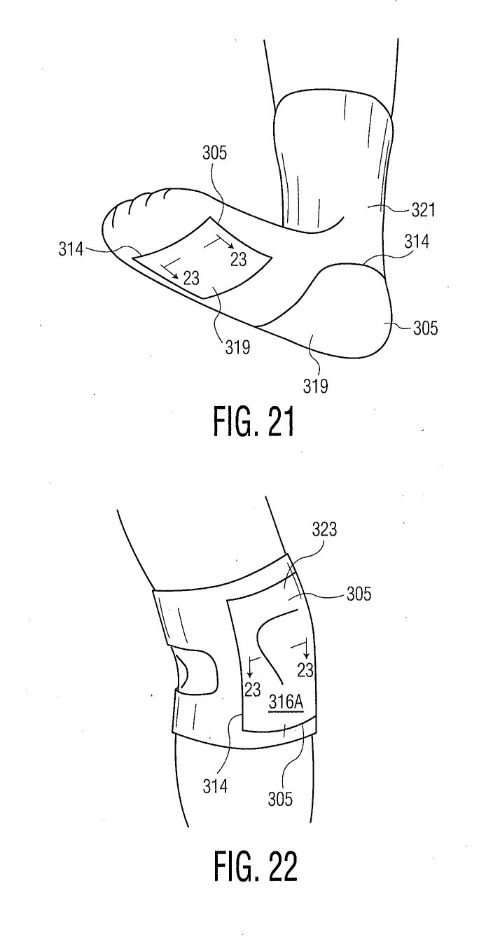

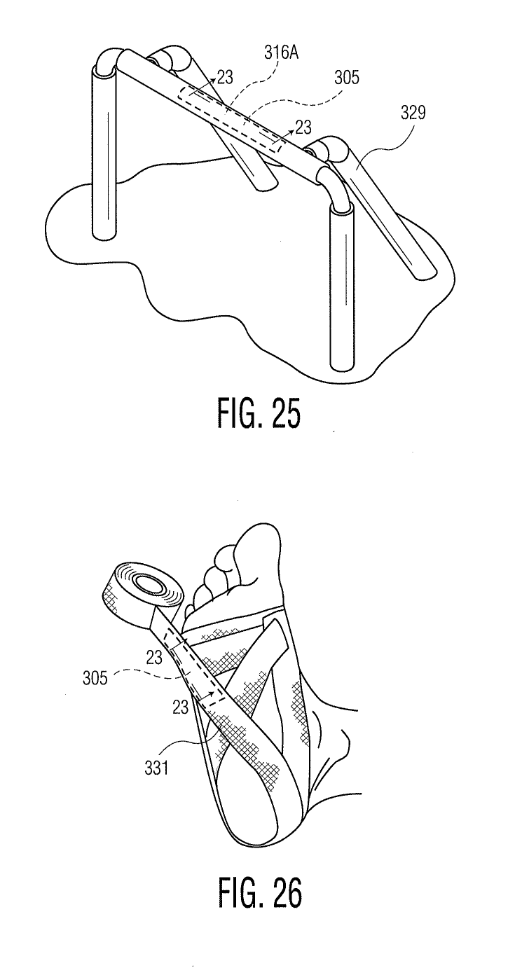

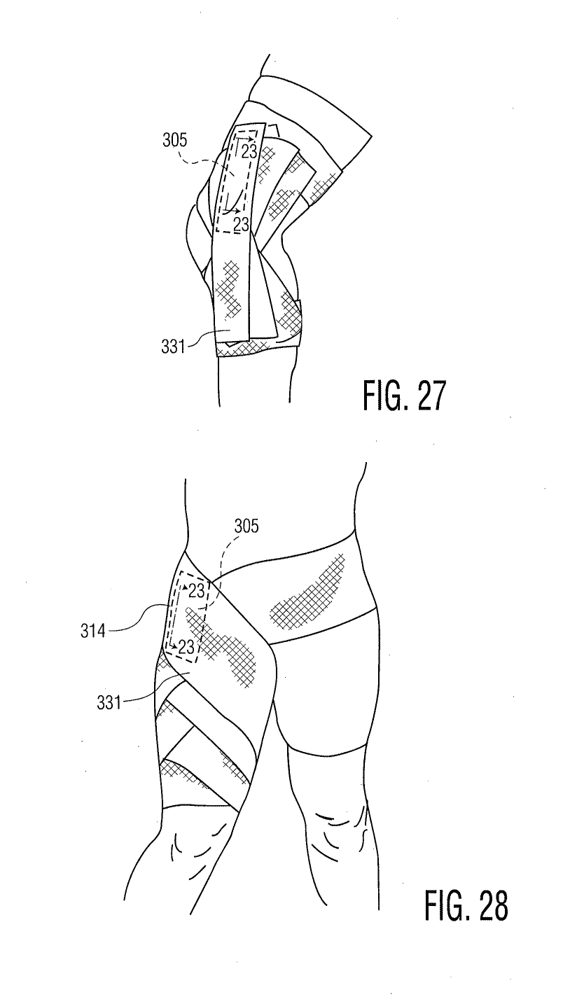

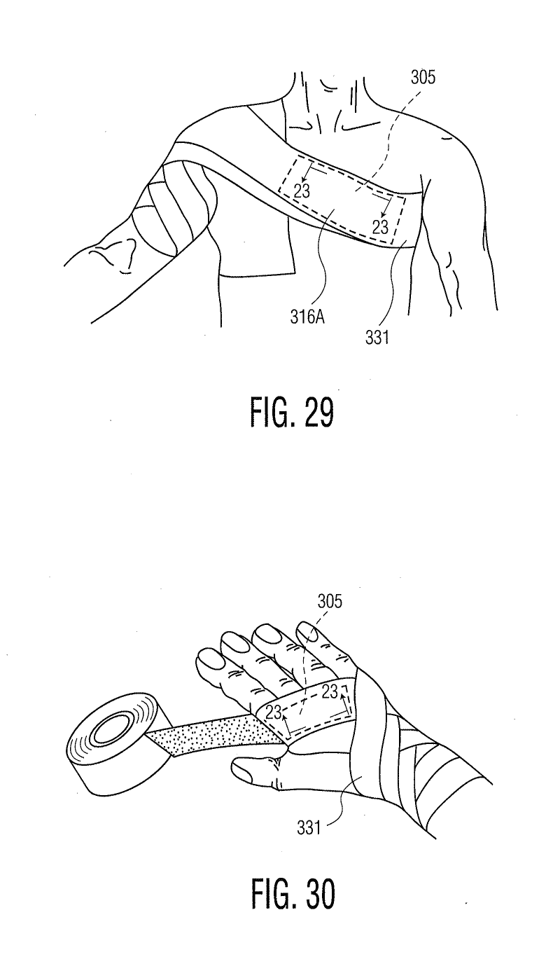

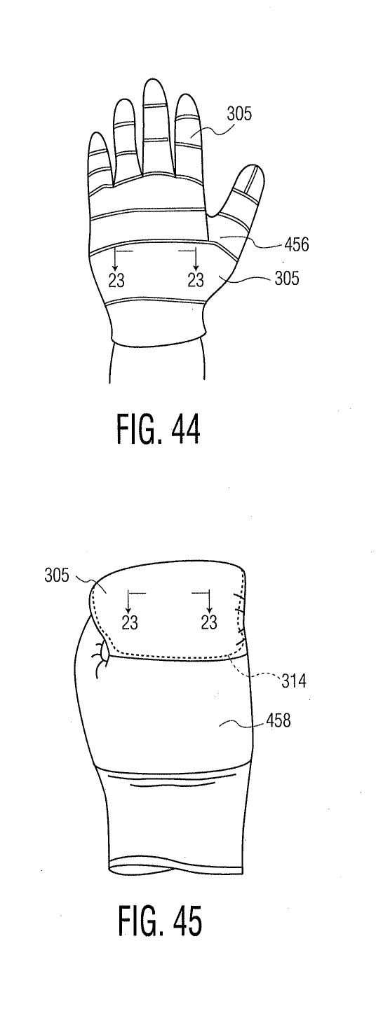

Referring to FIGS. 1 and 2, wherein like numerals indicate like elements throughout, there is shown a first embodiment of a material adapted to regulate vibration according to the present invention, generally designated 10. Briefly stated, the material 10 of the present invention is formed by at least a first elastomer layer 12A and a layer of high tensile strength fibrous material 14. The material 10 can be incorporated into athletic gear, grips for sports equipment, grips for tools, and protective athletic gear. The panels 305 (see FIGS. 17-45) of the material 10 can be incorporated into the various items disclosed in this application. The panel defines an outer perimeter 314 and may extend throughout the entire item, that is, the panel 305 may actually form the entire shoe insert, case, or other item. Alternatively, multiple panels can be separately located on an item. More specifically, the material 10 can be used: to form grips (or to form part of a grip or to form a panel 305 included in a grip) for a tennis racquet, hockey sticks, golf clubs, baseball bats or the like; to form protective athletic gear for mitts, headbands, helmets, knee pads 323 (shown in FIG. 22), umpire padding, shoulder pads, gloves, mouth guards, pads, or the like; to form seats or handle bar covers for bicycles, motorcycles, or the like; to form boots for skiing, roller blading or the like; to form clothing (such as shirts, gloves, pants, etc.) or padded liners or footwear 311 (shown in FIG. 19), such as shoe soles 313, shoe uppers 315, shoe lowers, shoe pads, ankle pads, toe pads 317, shoe inserts, and to provide padding 319 to socks 321 (shown in FIG. 21), such as sock bottoms; to form padding 307 (shown in FIG. 17) for portable electronics, such as cell phone cases, PDA cases, laptop cases, gun cases, radio cases, cassette cases, MP3 player cases, calculator cases; to form padding for speakers; to provide padding 325 (see FIG. 24) and soundproofing for automobiles 327, such as providing pole and/or roll bar padding 329 (shown in FIG. 25) in vehicles, such as automobiles, boats, trucks, all terrain vehicles, etc., providing insulation panels 329 for cars, for use in engine mounts; to form grips 309 (shown in FIG. 20) for firearms, hand guns, rifles, shotguns, or the like; to form grips for tools such as hammers, drills, screw drivers, circular saws, chisels or the like; and to form part or all of bandages and/or wraps 331 (shown in FIGS. 26-30). The material of the present invention 10 can also be used for soundproofing rooms, homes, airplanes, music studios, or the like.

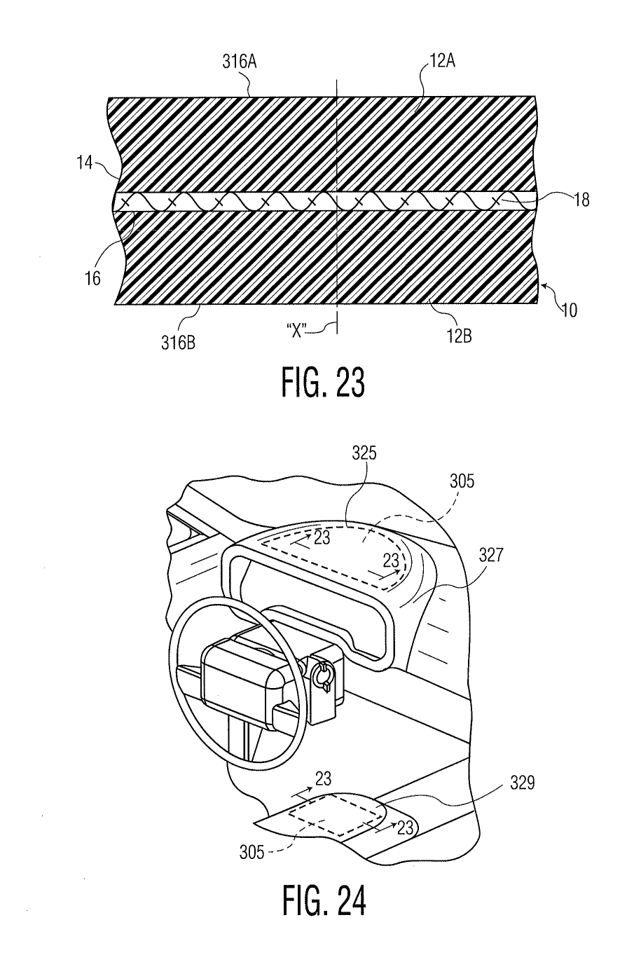

The material 10 is preferably generally non elastic in a direction generally perpendicular “X” to a major material surface 316A (shown in FIG. 23) and thus, does not provide a spring like effect when experiencing impact force. It is preferred that the material 10 is generally compliant in the direction “X” which is perpendicular to the major material surface 316A, 316B so as to be generally non energy storing in the direction “X”. It is preferred that the reinforcement layer generally distribute impact energy parallel to the major surfaces 316A, 316B and into the first and second elastomer layers 12A, 12B. The material 10 is preferably designed to reduce sensible vibration (and thus generally dampen and divert energy away from the object or person covered by the material).

The first elastomer layer 12A acts a shock absorber by converting mechanical vibrational energy into heat energy. The high tensile strength fibrous material layer 14 redirects vibrational energy and provides increased stiffness to the material 10 to facilitate a user's ability to control an implement 20 encased, or partially encased, by the material 10. It is preferred, but not necessary, that the high tensile strength fibrous material layer 14 be formed of aramid material.

In one embodiment, the composite material 10 may have three generally independent and separate layers including the first elastomer layer 12A and a second elastomer layer 12B. Elastomer material provides vibration damping by dissipating vibrational energy. Suitable elastomer materials include, but are not limited urethane rubbers, silicone rubbers, nitrile rubbers, butyl rubbers, acrylic rubbers, natural rubbers, styrene-butadiene rubbers, and the like. In general, any suitable elastomer material can be used to form the first and second elastomer layers without departing from the scope of the present invention. For example the elastomer layers may be thermoset elastomer layers. Alternatively, the elastomer layers 12A, 12B can be thermoplastic or any material suitable for thermoforming. As another example, the elastomer layers 12A, 12B can be manufactured as either on open cell foam or a closed cell foam having a foamed structure or as foam having a low or high density. In another aspect, when manufacturing some shaped articles, such as a golf club grip, it may be more efficient to first form the material 10 as a generally flat piece or sheet of material 10 which could then be reformed or thermoformed into the desired shaped article. Additionally, the material 10 may include a shrink wrap or shrinkable layer therein and/or thereon. The shrinkable layer can be heat and/or water activated.

The material 10 can include additional layers thereover, such as a generally rigid material or the like. For example, one or more generally rigid plates of rigid material can be positioned over the material 10 to distribute impact force over an increased amount of the material. This can be useful when using the material in umpire vests, bulletproof vests, shoulder pads, shoes, or in any other application where a generally rigid outer layer is desired.

The material 10 may also include additional elastomeric layers, comprising an open or closed cell structure foam and/or high or low density foam. For example, two foam layers can be positioned proximate the material 10 to provide optimal force distribution. This can be useful when using the material in umpire vests, bulletproof vests, sports protective apparel and accessories, shoulder pads, headbands, or in any other applications where protection from outwardly applied forces is desired.

The softness of elastomer materials can be quantified using Shore A durometer ratings. Generally speaking, the lower the durometer rating, the softer the material and the more effective an elastomer layer is at absorbing and dissipating vibration because less force is channeled through the elastomer. When a soft elastomer material is squeezed, an individual's fingers are imbedded in the elastomer which increases the surface area of contact between the user's hand and creates irregularities in the outer material surface to allow a user to firmly grasp any implement 20 covered, or partially covered, by the material. However, the softer the elastomer layers 12A, 12B, the less control a user has when manipulating an implement 20 covered by the elastomer. If the elastomer layer is too soft (i.e., if the elastomer layer has too low of a Shore A durometer rating), then the implement 20 may rotate unintentionally relative to a user's hand or foot. The material 10 of the present invention is preferably designed to use first and second elastomer layers 12A, 12B having Shore A durometer ratings that provide an optimum balance between allowing a user to precisely manipulate and control the implement 20 and effectively damping vibration during use of the implement 20.

It is preferable, but not necessary, that the elastomer used with the material 10 have a Shore A durometer of between approximately ten (10) and approximately eighty (80). It is preferred that the first elastomer layer have a Shore A durometer of between approximately ten (10) and approximately twenty-five (25) and that the second elastomer layer has a Shore A durometer of between approximately twenty-five (25) and approximately forty-five (45).

The first elastomer layer 12A is preferably used to slow down impact energy and to absorb vibrational energy and to convert vibrational energy into heat energy. This preferably, but not necessarily, allows the first elastomer layer to act as a pad as well as dissipate vibration. The second elastomer layer 12B is also used to absorb vibrational energy, but also provides a compliant and comfortable grip for a user to grasp (or provides a surface for a portion of a user's body, such as the under sole of a user's foot when the material 10 is formed as a shoe insert).

In one embodiment, the first elastomer layer 12A preferably has Shore A durometer of approximately fifteen (15) and the second elastomer layer has a Shore A durometer of approximately forty-two (42). If the first and second elastomer has generally the same Shore A durometer ratings, then it is preferable, but not necessary, that the first and second elastomer layers 12A, 12B have a Shore A durometer of fifteen (15), thirty-two (32), or forty-two (42).

The high tensile strength fibrous material layer 14 is preferably, but not necessarily, formed of aramid fibers. The fibers can be woven to form a cloth layer 16 that is disposed between and generally separates the first and second elastomer layers 12A, 12B. The cloth layer 16 can be formed of aramid fibers, high tensile strength fibers, fiberglass, or other types of fiber. It is preferred that the cloth layer 16 does not have suitable rigidity for use as an open gridwork having any significant energy storage capability. It is preferred that the material which forms the reinforcement layer 14 is generally bonded to the elastomer layers 12A, 12B. The cloth layer 16 preferably generally separates the first and second elastomer layers 12A, 12B causing the material 10 to have three generally distinct and separate layers 12A, 12B, 14. The high tensile strength fibrous material layer 14 blocks and redirects vibrational energy that passes through one of the elastomer layers 12A or 12B to facilitate the dissipation of vibrations. The high tensile strength fibers 18 redirect vibrational energy along the length of the fibers 18. Thus, when the plurality of high tensile strength fibers 18 are woven to form the cloth layer 16, vibrational energy emanating from the implement 20 that is not absorbed or dissipated by the first elastomer layer 12A is redistributed evenly along the material 10 by the cloth layer 16 and then further dissipated by the second elastomer layer 12B.

The cloth layer 16 is preferably generally interlocked in, generally affixed to, or generally fixed in position by the elastomer layers 12A, 12B in order for the cloth layer 16 to block and redirect vibrational energy to facilitate dissipation of vibrations.

It is preferable that the high tensile strength fibers 18 be formed of a suitable polyamide fiber of high tensile strength with a high resistance to elongation. However, those of ordinary skill in the art will appreciate from this disclosure that any aramid fiber suitable to channel vibration can be used to form the high tensile strength fibrous material layer 14 without departing from scope of the present invention. Additionally, those of ordinary skill in the art will appreciate from this disclosure that loose fibers or chopped fibers can be used to form the high tensile strength fibrous material layer 14 without departing from the scope of the present invention. The high tensile strength fibrous material may also be formed of fiberglass. The high tensile strength fibrous material preferably prevents the material 10 from substantially elongating in a direction parallel to the major material surfaces 316A, 316B during use. It is preferred that the amount of elongation is less than ten (10%) percent. It is more preferred that the amount of elongation is less than four (4%) percent. It is most preferred that the amount of elongation is less than one (1%) percent.

In another embodiment, where protection from outwardly applied forces is desired to prevent physical harm to, for example, an athlete, it may be preferable to utilize a specific combination of layers, such as for example, a generally rigid layer, a first elastomeric layer 12a, a high tensile strength fibrous material layer 14, a second elastomeric layer 12b, and one or more foam layers, including open or closed cell foam possessing a high or low durometer. In one such embodiment, for example, there may be at least a first elastomeric layer 12a, a high tensile strength fibrous material layer 14, a second elastomeric layer 12b, a layer of closed cell high durometer foam and a layer of closed cell low durometer foam, wherein the various layers may have varying degrees of thickness. By way of example, a low-density foam aspect may have a density of twelve to thirty-two pounds and most particularly may have a density of twenty pounds per square yard, while a high-density foam may have a density of three to twelve pounds, and most particularly nine pounds per square yard.

Those of ordinary skill in the art will appreciate from this disclosure that the material 10 can be formed of two independent layers without departing from the scope of the present invention. Accordingly, the material 10 can be formed of a first elastomer layer 12A and a high tensile strength fibrous material layer 14 (which may be woven into a cloth layer 16) that is disposed on the first elastomer 12A.

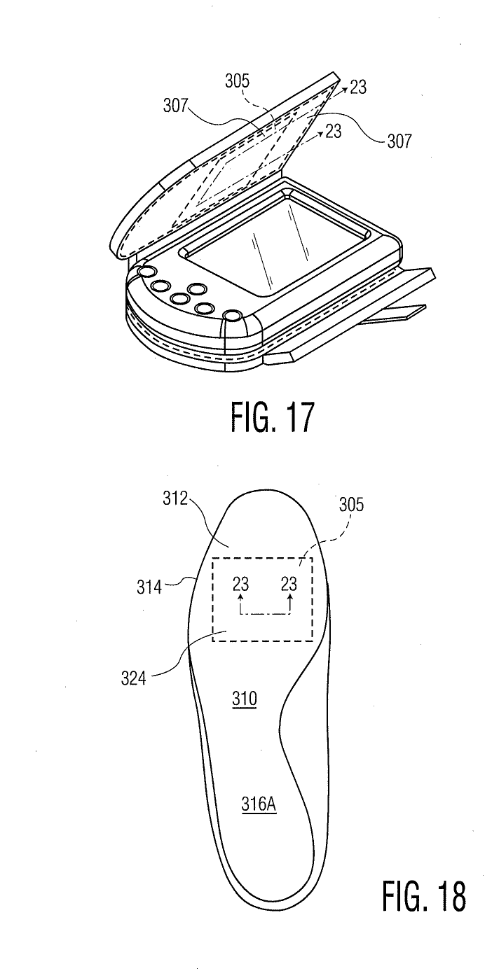

Referring to FIGS. 18 and 23, the material 10 may be configured and adapted to form an insert 310 for a shoe. When the material 10 is configured to form a shoe insert 310, the material 10 is preferably adapted to extend along an inner surface of the shoe from a location proximate to a heel of the shoe to the toe of the shoe. In addition to forming a shoe insert 310, the material 10 can be located along the sides of a shoe to protect the wearer's foot from lateral, frontal, and/or rear impact.

When the material of the present invention forms an insert 310 for a shoe, the insert 310 includes a shoe insert body 312 having a generally elongated shape with an outer perimeter 314 configured to substantially conform to a sole of the shoe so that the shoe insert body 312 extends along an inner surface of the shoe from a location proximate to a heel of the shoe to a toe of the shoe. The shoe insert body 312 is preferably generally planar and formed by a reinforced elastomer material 10 that regulates and dissipates vibration. The shoe insert body 312 has first and second major surfaces 316A, 316B. The reinforced elastomer material 10 preferably includes first and second elastomer layers 12A, 12B. In one embodiment it is preferred that the first and second elastomer layers are generally free of voids therein and/or that the elastomer layers are formed by thermoset elastomer.

A reinforcement layer 14 is disposed between and generally separates the first and second elastomer layers 12A, 12B. The reinforcement layer 14 may include a layer formed of a plurality of high tensile strength fibrous material. Alternatively, the reinforcement layer may be formed of aramid, fiberglass, regular cloth, or the like. The reinforcement layer may be formed by woven fibers. In one embodiment, it is preferred that the reinforcement layer consist of only a single cloth layer of material.

The woven high tensile strength fibrous material is preferably connected to the first and second elastomer layers 12A, 12B generally uniformly throughout to provide substantially complete coverage between the first and second elastomer layers 12A, 12B. The cloth layer is generally compliant only in a direction “X” generally perpendicular to the first major surface 316A so as to be generally non energy storing in the direction “X”. Wherein the high tensile strength fibrous material 14 generally distributes impact energy parallel to the first major surface 316A and into the first and second elastomer layers 12A, 12B. The reinforcement layer 14 preferably prevents the shoe insert 310 from substantially elongating during use. The reinforced elastomer 10 can also be used as a sole for footwear or as part of a sole or insole for footwear. The reinforced elastomer can also be used to provide padding within or along a side or upper portion of a shoe or boot.

Referring to FIGS. 4, 9, 10, and 20, the material 10 may be configured and adapted to form a grip 22 for an implement such as a bat, having a handle 24 and a proximal end 26 (i.e., the end proximal to where the bat is normally gripped). The material 10 is preferably adapted to enclose a portion of the handle 24 and to enclose the proximal end 26 of the bat or implement 20. When grip is used with a firearm the grip can be a wrap around grip or can be attached and/or molded to the firearm. As best shown in FIG. 2, in one embodiment the grip 22 can be formed as a single body that completely encloses the proximal end of the implement 20. The material 10 may be also be configured and adapted to form a grip 22 for a tennis racket or similar implement 20 having a handle 24 and a proximal end 26.

In the alternative embodiment illustrated in FIG. 2B, a proximal portion 21 of the grip 22′ is formed with a preformed shape to receive the proximal end 26 of the bat or implement 20 and a tape portion 23 of the grip 22′ extends from the proximal portion 21 for wrapping about a portion of the handle 24. The proximal portion 21 and tape portion 23 may be formed integral with one another or may be formed separately and used together, either connected before assembly on to the implement 20 or positioned separately on the implement 20. The proximal portion 21 and tape portion 23 may be manufactured from any of the materials described herein and may be of the same material or different materials.

Referring to FIG. 4, in some of the embodiments when the material of the present invention is directed to one of the types of grips described in this application (e.g., a gun grip, tool grip, golf club grip, etc.), the grip 22 may include a grip body 318 having a generally tubular shape configured to cover a portion of the associated device. As such, the grip body 318 can have a generally circular, oval, rectangular, octagonal, polygonal cross-section or the like. The grip body 318 is formed by a reinforced elastomer material 10 that regulates and dissipates vibration. The grip body 318 defines a first direction “Y”, tangential to an outer surface 320 of the grip body 318, and a second direction “Z”, generally perpendicular to the outer surface 320 of the grip body 318.

The reinforced elastomer material 10 includes first and second elastomer layers 12A, 12B. A reinforcement layer 14 is disposed between and generally separates the first and second elastomer layers 12A, 12B. In some embodiments, the elastomer layer is generally free of voids and/or is a thermoset elastomer. As explained above, however, the elastomer layers are not limited to such and may have various forms, including thermoplastic forms as well as open or closed cell foam structure in one or both layers. The reinforcement layer 14 preferably includes a layer of high tensile strength fibrous material. The high tensile strength fibrous material can be woven into a cloth, chopped, or otherwise distributed. The reinforcement layer 14 may be formed by various high tensile strength fibrous material including a layer of fiberglass, aramid, or any other suitable material.

The high tensile strength fibrous material layer 14 is connected to the first and second elastomer layers 12A, 12B generally uniformly throughout to provide substantially complete coverage between the first and second elastomer layers. This preferably prevents sliding movement between the reinforcement layer 14 and the elastomer layers 12A, 12B. The cloth layer is preferably generally compliant only in the second direction “Z” so as to be generally non energy storing in the second direction “Z”. The high tensile fibrous material generally distributes impact energy parallel to the first direction “Y” and into the first and second elastomer layers. This causes vibrational energy to be reduced and dampened rather than bounced back against the hand grasping the grip.

While the grip 22 will be described below in connection with a baseball or softball bat, those of ordinary skill in the art will appreciate that the grip 22 can be used with any of the equipment, tools, or devices mentioned above without departing from the scope of the present invention.

When the grip 22 is used with a baseball or softball bat, the grip 22 preferably covers approximately seventeen (17) inches of the handle of the bat as well as covers the knob (i.e., the proximal end 26 of the implement 20) of the bat. The configuration of the grip 22 to extend over a significant portion of the bat length contributes to increase vibrational damping. It is preferred, but not necessary, that the grip 22 be formed as a single, contiguous, one-piece member.

The baseball bat (or implement 20) has a handle 24 including a handle body 28 having a longitudinal portion 30 and a proximal end 26. The material 10 preferably encases at least some of the longitudinal portion 30 and the proximal end 26 of the handle 24. The material 10 can be produced as a composite having two generally separate and distinct layers including a first elastomer layer 12A and a high tensile strength fibrous material layer 14 (which may be a woven cloth layer 16) disposed on the elastomer layer 12A. The high tensile strength fibrous material layer 14 is preferably formed of woven fibers 18. The second elastomer layer 12B may be disposed on a major surface of the high tensile strength fibrous material layer 14 opposite from the first elastomer layer 12A.

As best shown in FIG. 2, a preferred grip 22 is adapted for use with an implement 20 having a handle and a proximal handle end. The grip 22 includes a tubular shell 32 having a distal open end 34 adapted to surround a portion of the handle and a closed proximal end 36 adapted to enclose the proximal end of the handle. The tubular shell 32 is preferably formed of the material 10 which dissipates vibration. The material 10 preferably has at least two generally separate layers including a first elastomer layer 12A and a high tensile strength fibrous material layer 14 (which fibers 18 may be woven to form a cloth layer 16) disposed on the first elastomer layer 12A.

Referring to FIGS. 17-22 and 24-30, when the material of the present invention is directed to one of the types of padding described above (e.g., speaker padding and/or insulation, shoe padding, electronic device cases, mouth guards, umpire protective gear, athlete protective gear, car interior padding, rollover bar padding, or the like, tool grip, golf club grip, etc.), the padding or item may include a panel 305 formed by a panel body 324 preferably having a generally planar shape. The panel body is preferably configured for placement in a particular location or for covering a portion of an associated device or object. It is preferable that the panel body is flexible so that shaped objects can be wrapped therein. As such, the panel body 324 may be bent around a generally circular, oval, rectangular, octagonal, or polygonal shaped object.

The panel body 324 is formed by a reinforced elastomer material that regulates and dissipates vibration. As shown in FIGS. 4 and 20, the panel body 324 defines a first direction “Y”, tangential, or parallel, to an outer surface of the padding body 324, and a second direction “Z”, generally perpendicular to the outer surface of the panel body. The reinforced elastomer material includes first and second elastomer layers 12A, 12B. A reinforcement layer 14 is disposed between and generally separates the first and second elastomer layers 12A, 12B. In one embodiment the elastomer layers 12A, 12B are preferably free of voids and/or formed by a thermoset elastomer. As explained above, however, the elastomer layers are not limited to such and may have various forms, including thermoplastic forms as well as open or closed cell foam structure in one or both layers. The reinforcement layer 14 preferably includes a layer of high tensile strength fibrous material. The high tensile strength fibrous material can be woven into a cloth, chopped, or otherwise distributed. Instead of the reinforcement layer 14 being formed by high tensile strength fibrous material, the reinforcement layer 14 can be formed by a layer of fiberglass, aramid, or any other suitable material. The high tensile strength fibrous material layer 14 is connected to the first and second elastomer layers 12A, 12B generally uniformly throughout to provide substantially complete coverage between the first and second elastomer layers 12A, 12B. The reinforcement layer 14 is preferably generally compliant only in the second direction so as to be generally non energy storing in the second direction “Z”. The reinforcement layer 14 generally distributes impact energy parallel to the first direction “Y” and into the first and second elastomer layers 12A, 12B. This causes vibrational energy to be reduced and dampened rather than bounced back. It is preferable that the reinforcement layer 14 prevents the padding from elongating during impact. The panel body 324 can form part or all of a cell phone case, a laptop case, a shoe sidewall, protective umpire gear, a mouth guard, knee pads, interior panels for automobiles or the like.

Multiple methods can be used to produce the composite or vibration dissipating material 10 of the present invention. One method is to extrude the material by pulling a high tensile strength fibrous cloth layer 16 from a supply roll while placing the first and second elastomer layers 12A, 12B on both sides of the woven high tensile strength fibrous cloth 16. A second method of producing the material 10 of the present invention is to mold the first elastomer layer 12A onto the implement 20, then to weave an aramid fiber layer thereover, and then to mold the second elastomer layer 12B thereover.

Alternatively, a cloth layer 16 can be pressured fit to an elastomer layer to form the material 10. Accordingly, the cloth layer 16 can be generally embedded in or held in place by the elastomer layer. The pressured fitting of the reinforcement layer, or fabric layer, 14 to an elastomer preferably results in the reinforcement layer, or fabric layer, 14 being generally interlocked in and/or bonded in position by the elastomer. Thus, the cloth layer can be generally interlocked with the elastomer layer. It is preferable that the high tensile strength cloth generally not be able to slide laterally between the first and second elastomer layers. The cloth layer in the resulting material would be generally fixed in position. One of ordinary skill in the art would realize that the cloth layer 14 in the resulting material would be generally interlocked and/or bonded in position by the elastomer 12A, 12B. Alternatively, the material 10 can be assembled by using adhesive or welding to secure the elastomer layer(s) to the reinforced layer.

It is preferred that the woven high tensile strength fibers are connected to the first and second elastomer layers generally uniformly throughout to provide substantially complete coverage between the first and second thermoset elastomer layers. The cloth layer is generally non energy storing in a direction generally perpendicular to a major material surface. This results in the vibrational energy being generally evenly redistributed throughout the material by the cloth layer. This is due to the high tensile strength fibers transmitting/storing energy unidirectionally along the length of the fiber and generally not storing energy in a direction generally perpendicular to the length of the fiber or perpendicular to a cloth layer formed by the fibers.

In other words, the cloth layer 16 is preferably compliant generally only in a direction generally perpendicular to a major material surface so as to be generally non energy storing in the direction perpendicular to the major material surface and to generally distribute energy parallel to the major material surface and into the first and second elastomer layers. The present invention preferably generally dissipates vibration throughout the material to prevent “bounce back” (e.g., to avoid having a runner's feet absorb too much vibration during athletics).

In some cases the high tensile fibrous material can be pulped to form an imperforate sheet that may be secured in position between the first and second elastomer layers 12A, 12B. Those of ordinary skill in the art will appreciate from this disclosure that any known method of making composite or vibration dissipating materials can be used to form the material 10.

The covering of the proximal end of an implement 20 by the grip 22 results in reduced vibration transmission and in improved counter balancing of the distal end of the implement 20 by moving the center of mass of the implement 20 closer to the hand of a user (i.e., closer to the proximal end 26). This facilitates the swinging of the implement 20 and can improve sports performance while reducing the fatigue associated with repetitive motion.

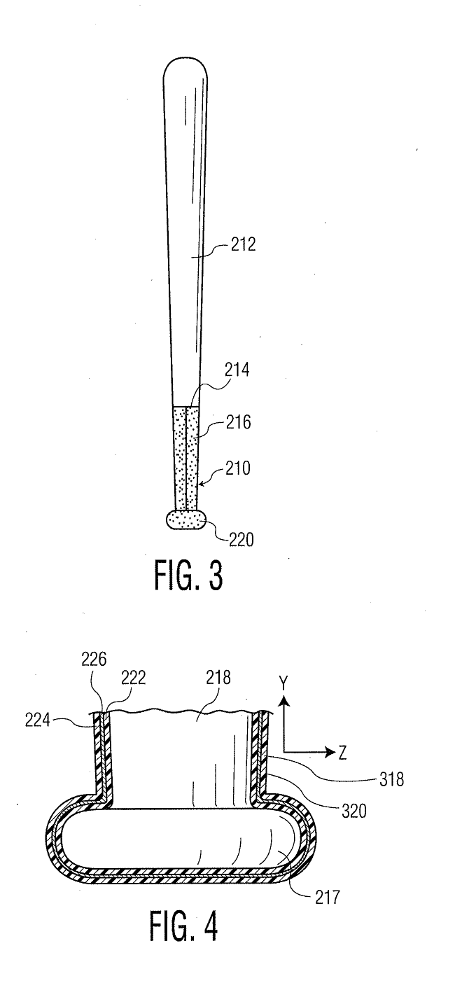

FIGS. 3-4 illustrate another embodiment of the present invention. As shown therein a cover in the form of a sleeve 210 is mounted on the handle or lower portion 218 of a baseball bat 210. Sleeve 210 is premolded so that it can be fit onto the handle portion of the bat 212 in a quick and convenient manner. This can be accomplished by having the sleeve 210 made of a stretchable or resilient material so that its upper end 214 would be pulled open and could be stretched to fit over the knob 217 of the bat 212. Alternatively, or in addition, sleeve 210 may be provided with a longitudinal slit 16 to permit the sleeve to be pulled at least partially open and thereby facilitate snapping the sleeve 210 over the handle 218 of the bat 212. The sleeve would remain mounted in place due to the tacky nature of the sleeve material and/or by the application of a suitable adhesive on the inner surface of the sleeve and/or on the outer surface of handle 218.

A characterizing feature of sleeve 210, as illustrated in FIGS. 3-4, is that the lower end of the sleeve includes an outwardly extending peripheral knob 220. Knob 220 could be a separate cap snapped onto or secured in any other manner to the main portion of sleeve 210. Alternatively, knob 220 could be integral with and molded as part of the sleeve 210.

In a broad practice of this invention, sleeve 210 can be a single layer. The material would have the appropriate hardness and vibration dampening characteristics. The outer surface of the material would be tacky having high friction characteristics.

Alternatively, the sleeve 210 could be formed from a two layer laminate where the vibration absorbing material forms the inner layer disposed against the handle, with a separate tacky outer layer made from any suitable high friction material such as a thermoplastic material with polyurethane being one example. Thus, the two layer laminate would have an inner elastomer layer which is characterized by its vibration dampening ability, while the main characteristic of the outer elastomer layer is its tackiness to provide a suitable gripping surface that would resist the tendency for the user's hand to slide off the handle. The provision of the knob 220 also functions both as a stop member to minimize the tendency for the handle to slip from the user's hand and to cooperate in the vibration dampening affect.

FIG. 4 illustrates the preferred form of multilayer laminate which includes the inner vibration absorbing layer 222 and the outer tacky gripping layer 224 with an intermediate layer 226 made of a stiffening material which dissipates force. If desired, layer 226 could be innermost and layer 224 could be the intermediate layer. A preferred stiffening material would be aramid fibers which could be incorporated in the material in any suitable manner as later described with respect to FIGS. 13-16. However, fiberglass or any high tensile strength fibrous material can be used as the stiffening material forming the layer. Additionally, in one embodiment, the stiffening layer is substantially embedded in or held in place by the elastomer layer(s).

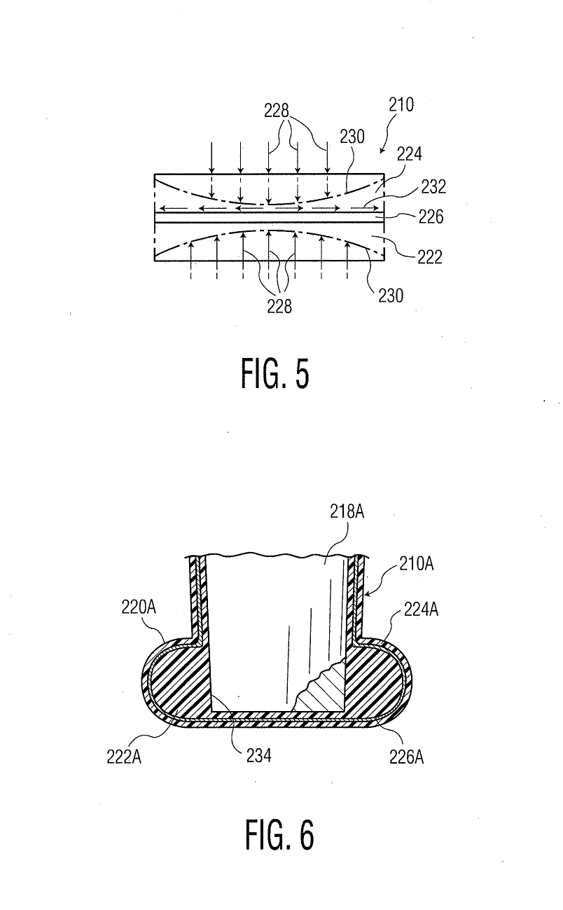

FIG. 5 schematically shows what is believed to be the affect of the shock forces from vibration when the implement makes contact such as from the bat 212 striking a ball. FIG. 5 shows the force vectors in accordance with a three layer laminate, such as illustrated in FIG. 4, wherein elastomeric layers 222,224 are made of a silicone material. The intermediate layer 226 is an aramid layer made of aramid fibers. The initial shock or vibration is shown by the lateral or transverse arrows 228 on each side of the sleeve laminate 210. This causes the elastomeric layers 222,224 to be compressed along the arc 230. The inclusion of the intermediate layer 226 made from a force dissipating material spreads the vibration longitudinally as shown by the arrows 232. The linear spread of the vibration causes a rebound effect which totally dampens the vibration.

Laboratory tests were carried out at a prominent university to evaluate various grips mounted on baseball bats. In the testing, baseball bats with various grips were suspended from the ceiling by a thin thread; this achieves almost a free boundary condition that is needed to determine the true characteristics of the bats. Two standard industrial accelerometers were mounted on a specially fabricated sleeve roughly in positions where the left hand and the right hand would grip the bat. A known force was delivered to the bat with a standard calibrated impact hammer at three positions, one corresponding to the sweet spot, the other two simulating “miss hits” located on the mid-point and shaft of the bat. The time history of the force as well as the accelerations were routed through a signal conditioning device and were connected to a data acquisition device. This was connected to a computer which was used to log the data.

Two series of tests were conducted. In the first test, a control bat (with a standard rubber grip, WORTH Bat-model #C405) was compared to identical bats with several “Sting-Free” grips representing practices of the invention. These “Sting-Free” grips were comprised of two layers of pure silicone with various types of high tensile fibrous material inserted between the two layers of silicone. The types of KEVLAR, a type of aramid fiber that has high tensile strength, used in this test were referenced as follows: “005”, “645”, “120”, “909”. Also, a bat with just a thick layer of silicone but no KEVLAR was tested. With the exception of the thick silicone (which was deemed impractical because of the excessive thickness), the “645” bat showed the best reduction in vibration magnitudes.

The second series of tests were conducted using EASTON Bats (model #BK8) with the “645” KEVLAR in different combinations with silicone layers: The first bat tested was comprised of one bottom layer of silicone with a middle layer of the “645” KEVLAR and one top layer of silicone referred to as “111”. The second bat test was comprised of two bottom layers of silicone with a middle layer of KEVLAR and one top layer of silicone referred to as “211”. The third bat tested was comprised of one bottom layer of silicone with a middle layer of KEVLAR and two top layers of silicone referred to as “112”. The “645” bat with the “111” configuration showed the best reduction in vibration magnitudes.

In order to quantify the effect of this vibration reduction, two criteria were defined: (I) the time it takes for the vibration to dissipate to an imperceptible value; and, (2) the magnitude of vibration in the range of frequencies at which the human hand is most sensitive.

The sting-free grips reduced the vibration in the baseball bats by both quantitative measures. In particular, the “645” KEVLAR in a “111” configuration was the best in vibration reduction. In the case of a baseball bat, the “645” reduced the bat's vibration in about ⅕ the time it took the control rubber grip to do so. The reduction in peak magnitude of vibration ranged from 60% to 80%, depending on the impact location and magnitude.

It was concluded that the “645” KEVLAR grip in a “111” combination reduces the magnitude of sensible vibration by 80% that is induced in a baseball bat when a player hits a ball with it. This was found to be true for a variety of impacts at different locations along the length of the bat. Hence, a person using the “Sting-Free” grips of the invention would clearly experience a considerable reduction in the sting effect (pain) when using the “Sting-free” grip than one would with a standard grip.

In view of the above tests a particularly preferred practice of the invention involves a multilayer laminate having an aramid such as KEVLAR, sandwiched between layers of pure silicone. The above indicated tests show dramatic results with this embodiment of the invention. As also indicated above, however, the laminate could comprise other combinations of layers such as a plurality of bottom layers of silicone or a plurality of top layers of silicone. Other variations include a repetitive laminate assembly wherein a vibration dampening layer is innermost with a force dissipating layer against the lower vibration dampening layer and then with a second vibration dampening layer over the force dissipating layer followed by a second force dissipating layer, etc. with the final laminate layer being a gripping layer which could also be made of vibration dampening material. Among the considerations in determining which laminate should be used would be the thickness limitations and the desired vibration dampening properties.

The various layers could have different relative thicknesses. Preferably, the vibration dampening layer, such as layer 222, would be the thickest of the layers. The outermost gripping layer, however, could be of the same thickness as the vibration dampening layer, such as layer 224 shown in FIG. 4 or could be a thinner layer since the main function of the outer layer is to provide sufficient friction to assure a firm gripping action. A particularly advantageous feature of the invention where a force dissipating stiffening layer is used is that the force dissipating layer could be very thin and still achieve its intended results. Thus, the force dissipating layer would preferably be the thinnest of the layers, although it might be of generally the same thickness as the outer gripping layer. If desired the laminate could also include a plurality of vibration dampening layers (such as thin layers of gel material) and/or a plurality of stiffening force dissipating layers. Where such plural layers are used, the various layers could differ in the thickness from each other.

FIGS. 3-4 show the use of the invention where the sleeve 210 is mounted over a baseball bat 212 having a knob 217. The same general type structure could also be used where the implement does not have a knob similar to a baseball bat knob. FIG. 6, for example, illustrates a variation of the invention wherein the sleeve 210A would be mounted on the handle 218A of an implement that does not terminate in any knob. Such implement could be various types of athletic equipment, tools, etc. The sleeve 210A, however, would still have a knob 220A which would include an outer gripping layer 224A, an intermediate force dissipating layer 226A and an inner vibration dampening layer 222A. In the embodiment shown in FIG. 6, the handle 218A extends into the knob 220A. Thus, the inner layer 222A would have an accommodating recess 34 for receiving the handle 218A. The inner layer 222A would also be of greater thickness in the knob area as illustrated.

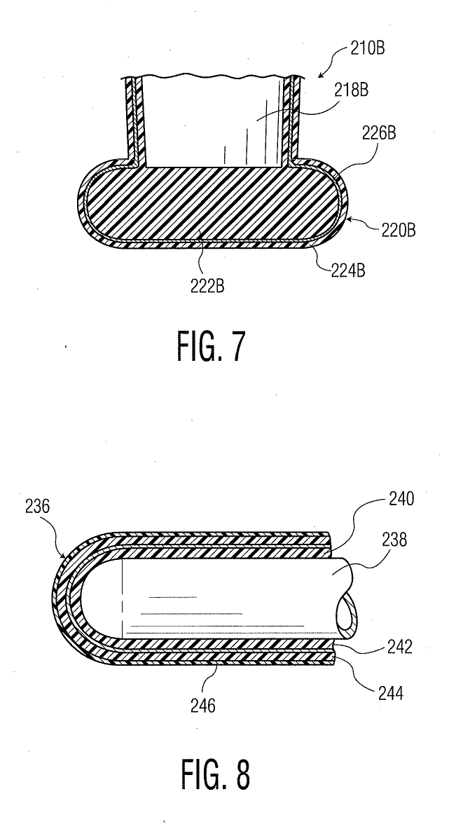

FIG. 7 shows a variation where the sleeve 2108 fits over handle 2188 without the handle 2188 penetrating the knob 220B. As illustrated, the outer gripping layer 224B would be of uniform thickness both in the gripping area and in the knob. Similarly, the intermediate force dissipating layer 226B would also be of uniform thickness. The inner shock absorbing layer 222B, however, would completely occupy the portion of the knob inwardly of the force dissipating layer 226B since the handle 218B terminates short of the knob 2220B.

FIG. 8 shows a variation of the invention where the gripping cover 236 does not include a knob. As shown therein, the gripping cover would be mounted over the gripping area of a handle 238 in any suitable manner and would be held in place either by a previously applied adhesive or due to the tacky nature of the innermost vibration dampening layer 240 or due to resilient characteristics of the cover 236. Additionally, the cover might be formed directly on the handle 238. FIG. 10, for example, shows a cover 236B which is applied in the form of tape.

As shown in FIG. 8, the cover 236 includes one of the laminate variations where a force dissipating layer 242 is provided over the inner vibration dampening layer 240 with a second vibration dampening layer 244 applied over force dissipating layer 242 and with a final thin gripping layer 246 as the outermost layer. As illustrated, the two vibration dampening layers 240 and 244 are the thickest layers and may be of the same or differing thickness from each other. The force dissipating layer 242 and outer gripping layer 244 are significantly thinner.

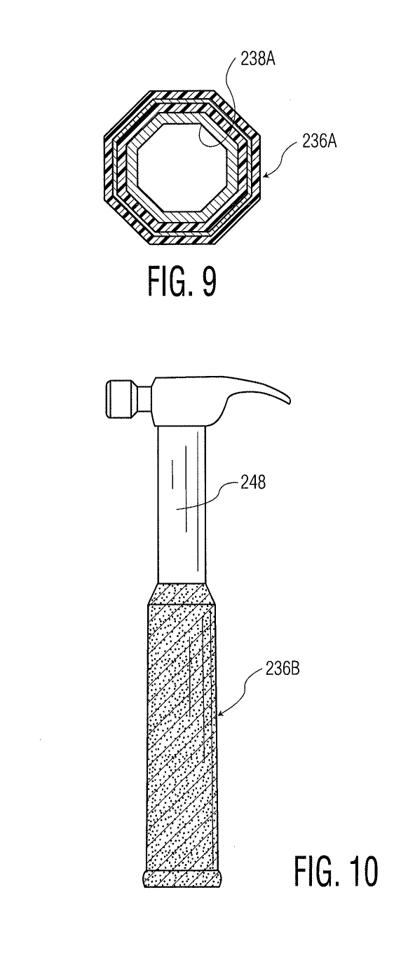

FIG. 9 shows a cover 236A mounted over a hollow handle 238A which is of non-circular cross-section. Handle 238A may, for example, have the octagonal shape of a tennis racquet.

FIG. 10 shows a further cover 236B mounted over the handle portion of tool such as hammer 248. As illustrated, the cover 236B is applied in tape form and would conform to the shape of the handle portion of hammer 248. Other forms of covers could also be applied rather than using a tape. Similarly, the tape could be used as a means for applying a cover to other types of implements.

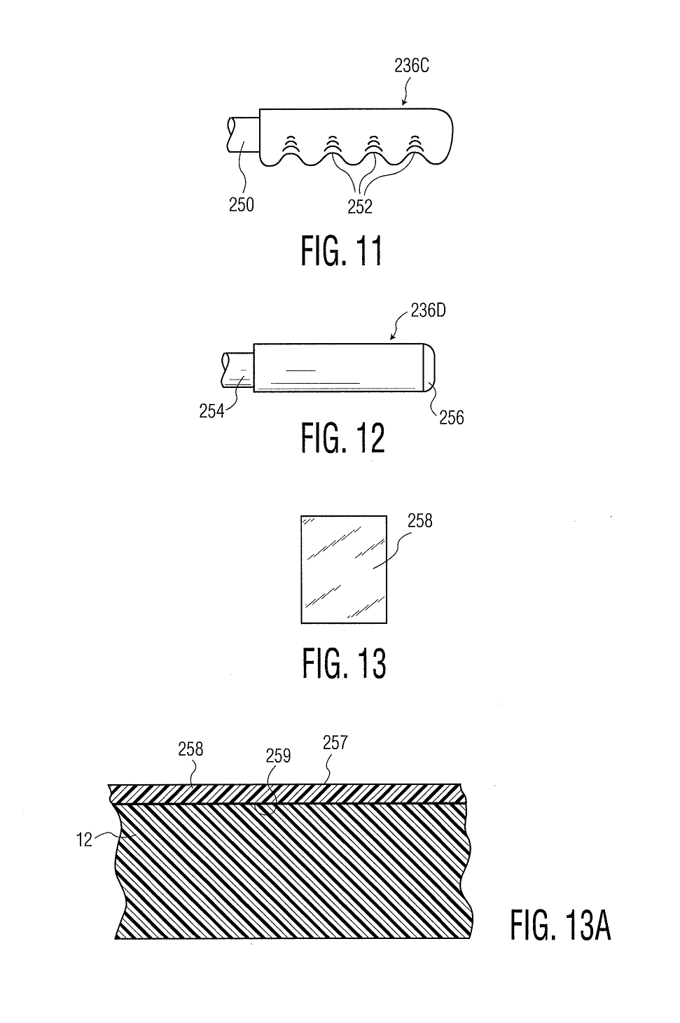

FIG. 11 illustrates a cover 236C mounted over the end of a handlebar, such as the handlebar of various types of cycles or any other device having a handlebar including steering wheels for vehicles and the like. FIG. 11 also illustrates a variation where the cover 236C has an outer contour with finger receiving recesses 252. Such recesses could also be utilized for covers of other types of implements.

FIG. 12 illustrates a variation of the invention where the cover 236D is mounted to the handle portion of an implement 254 with the extreme end 256 of the implement being bare. This illustration is to show that the invention is intended to provide a vibration dampening gripping cover for the handle of an implement and that the cover need not extend beyond the gripping area. Thus, there could be portions of the implement on both ends of the handle without having the cover applied to those portions.

In a preferred practice of the invention, as previously discussed, a force dissipating stiffening layer is provided as an intermediate layer of a multilayer laminate where there is at least one inner layer of vibration dampening material and an outer layer of gripping material with the possibility of additional layers of vibration dampening material and force dissipating layers of various thickness. As noted the force dissipating layer could be innermost. The invention may also be practiced where the laminate includes one or more layers in addition to the gripping layer and the stiffening layer and the vibration dampening layer. Such additional layer(s) could be incorporated at any location in the laminate, depending on its intended function (e.g., an adhesive layer, a cushioning layer, etc.).

The force dissipating layer could be incorporated in the laminate in various manners. FIG. 13, for example, illustrates a force dissipating stiffening layer 258 in the form of a generally imperforate sheet. FIG. 13A illustrates the stiffening layer 258 applied to an illustrative elastomer layer 12. The generally imperforate sheet may be manufactured from various high tensile strength materials, for example, a thin sheet of polypropylene, preferably having a thickness of 0.025 mm to 2.5 mm. The stiffening layer 258 has an outer major surface 257 and an inner major surface 259 secured to the elastomer layer 12. The layers 12 and 258 may be formed integrally or may be adhered to one another.

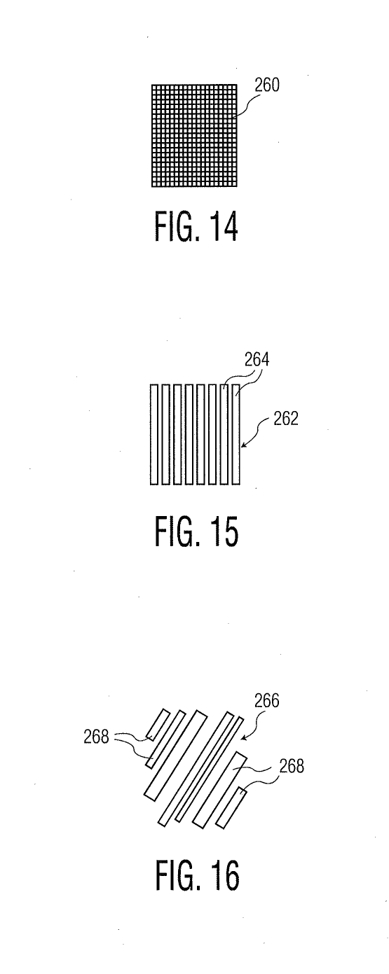

FIG. 14 illustrates a force dissipating layer 260 in the form of an open mesh sheet. This is a particularly advantageous manner of forming the force dissipating layer where it is made of KEVLAR fibers. FIG. 15 illustrates a variation where the force dissipating layer 262 is formed from a plurality of individual strips of material 264 which are parallel to each other and generally identical to each other in length and thickness as well as spacing. FIG. 16 shows a variation where the force dissipating layer 266 is made of individual strips 268 of different sizes and which could be disposed in a more random fashion regarding their orientation. Although all of the strips 268 are illustrated in FIG. 16 as being parallel, non-parallel arrangements could also be used.

The vibration dampening grip cover of this invention could be used for a wide number of implements. Examples of such implements include athletic equipment, hand tools and handlebars. For example, such athletic equipment includes bats, racquets, sticks, javelins, etc. Examples of tools include hammers, screwdrivers, shovels, rakes, brooms, wrenches, pliers, knives, handguns, air hammers, etc. Examples of handlebars include motorcycles, bicycles and various types of steering wheels.

A preferred practice of this invention is to incorporate a force dissipating layer, particularly an aramid, such as KEVLAR fiber, into a composite with at least two elastomers. One elastomer layer would function as a vibration dampening material and the other outer elastomer layer which would function as a gripping layer. The outer elastomer layer could also be a vibration dampening material. Preferably, the outer layer completely covers the composite.

There are an almost infinite number of possible uses for the composite of laminate of this invention. In accordance with the various uses the elastomer layers may have different degrees of hardness, coefficient of friction and dampening of vibration. Similarly, the thicknesses of the various layers could also vary in accordance with the intended use. Examples of ranges of hardness for the inner vibration dampening layer and the outer gripping layer (which may also be a vibration absorbing layer) are 5-70 Durometer Shore A. One of the layers may have a range of 5-20 Durometer Shore A and the other a range of 30-70 Durometer Shore A for either of these layers. The vibration dampening layer could have a hardness of less than 5, and could even be a 000 Durometer reading. The vibration dampening material could be a gel, such as a silicone gel or a gel of any other suitable material. The coefficient of friction as determined by conventional measuring techniques for the tacky and non-porous gripping layer is preferably at least 0.5 and may be in the range of 0.6-1.5. A more preferred range is 0.7-1.2 with a still more preferred range being about 0.8-1. The outer gripping layer, when also used as a vibration dampening layer, could have the same thickness as the inner layer. When used solely as a gripping layer the thickness could be generally the same as the intermediate layer, which might be about 1/20 to ¼ of the thickness of the vibration dampening layer.

The grip cover of this invention could be used with various implements as discussed above. Thus, the handle portion of the implement could be of cylindrical shape with a uniform diameter and smooth outer surface such as the golf club handle 238 shown in FIG. 6. Alternatively, the handle could taper such as the bat handle shown in FIGS. 3-4. Other illustrated geometric shapes include the octagonal tennis racquet handle 238A shown in FIG. 9 or a generally oval type handle such as the hammer 248 shown in FIG. 10. The invention is not limited to any particular geometric shape. In addition, the implement could have an irregular shape such as a handle bar with finger receiving depressions as shown in FIG. 11. Where the outer surface of the implement handle is of non-smooth configuration the inner layer of the cover could press against and generally conform to the outer surface of the handle and the outermost gripping layer of the cover could include its own finger receiving depressions. Alternatively, the cover may be of uniform thickness of a shape conforming to the irregularities in the outer surface of the handle.

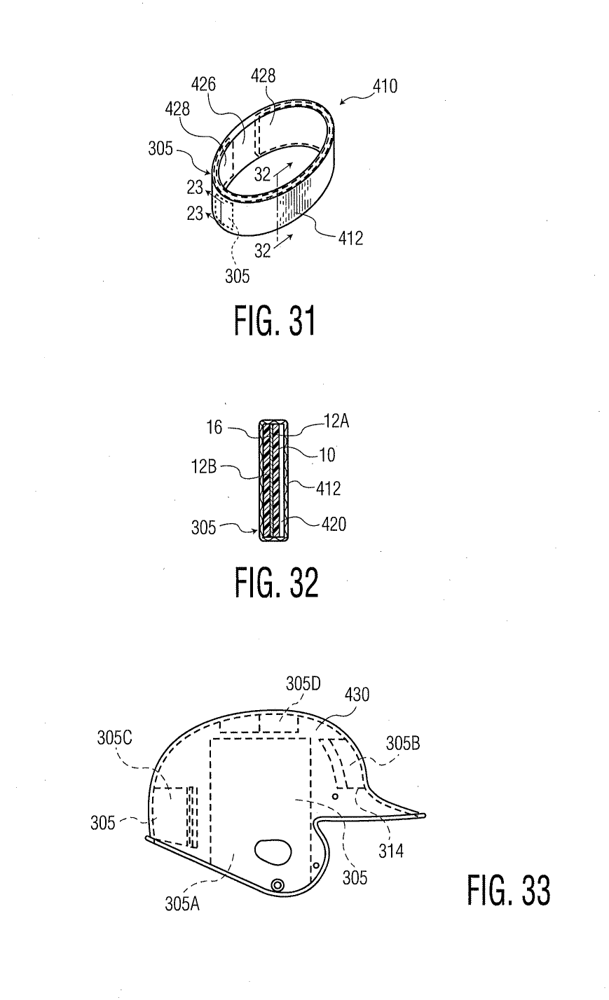

Referring to FIGS. 31 and 32, the material 10 of the present invention can be used to form part of a headband 410. The headband preferably has a peripheral outer fabric layer 412 that forms a hollow tubular shape in which the material 10 is located. Space 420 represents schematically room for one or more layers of the material 10. A particular advantage of the headband 410 is that it lends itself more readily to acceptance by users, such as children, who prefer not to wear large and cumbersome head protective gear. Although FIG. 31 shows the headband 410 to be a continuous endless flexible loop, it is to be understood that the invention could be incorporated in a headband or visor where the headband or visor does not extend completely around the head three hundred and sixty degrees. Instead, the headband or visor could be made of a stiff springy material having a pair of free ends 428 separated by a gap 426.

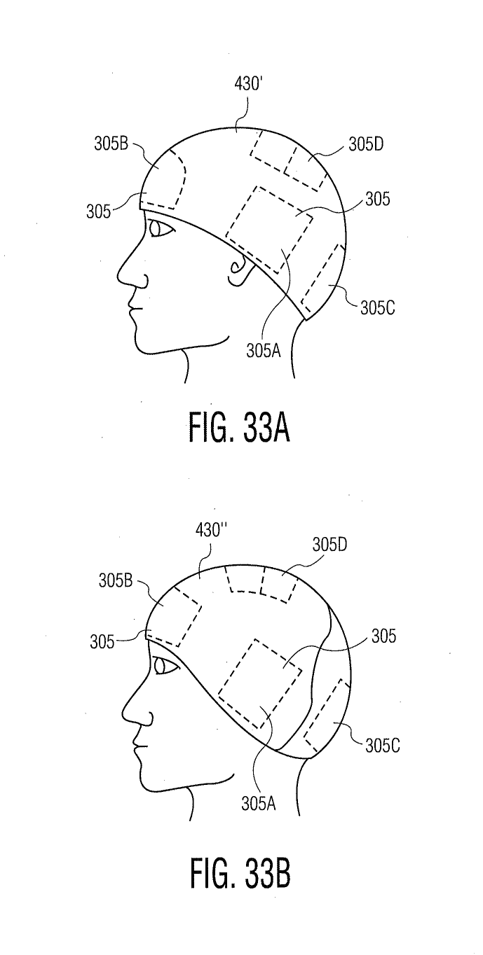

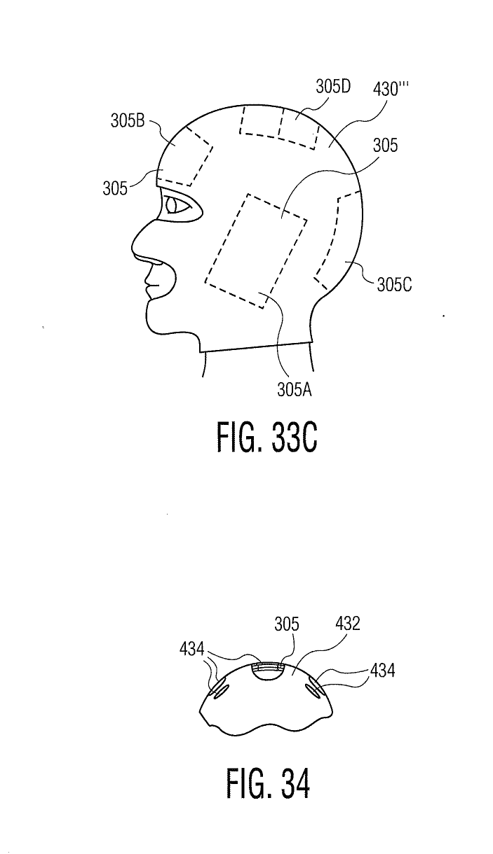

FIG. 33 shows panels 305 of material 10 incorporated into a helmet 430. The panels include temple and ear covering panels 305A; forehead covering panels 305B; neck panels 305C; and top panels 305D. FIG. 34 shows a cyclist helmet 432 with air vents 434 therein. A broken away portion of the top of the cyclist helmet shows the integration of at least one panel 305 with the helmet 432. Although two particular types of helmets are specifically discussed, those of ordinary skill in the art will appreciate from this disclosure that the material 10 can be incorporated into any type of hat (such as a hard hat or a baseball cap), helmet (such as a paintball helmet, a batting helmet, a motorcycle helmet, or an army helmet) or the like without departing from the present invention. The panel 305 can be a lining for hard shell headgear, for a shell, or for a soft cap.

For example, FIGS. 33A, 33B and 33C illustrate various soft caps or flexible headgear 430′, 430″, 430′″ incorporating panels 305 of material 10. The material 10 may be any of the materials adapted to regulate vibration described herein. The flexible headgear 430′ of FIG. 33A is a “durag” or “skull cap” typically formed from a lightweight, stretchable material, for example, cotton, nylon, polyesters, spandex, combinations thereof and other natural or synthetic materials. The flexible headgear 430′ may be worn independent of any other headgear, for example, worn by a soccer player, or may be worn under an existing helmet, for example, a football helmet or batting helmet. In this regard, the flexible headgear 430′ allows the user to “retro-fit” an existing helmet for improved vibration regulation without the need to buy a new helmet. Similarly, flexible headgear 430″ is a ski cap with a plurality of panels 305 and flexible headgear 430′″ is a ski mask with a plurality of panels 305. The ski cap and ski mask may be manufactured from various flexible cloth materials including, for example, cotton, wool, polyesters, combinations thereof and other natural or synthetic materials. Again, the flexible headgear 430″, 430′″ may be worn independent of any other headgear or may be worn under an existing helmet, for example, a ski helmet. Again, the flexible headgear 430″, 430′″ allows the user to “retro-fit” an existing helmet for improved vibration regulation without the need to buy a new helmet. The invention is not limited to the soft caps (flexible headgear) described herein, but may have other configurations with a flexible material configured to be worn a users head.

In each of these embodiments, the panels include temple and ear covering panels 305A; forehead covering panels 305B; neck panels 305C; and top panels 305D, however, the panels 305 may otherwise be positioned. The panels 305 may be positioned within pockets formed in the flexible headgear 430′, 430″, 430′″ or may otherwise be attached thereto, for example, via an adhesive, stitching or hook and loop fastener. The hook and loop fastener may allow the user to position the panels 305 as desired. Similarly, multiple pockets may be provided to allow the user to position the panels 305 as desired. The pockets may include openings which allow the panels 305 to be removed, for example, for cleaning of the headgear or repositioning of the panels 305. The openings are preferably sealable, for example, by hook and loop fastener or the like.

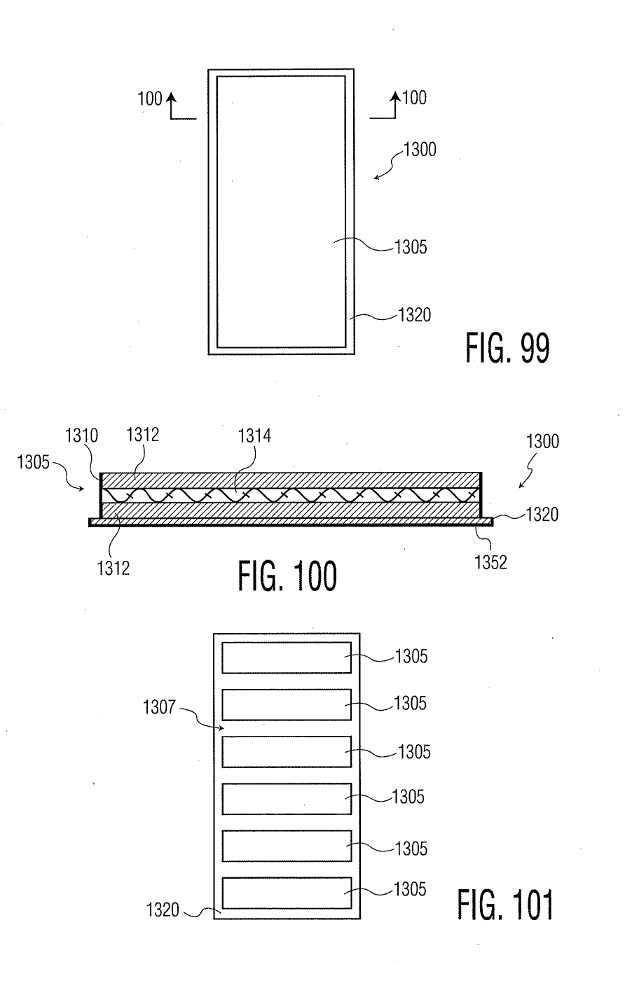

FIGS. 99-103 illustrate another embodiment of a material 1300 for retro-fitting existing products, for example, helmets of any kind. FIGS. 99 and 100 illustrate the material 1300 including a single panel 1305 of material 1310 adapted to regulate vibration. While the material 1310 is illustrated as including first and second elastomer layers 1312 and an intermediate reinforcement layer 1314, the material 1310 may be any of the materials described herein. The panel 1305 is attached to a flexible base fabric 1320 having an adhesive surface 1352 opposite the material 1310. This is similar to the adhesive material described herein with respect to FIG. 70. The panel 1305 may be attached to the base fabric 1320 in any desired manner, for example, the materials may be formed integrally or an adhesive or the like may be applied between the panel 1305 and the base fabric 1320. In one exemplary embodiment, the base fabric 1320 is formed from double-sided adhesive.

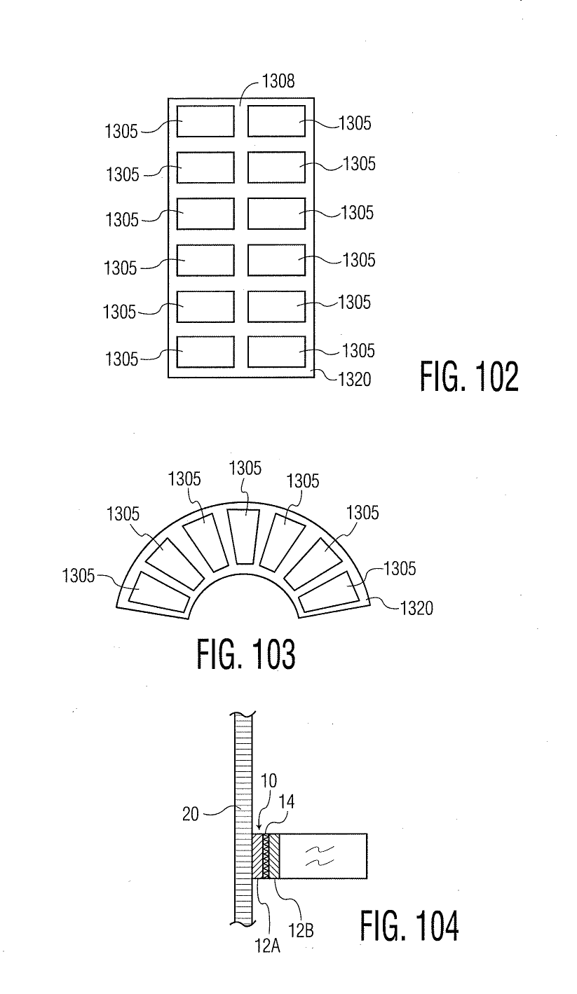

The external adhesive surface 1352 allows the material 1300 to be secured in a desired location, for example, inside a batting helmet or football helmet, Again this allows the user to “retro-fit” an existing helmet or other product for improved vibration regulation without the need to buy a new product. The material 1300 may be cut to a desired configuration. As illustrated in FIGS. 101-103, the panels 1305 may have various sizes and configurations to address different applications. For example, in the material 1300 of FIG. 101, the panels 1305 have horizontal gaps 1307 therebetween which allows the material 1300 to be applied inside a curved surface. The material 1300 of FIG. 102 includes horizontal and vertical gaps 1307, 1308 to allow greater flexibility. The material 1300 of FIG. 103 has a semi-circular configuration which may be utilized, for example, about an ear hole. Other combinations of sizes and shapes may be utilized.

As an additional benefit of the retro-fit padding, it has been found that the panels 305, 1305 positioned over original padding attached to the inside of the helmet provided enhanced vibration reduction compared to applications wherein the inventive material was applied to the shell of the helmet and then had standard padding applied to the material of the present invention. In each of the padding applications, whether in a retro-fit application or a new product application, it is preferable that the material of the present invention be positioned as the layer closest to the users body.

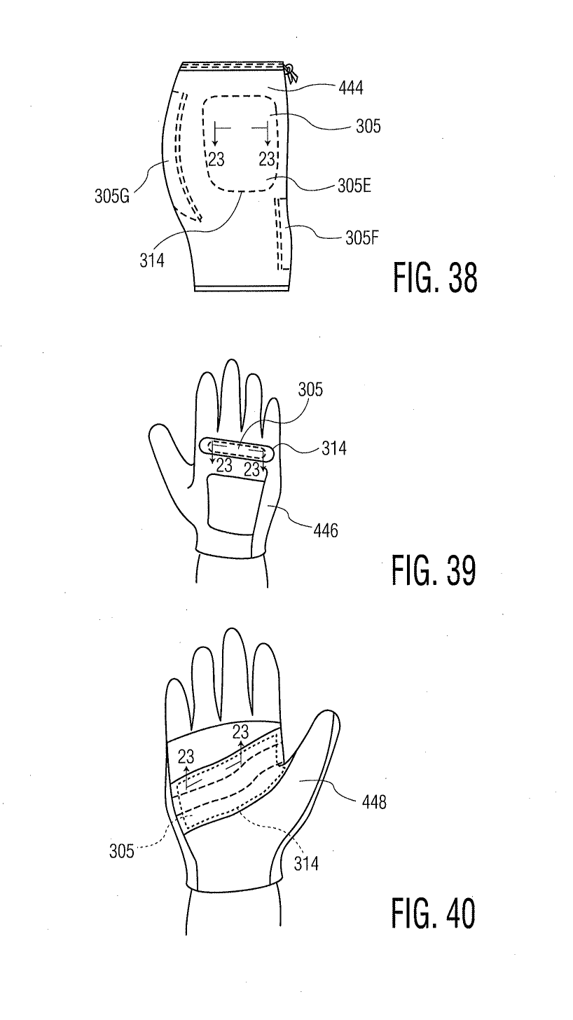

FIGS. 37 and 38 illustrate a shirt 440 and pants 444 incorporating panels 305 formed of the material 10 of the present invention. A preferred cross-section of the panels 305 is shown in FIG. 23. The shirt panels 305 can vary in number and position as desired. The pants 444 preferably include multiple panels 305, including a thigh protection panel 305F; a hip protection panel 305E; and a rear protection panel 305G.

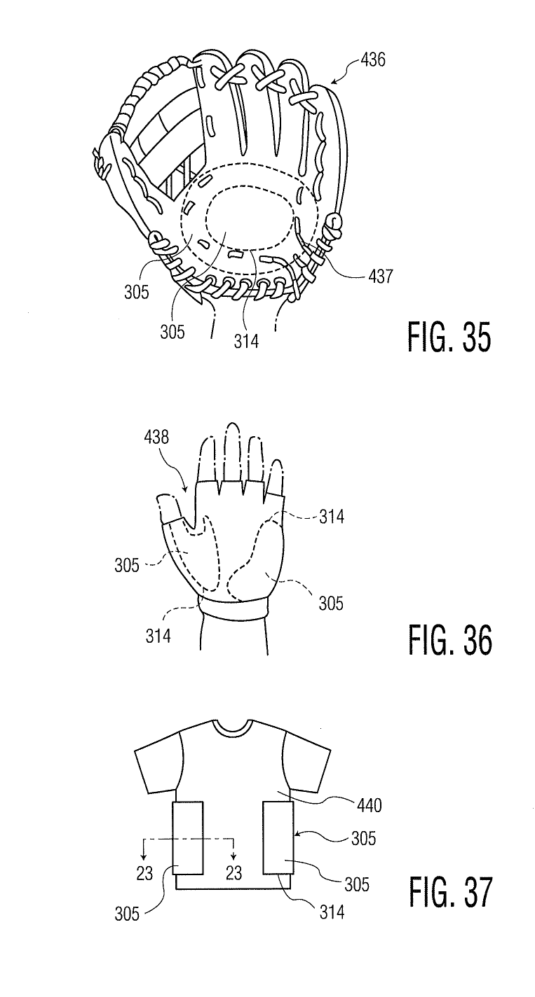

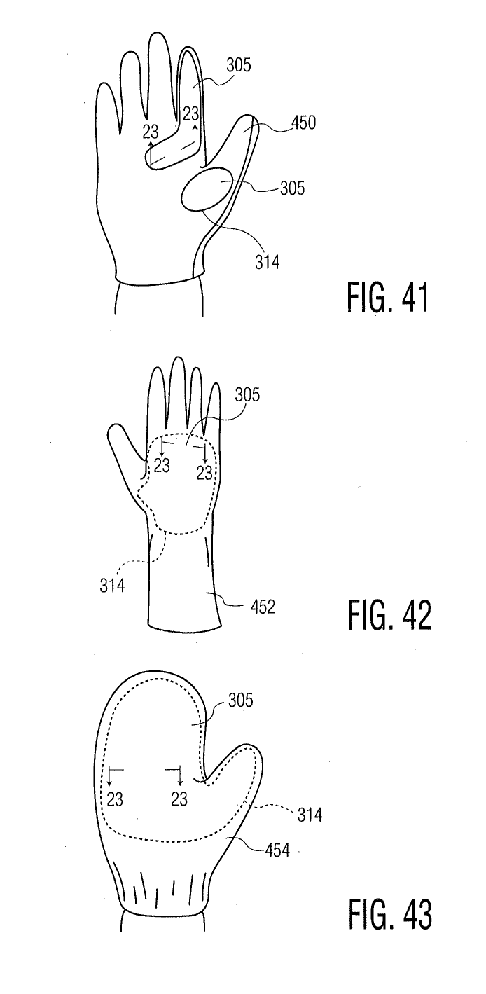

As detailed above, the material 10 of the present invention can be used to form gloves or to form panels 305 incorporated into gloves. The preferred cross-section of the glove panels 305 is also shown in FIG. 23. FIG. 35 illustrates a glove 436 suitable for both baseball and softball that uses panels 305 to provide protection to a palm area 437. FIG. 36 illustrates a weightlifting glove 438 having panels 305 of the material 10 thereon. 9 illustrates a golf glove 446 having at least one panel 305 thereon. FIG. 40 illustrates the type of glove 448 used for rope work or by rescue services personnel with panels 305 of the material 10 of the present invention. FIG. 41 shows a batting glove 450 with panels 305 thereon. The material 10 can also be used to form panels 305 for women's dress gloves 452 or ski mittens 454, as shown in FIGS. 42 and 43. Lacrosse gloves 456 and boxing gloves 458 can also be formed entirely of the material 10 of the present invention or can incorporate panels 305 of the material 10. Although specific types of gloves have been mentioned above, those of ordinary skill in the art will appreciate that the material 10 of the present invention can be incorporated into any type of gloves, athletic gloves, dress gloves, or mittens without departing from the scope of the present invention.

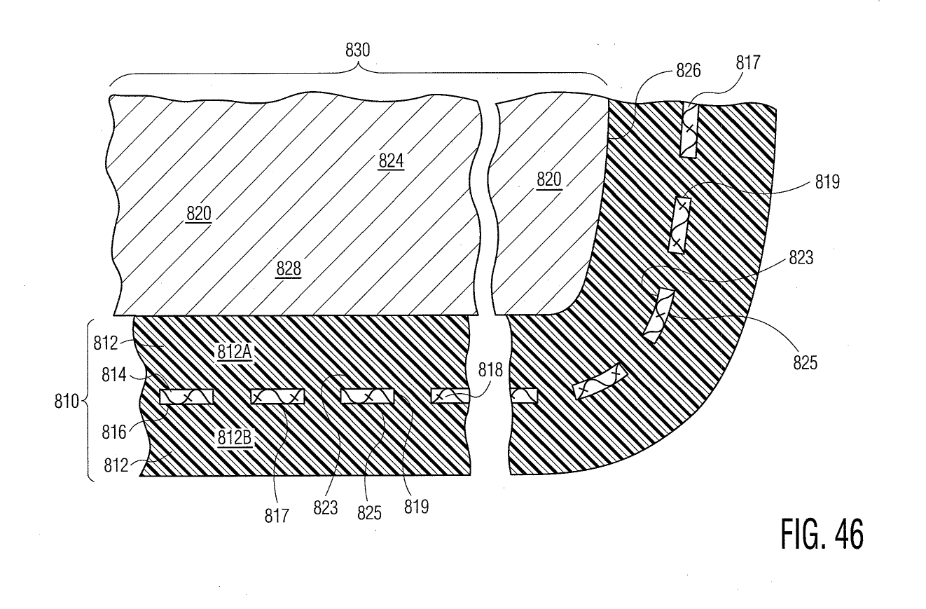

With reference to FIGS. 46-51 in particular, another embodiment of the material 810 having a single contiguous elastomer body 812 will be described. Referring to FIG. 46, the support structure has first and second major surfaces 823,825. In one embodiment, the elastomer 812 extends through the support structure 817 so that the portion of the elastomer 812A contacting the first major support structure surface 823 (i.e., the top of the support structure 817) and the portion of the elastomer 812B contacting the second major support structure surface 825 (i.e., the bottom of the support structure) form the single contiguous elastomer body 812. Elastomer material provides vibration damping by dissipating vibrational energy. Suitable elastomer materials include, but are not limited, urethane rubbers, silicone rubbers, nitrile rubbers, butyl rubbers, acrylic rubbers, natural rubbers, styrene-butadiene rubbers, and the like. In general, any suitable elastomer or polymer material can be used to form the vibration dissipating layer 812 and can take desired forms including thermoset, thermoplastic, open cell foam, or closed cell foam, as non-limiting examples.

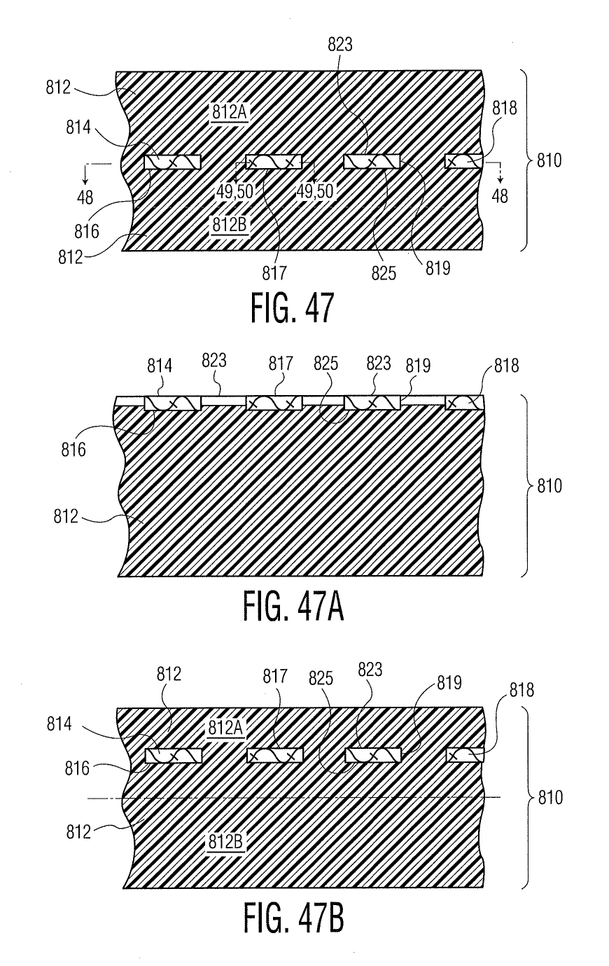

Referring to FIGS. 47-51, the support structure 817 can be any one (or combination of) of a polymer, an elastomer, a plurality of fibers, a plurality of woven fibers, and a cloth. If the support structure 817 and the layer 812 are both polymers or both elastomers, then they can be the same or different from each other without departing from the scope of the present invention. If vibration dissipating material is 812 if formed of the same material as the support structure 817, then the support structure 817 can be made more rigid than the main layer 812 by embedding fibers 814 therein. It is preferable that the support structure 817 is generally more rigid than the vibration dissipating material 812.

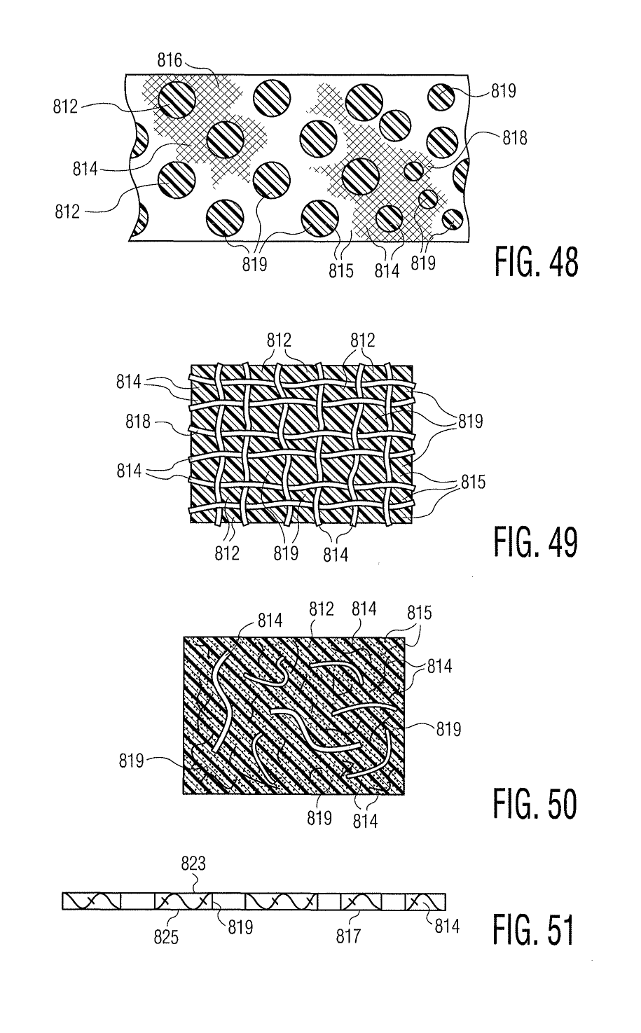

Referring specifically to FIG. 48, the support structure 817 may be formed of an elastomer that may but does not necessarily, also have fibers 814 embedded therein (exemplary woven fibers are shown throughout portions of FIG. 48). Referring to FIG. 49, the support structure 817 may be formed by a plurality of woven fibers 818. Referring to FIG. 50, the support structure 817 may be formed by a plurality of fibers 814. Regardless of the material forming the support structure 817, it is preferable that passageways 819 extend into the support structure 817 to allow the elastomer 812 to penetrate and embed the support structure 817. The term “embed,” as used in the claim and in the corresponding portions of the specification, means “contact sufficiently to secure thereon and/or therein.”

Accordingly, the support structure 817 shown in FIG. 47A is embedded by the elastomer 812 even though the elastomer 812 does not fully enclose the support structure 817. Additionally, as shown in FIG. 47B, the support structure 817 can be located at any level or height within the elastomer 812 without departing from the scope of the present invention. While the passageways 819 are shown as extending completely through the support structure 817, the invention includes passageways 819 that extend partially through the support structure 817.

Referring again to FIG. 47A, in one embodiment, it is preferred that the support structure 817 be embedded on the elastomer 812, with the elastomer penetrating the support structure 817. The support structure 817 being generally along a major material surface 838 (i.e., the support structure 817 is generally along the top of the material).

The fibers 814 are preferably, but not necessarily, formed of aramid fibers. Referring to FIG. 49, the fibers 814 can be woven to form a cloth 816 that is disposed on and/or within the elastomer 812. The cloth layer 816 can be formed of woven aramid fibers or other types of fiber. The aramid fibers 814 block and redirect vibrational energy that passes through the elastomer 812 to facilitate the dissipation of vibrations. The aramid fibers 818 redirect vibrational energy along the length of the fibers 818. Thus, when the plurality of aramid fibers 818 are woven to form the cloth 816, vibrational energy emanating from the implement 820 that is not absorbed or dissipated by the elastomer layer 812 is redistributed evenly along the material 810 by the cloth 816 and preferably also further dissipated by the cloth 816.

It is preferable that the aramid fibers 818 are formed of a suitable polyamide fiber of high tensile strength with a high resistance to elongation. However, those of ordinary skill in the art will appreciate from this disclosure that any high tensile strength material suitable to channel vibration can be used to form the support structure 817 without departing from scope of the present invention. Additionally, those of ordinary skill in the art will appreciate from this disclosure that loose high tensile strength fibers or chopped high tensile strength fibers can be used to form the support structure 817 without departing from the scope of the present invention. The high tensile strength fibers may be formed of aramid fibers, fiberglass or the like.

When the aramid fibers 818 are woven to form the cloth 816, it is preferable that the cloth 816 include at least some floating aramid fibers 818. That is, it is preferable that at least some of the plurality of aramid fibers 818 are able to move relative to the remaining aramid fibers 818 of the cloth 816. This movement of some of the aramid fibers 818 relative to the remaining fibers of the cloth converts vibrational energy to heat energy.

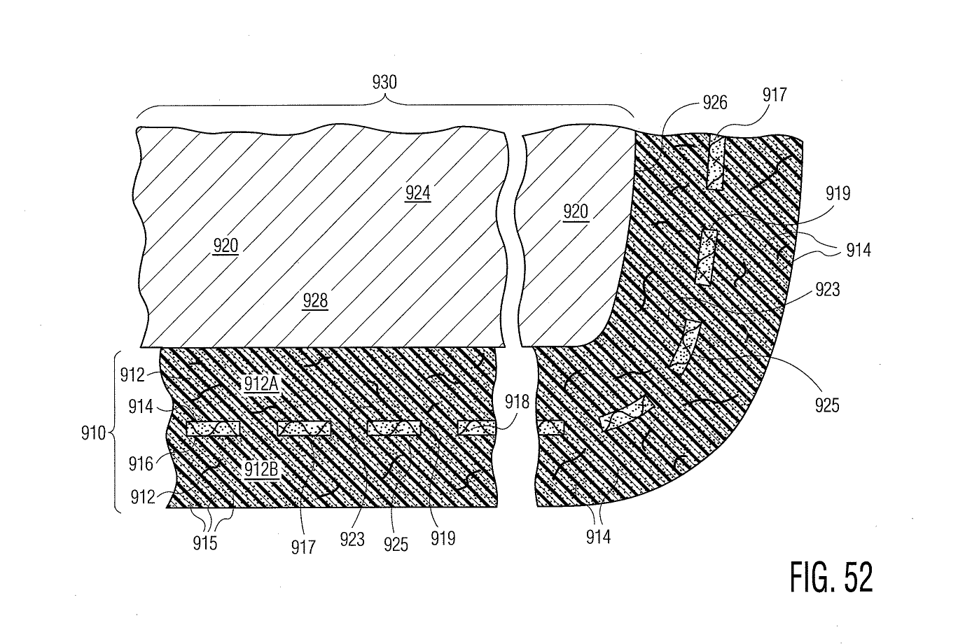

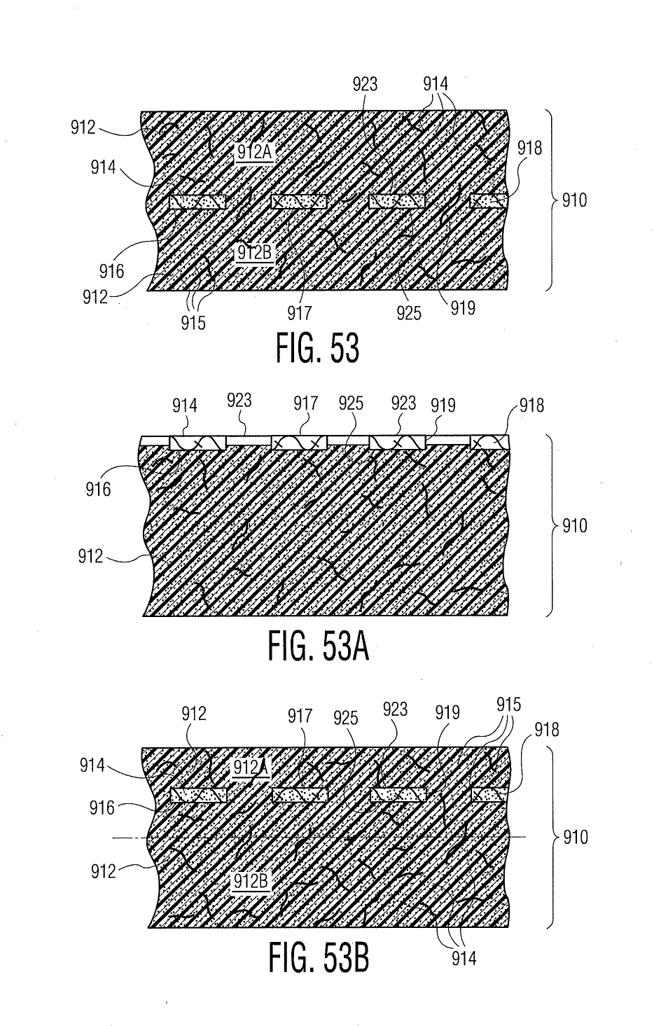

With reference to FIGS. 52-53, the elastomer layer 912 acts as a shock absorber by converting mechanical vibrational energy into heat energy. The embedded support structure 917 redirects vibrational energy and provides increased stiffness to the material 910 to facilitate a user's ability to control an implement 920 encased, or partially encased, by the material 910. The elastomer layer 912, 912A, or 912B may include a plurality of fibers 914 (further described below) or a plurality of particles 915 (further described below). The incorporation of the support structure 917 on and/or within the material 910 allows the material 910 to be formed by a single elastomer layer without the material 910 being unsuitable for at least some of the above-mentioned uses. The support structure 917 may also include a plurality of fibers 914 or a plurality of particles 915. However, those of ordinary skill in the art will appreciate from this disclosure that additional layers of material can be added to any of the embodiments of the present invention disclosed below without departing from the scope of the invention.

In the situation where the support structure 917 is formed by a second elastomer layer, the two elastomer layers can be secured together via an adhesive layer, discreet adhesive locations, or using any other suitable method to secure the layers together. Regardless of the material used to form the support structure 917, the support structure is preferably located and configured to support the first elastomer layer (see FIGS. 53-53B).

It is preferred that the material 910 have a single contiguous elastomer body 912. Referring to FIG. 52, the support structure has first and second major surfaces 923, 925. In one embodiment, the elastomer 912 extends through the support structure 917 so that the portion of the elastomer 912A contacting the first major support structure surface 923 (i.e., the top of the support structure 917) and the portion of the elastomer 912B contacting the second major support structure surface 925 (i.e., the bottom of the support structure) form the single contiguous elastomer body 912. Elastomer material provides vibration damping by dissipating vibrational energy. Suitable elastomer materials include, but are not limited, urethane rubbers, silicone rubbers, nitrile rubbers, butyl rubbers, acrylic rubbers, natural rubbers, styrene-butadiene rubbers, and the like. In general, any suitable elastomer or polymer material can be used to form the vibration dissipating layer 912 and can have various forms including thermoplastic, thermoset, open cell foam and closed cell foam, as unlimiting examples.

Referring to FIG. 53A, in one embodiment, it is preferred that the support structure 917 be embedded on the elastomer 912, with the elastomer penetrating the support structure 917. The support structure 917 being generally along a major material surface 938 (i.e., the support structure 917 is generally along the top of the material).

The fibers 914 are preferably, but not necessarily, formed of aramid fibers. However, the fibers can be formed from any one or combination of the following: bamboo, glass, metal, elastomer, polymer, ceramics, corn husks, and/or any other renewable resource. By using fibers from renewable resources, production costs can be reduced and the environmental friendliness of the present invention can be increased.

Particles 915 can be located in either an elastomer layer 912, 912A, and/or 912B and/or in the support structure 915. The particles 915 increase the vibration absorption of the material of the present invention. The particles 915 can be formed of pieces of glass, polymer, elastomer, chopped aramid, ceramic, chopped fibers, sand, gel, foam, metal, mineral, glass beads, or the like. Gel particles 915 provide excellent vibration dampening due to their low durometer rating. One exemplary gel that is suitable for use the present invention is silicone gel. However, any suitable gel can be used without departing from the present invention.

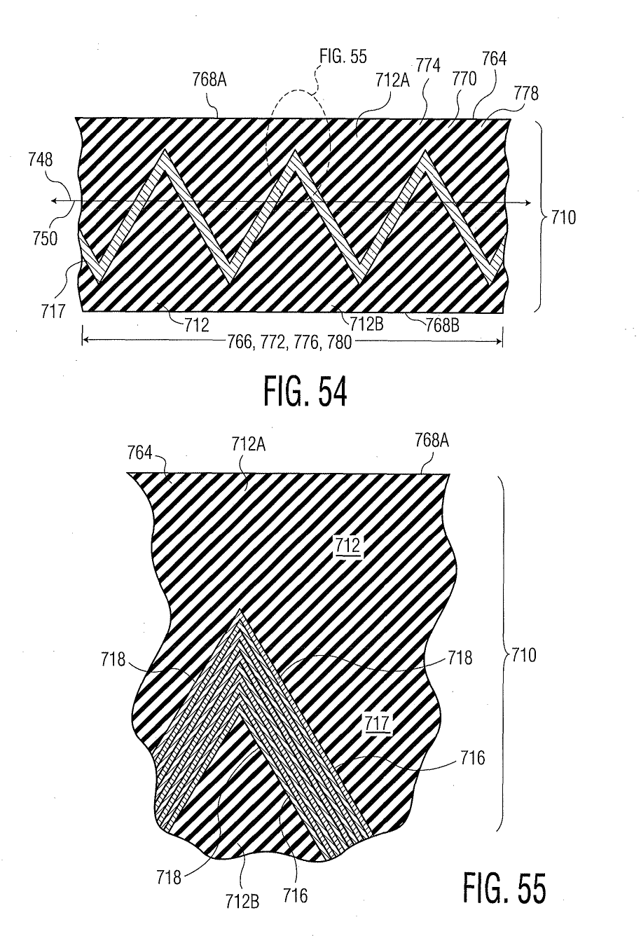

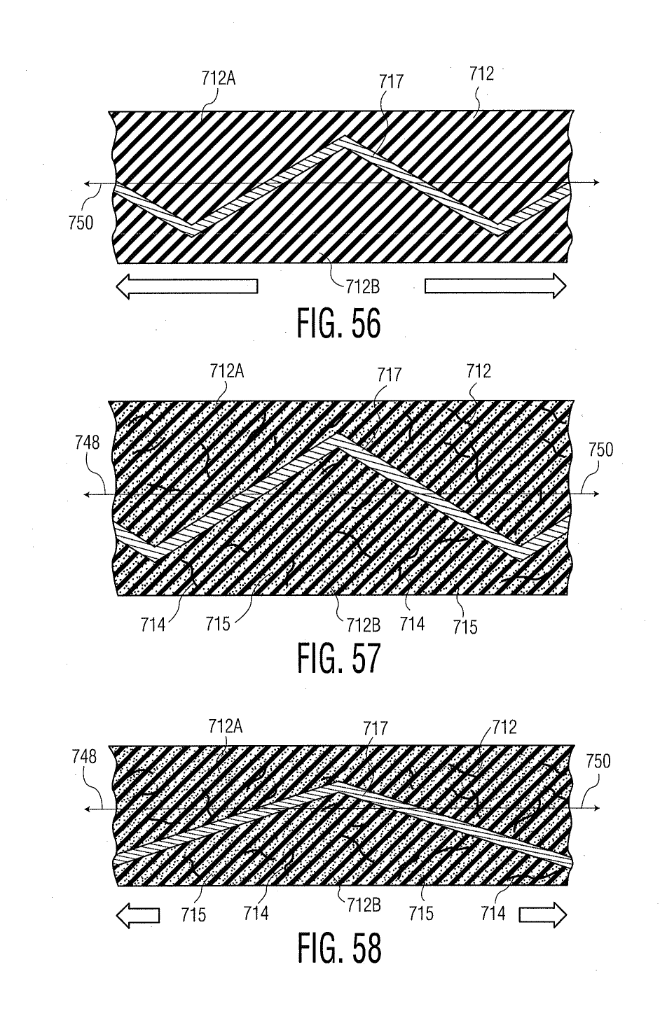

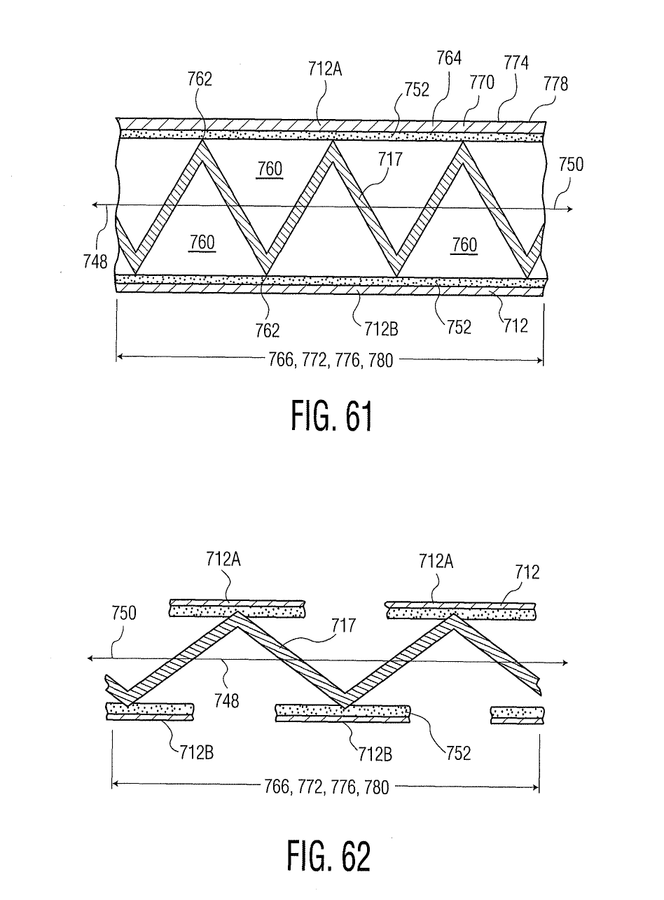

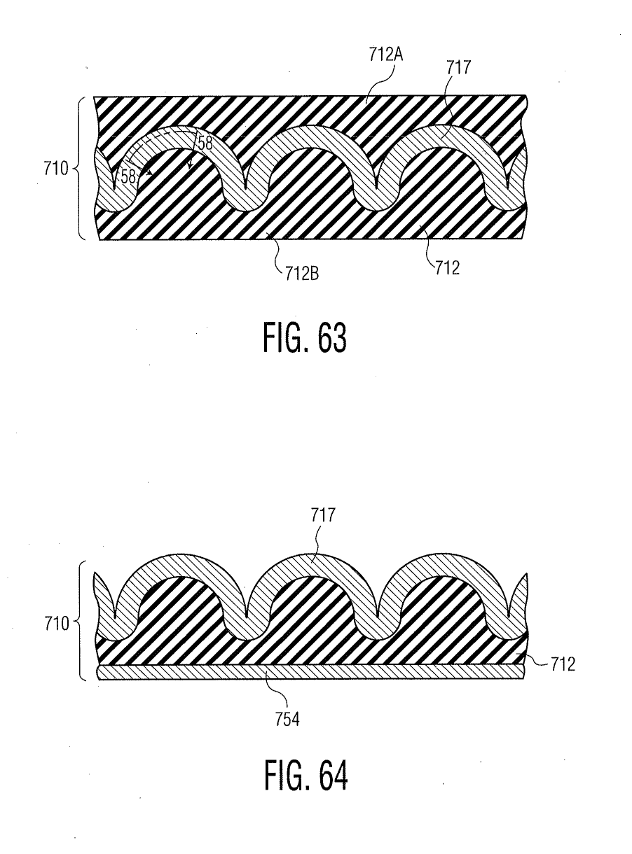

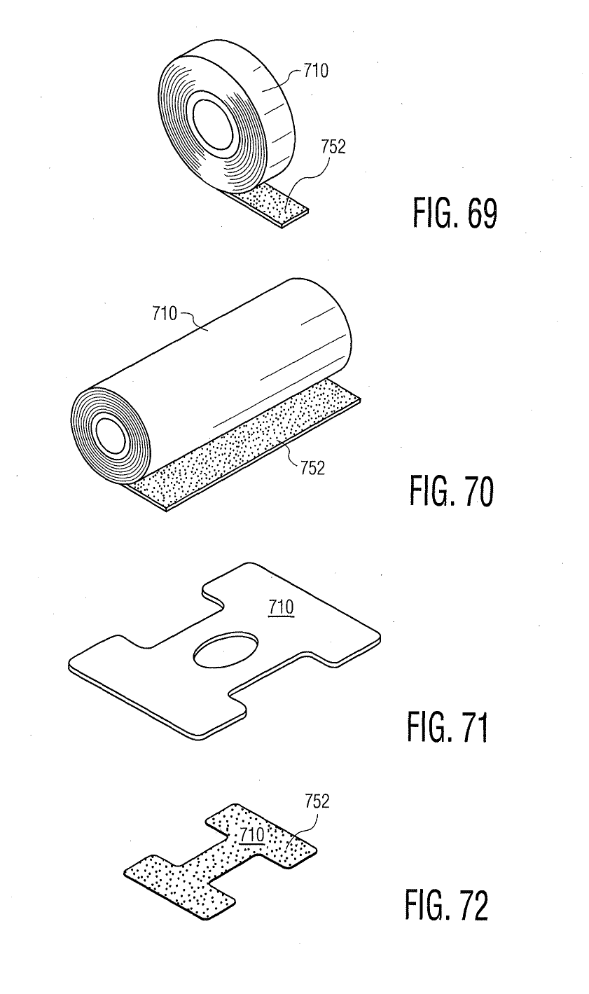

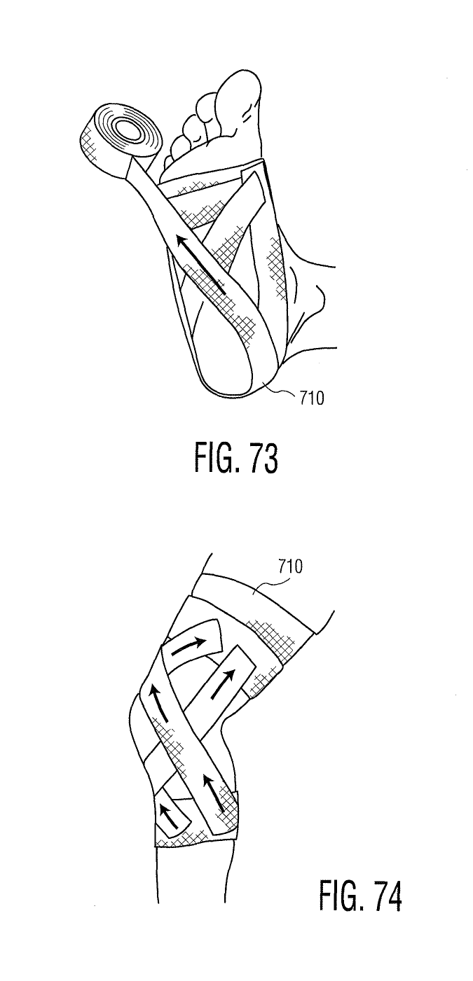

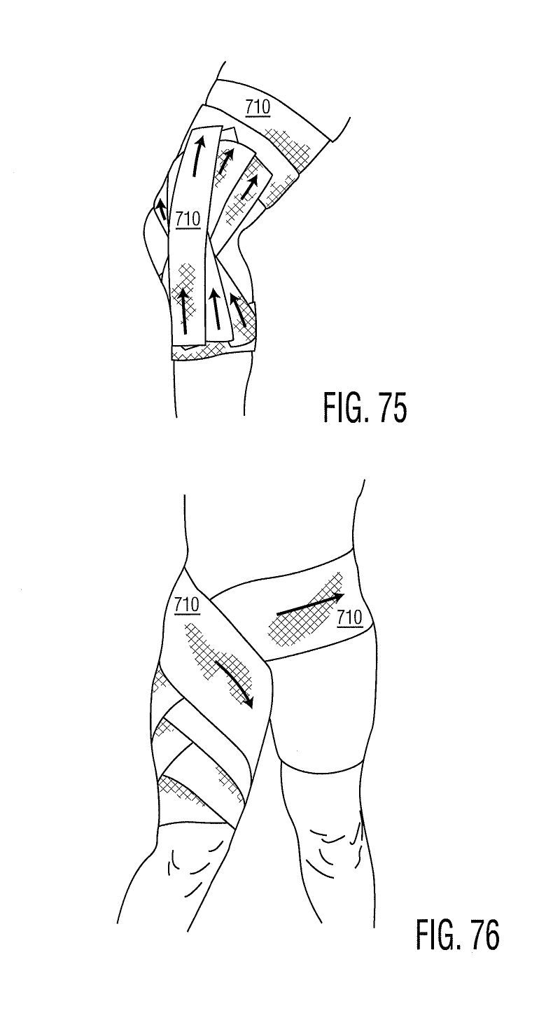

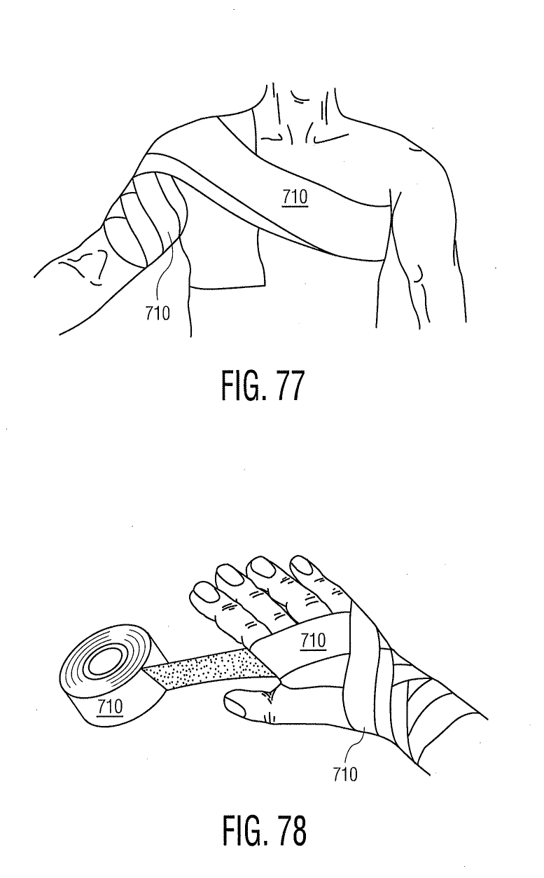

In addition to use with implements, sleeves, covers, and the like described above, the material can be used as an athletic tape, padding, bracing material, or the like (as shown in FIGS. 54-78) without departing from the scope of the present invention. Referring to FIGS. 69-78; an athletic tape for wrapping a portion of a person's body; a material having a stretch axis and being adapted to regulate energy by disputing and partially dissipating energy exerted thereon; a padding for covering a portion of a person's body or an object; and/or a brace for wrapping a portion of a person's body is shown

When the material of the present invention is used to form athletic tape, that athletic tape provides a controlled support for a portion of the person's body. The athletic tape includes a tape body 764 that is preferably stretchable along a longitudinal axis 748 (or stretch axis 750) from a first position to a second position, in which the tape body 764 is elongated by a predetermined amount relative to the first position.

FIGS. 54 and 56 illustrate another embodiment of the material of the present invention in the first and second positions, respectively. FIGS. 57 and 58 illustrate an alternative embodiment of the material of the present invention in the first and second positions, respectively.

As described below, the configuration of the support structure 717 within the vibration absorbing layer 712 allows the predetermined amount of elongation to be generally fixed so that the athletic tape provides a controlled support that allows limited movement before applying a brake on further movement of the wrapped portion of a person's body. This facilitates movement of a wrapped joint while simultaneously dissipating and absorbing vibration to allow superior comfort and performance as compared to that experienced with conventional athletic tape. While the predetermined amount of elongation can be set to any value, it is preferably less than twenty (20%) percent. The predetermined amount of elongation is more preferably less than two (2%) percent. However, depending on the application any amount of elongation can be used with the material 10 of the present invention.

The tape body 64 preferably includes a first elastomer layer 712 that defines a tape length 766, as measured along the longitudinal axis 748, of the tape body 764. The support structure 717 is preferably disposed within the elastomer layer 712 generally along the longitudinal axis 748 in an at least partially non linear fashion while the tape body is in the first position so that a length of the support structure 717, as measured along a surface thereof, is greater than the tape length 766 of the first elastomer layer 712. It is preferred, by not necessary, that the support structure 717 (or ribbon material) is positioned in a generally sinusoidal fashion within the elastomer layer 712 while the tape body 764 is in the first position. However, the support structure 717 can be positioned in an irregular fashion without departing from the scope of the present invention. As described above, the support structure 717 and/or the elastomer layer 712 can include particles, fibers, or the like (as shown in FIGS. 52 and 53).

Referring to FIGS. 56 and 58, when the tape body 764 is stretched into the second position, the support structure 717 is preferably at least partially straightened so that the support structure 717 is more linear (or in the case of other materials, the support structure 717 would likely be thinner), relative to when the tape body 764 is in the first position. The straightening of the support structure causes energy to be dissipated and preferably generally prevents further elongation of the elastomer layer 712 along the longitudinal axis 748 past the second position. Energy dissipation occurs due to the stretching of the material of the support structure 717 and can occur due to the separation or partial pulling away of the support structure 717 from the attached elastomer layer 712.

Referring to FIG. 55, the “overall support structure” 717 may comprise a plurality of stacked support structures, fibers 718, and/or cloth layers 716. It is preferred that the plurality of fibers include aramid fibers or other high tensile strength fibrous material, for example, the plurality of fibers may be formed of fiberglass material or be woven into a ribbon or cloth. The support structure can include any one (or combination) of a polymer, an elastomer, particles; fibers; woven fibers; a cloth; a plurality of cloth layers; loose fibers, chopped fibers, gel particles, particles, sand, or the like without departing from the scope of the present invention.

As detailed above, the support structure 717 and/or the elastomer layer 712 may include a plurality of particles therein. Such particles may include any one or combination of gel particles, sand particles, glass beads, chopped fibers, metal particles, foam particles, sand, or any other particle in parting desirable vibration dissipation characteristics to the material 710.

Referring to FIGS. 54 and 55, it is preferred that the tape body 764 have top and bottom surfaces 768A, 768B, respectively. The bottom surface 768B faces the portion of the person's body when the athletic tape 710 is wrapped thereover. When the support structure 717 is formed by a plurality of fibers 718, it is preferable that the plurality of fibers 718 define multiple stacked fiber layers between the top and bottom surfaces 768A, 768B. It is preferable that the plurality of fibers 718 are stacked between four (4) and sixteen (16) times between the top and bottom surfaces 768A, 768B. It is more preferable still that the plurality of fibers are stacked ten (10) times. As described above, the plurality of fibers 718 may include metal fibers, high tensile strength fibrous material, ceramic fibers, polymer fibers, elastomer fibers, or the like without departing from the scope of the present invention. As shown in FIG. 64, the support structure 717 may be disposed only partially within or on the elastomer layer generally along the longitudinal axis without departing from the scope of the present invention.

Referring again to FIGS. 54-58, the material of the present invention can be an all purpose material for use as desired by a person to regulate energy by distributing and partially dissipating energy exerted thereon. When the material 710 of the present is used as an all purpose material, the all purpose material 710 includes a material body 770 that is elongateable along the stretch axis 750 from a first position (shown in FIGS. 54 and 57) to a second position (shown in FIGS. 55 and 58), in which the material body 770 is elongated by a predetermined amount relative to the first position. The stretch axis 750 is preferably determined during manufacturing by the orientation and geometry of the support structure 717 which preferably limits the directions in which the material body 770 can elongate. If multiple separate material bodies 770 are stacked together, it may be desirable to have the stretch axis 750 of the individual material bodies 770 oriented askew from each other.

The first elastomer layer 712 defines a material length 772, as measured along the stretch axis 750 of the material body 770. The support structure 717 is preferably disposed within the elastomer layer 712 generally along the stretch axis 750 in an at least partially non linear fashion while the material body 770 is in the first position so that a length of the support structure, as measured along the surface thereof, is greater than the material length 772 of the first elastomer layer. When the material body 770 is elongated into the second position, the support structure 717 is at least partially straightened so that the support structure is more linear, relative to when the material body 770 is in the first position.

The support structure 717 is preferably positioned in a sinusoidal fashion within any of the materials 710 of the present invention. The support structure 717 or ribbon may also be positioned in the form of a triangular wave, square wave, or an irregular fashion without departing from the scope of the present invention.

Any of the materials of the present invention may be formed with an elastomer layer 712 formed by silicone or any other suitable material. Depending upon the application, the vibration absorbing material 712 may be a thermoset and/or may be free of voids therein.

Any of the embodiments of the material 710 can be used as an implement cover, grip, athletic tape, an all purpose material, a brace, and/or padding. When the material 710 of the present invention is used as part of a padding, the padding includes a padding body 774 that is elongateable along the stretch axis from a first position to a second position, in which the padding body 774 is elongated by a predetermined amount relative to the first position. The padding includes a first elastomer layer 712 which defines a padding length 776, as measured along the stretch axis 750 of the padding body 774.

The support structure 717 is disposed within the elastomer layer 712 generally along the stretch axis 750 in an at least partially non linear fashion while the padding body 774 is in the first position so that a length of the support structure 717, is measured along a surface thereof, is greater than the padding length 776 of the first elastomer layer 712. When the padding body 774 is elongated into the second position, the support structure 717 is at least partially straightened so that the support structure is more linear, relative to when the padding body 774 is in the first position. The straightening of the support structure 717 causes energy to be dissipated and generally prevents further elongation of the elastomer layer along the stretch axis 750 past the second position.

When the materials 710 of the present invention are incorporated as part of a brace, the brace provides a controlled support for a wrapped portion of a person's body. The brace includes a brace body 778 that is elongateable along the stretch axis 750 from a first position to a second position, in which the brace body 778 is elongated by a predetermined amount relative to the first position. The brace body includes a first elastomer layer 712 that defines a brace length 780, as measured along the stretch axis 750, of the brace body 778.

The support structure 717 is preferably disposed within the elastomer layer generally along the stretch axis 750 in an at least partially non linear fashion while the brace body 778 is in the first position so that a length of the support structure 717, as measured along a surface thereof, is greater than the brace length 780 of the first elastomer layer 712. When the brace body 778 is stretched into the second position, the support structure 717 is at least partially straightened so that the support structure 717 is more linear, relative to when the brace body 778 is in the first position. The straightening of the support structure 717 causes energy to be dissipated and preferably generally prevents further elongation of the elastomer layer 712 along the stretch axis past the second position. Those ordinarily skilled in the art will appreciate that any of the materials 710 of the present invention may be formed into a one piece brace that provides a controlled support as described above without departing from the scope of the present invention.

Referring to FIGS. 54 and 57, depending upon the geometry of the support structure 717 when the material 710 is in the first position, the amount of stretch of the material 710 can be selected. It is preferred that the percentage increase in the material length when the body 764, 770, 774, 778 moves from the first position to the second position is selected based on a desired range of motion. When the material 710 is configured as an athletic tape, the athletic tape may be wrapped about a portion of a person's body multiple times, if necessary, to form a brace. Alternatively, a single layer of material 710 can be wrapped on a person and secured in place using conventional athletic tape or the like. It is preferable that the successive wrappings of athletic tape are affixed to each other to form a generally one piece brace. This can be accomplished by using tape that is self fusing to allow multiple adjacent wrappings of the athletic tape to fuse together to form an integral piece. One method of fusing wrappings of the athletic tape is for the elastomer layer of each of the multiple adjacent wrappings to contact the elastomer layer of the adjacent wrappings to fuse together to form a single elastomer layer. Self fusing technology can be used with any of the materials 710 of the present invention and can be used in any of the applications for which those materials are suitable. By way of non limiting example, self fusing material 710 can be used with baseball bats, lacrosse sticks, tennis rackets, gun covers and wraps, implements, sports implements, tape, padding, braces, or the like.

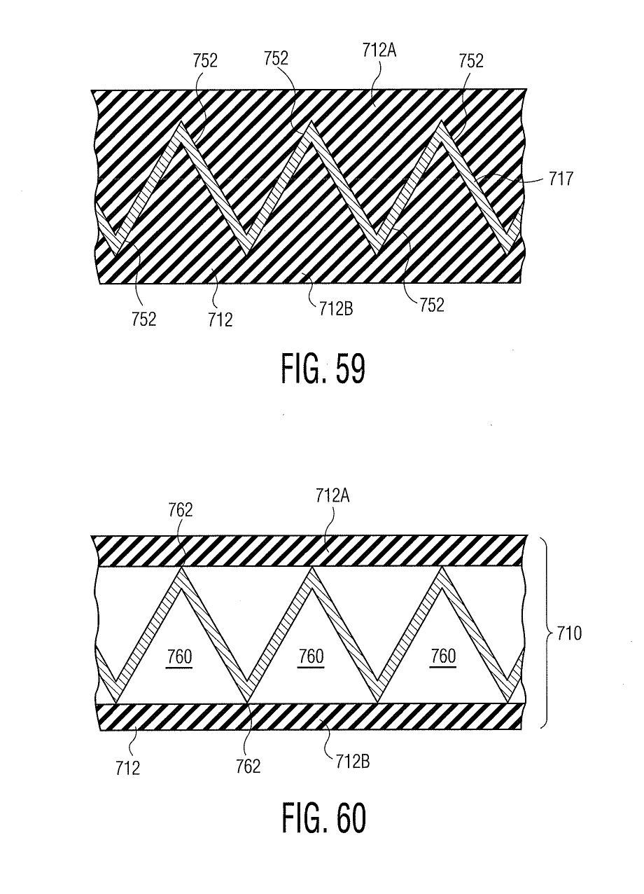

Referring to FIGS. 59, 60, and 62, adhesive 752 may be used to connect the support structure 717 to the vibration absorbing material 712. Referring to FIGS. 60-62, air gaps 760 can be present proximate to the support structure 717 without departing from the scope of the present invention. Referring to FIG. 60, the material can be secured at its peak 762 to the vibrating absorbing material 712 or can be secured only at its ends with the vibration absorbing material 712 forming a protective sheath for the support structure 717 which would act as an elastic member in this instance.

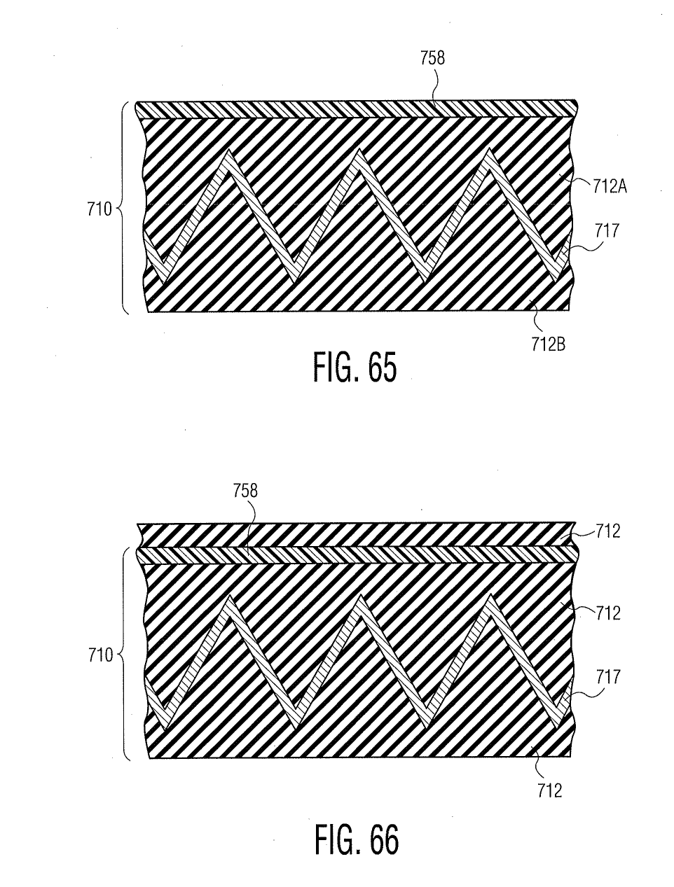

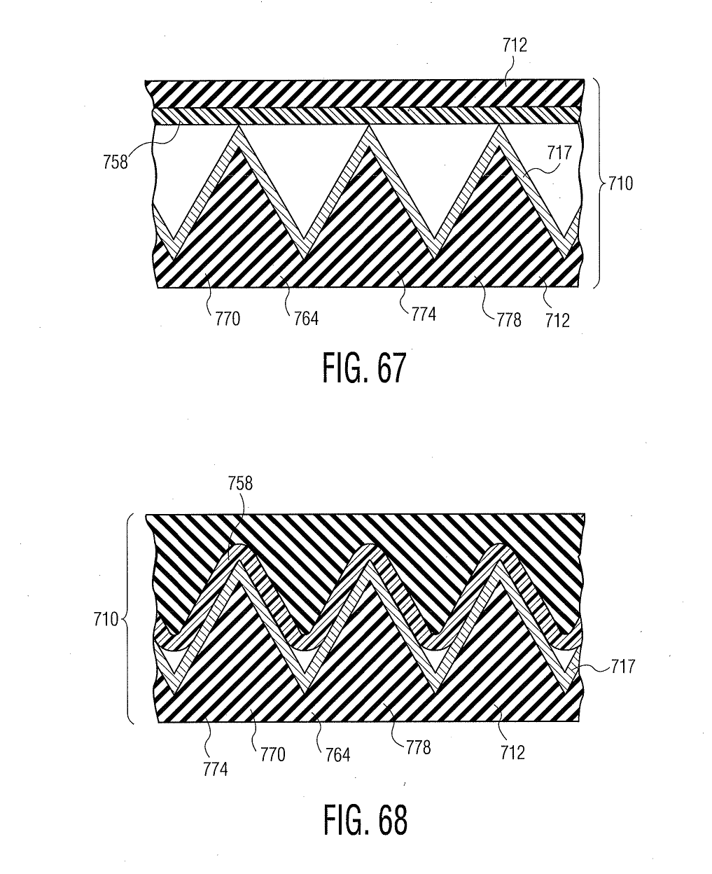

FIGS. 65-68 illustrate the material 710 of the present invention incorporating a shrink layer 758 which can be used to secure the material 710 in position. Additionally, the shrinkable layer 758 may be configured to break when a certain stress threshold is reached to provide further energy dissipation. Referring to FIG. 67, a shrinkable layer 758 is in its pre-shrink configuration. Referring to FIG. 68, once the shrinkable layer 758 has been activated, the shrinkable layer 758 preferably deforms about one side of the support structure 717 to hold the material 710 in position. The shrinkable layer 758 can be heat or water activated. Alternative known activation methods are also suitable for use with the present invention.

FIG. 62 illustrates another embodiment of the present invention in which the vibration absorbing layer 712 is configured to break apart during the elongation of the support structure 717 to allow for greater energy dissipation.

Any of the materials 710 of the present invention can be used in conjunction with additional layers of rigid or flexible materials without departing from the scope of the present invention. For example, the materials 710 of the present invention may be used with a hard shell outer layer which is designed to dissipate impact energy over the entire material 710 prior to the material 710 deforming to dissipate energy. One type of rigid material that can be used in combination with the materials 710 of the present invention is molded foam. Molded foam layers preferably include multiple flex seams that allow portions of the foam layer to at least partially move relative to each other even though the overall foam layer is a single body of material. This is ideal for turning an impact force into a more general blunt force that is spread over a larger area of the material 710. Alternatively, individual foam pieces, buttons, rigid squares, or the like can be directly attached to an outer surface of any of the materials 710 of the present invention. Alternatively, such foam pieces, buttons, rigid squares, or the like can be attached to a flexible layer or fabric that will dissipate received impact energy over the length of the fabric fibers prior to the dissipation of energy by the material 710.

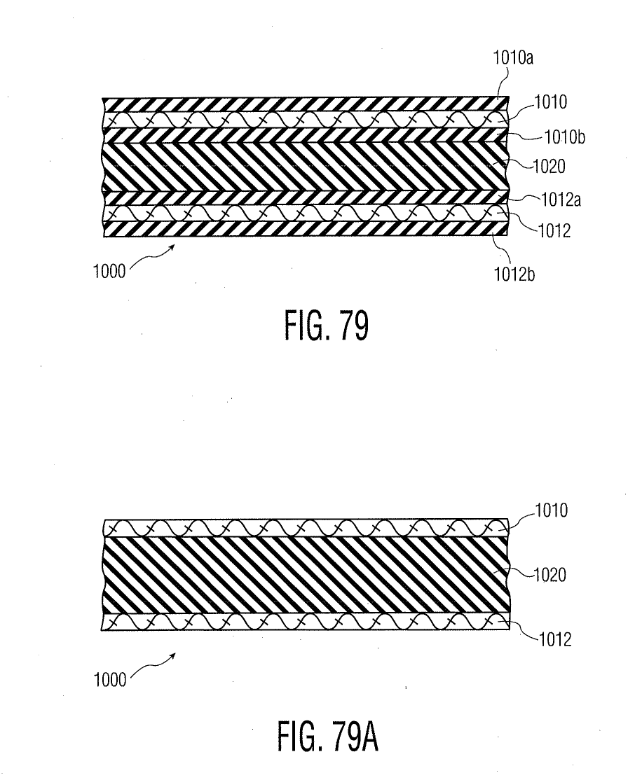

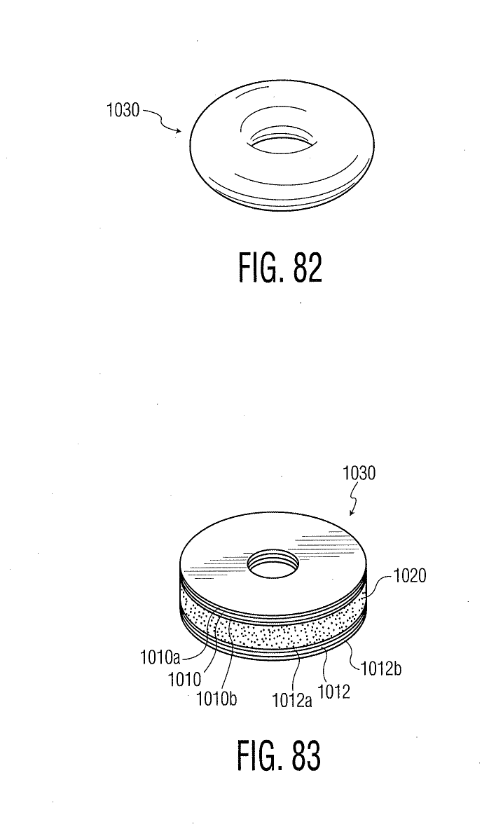

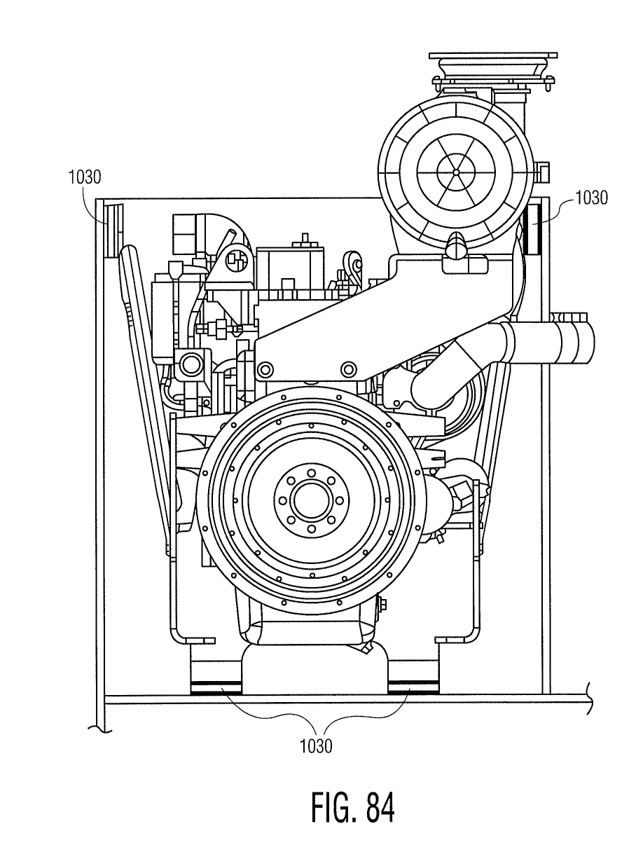

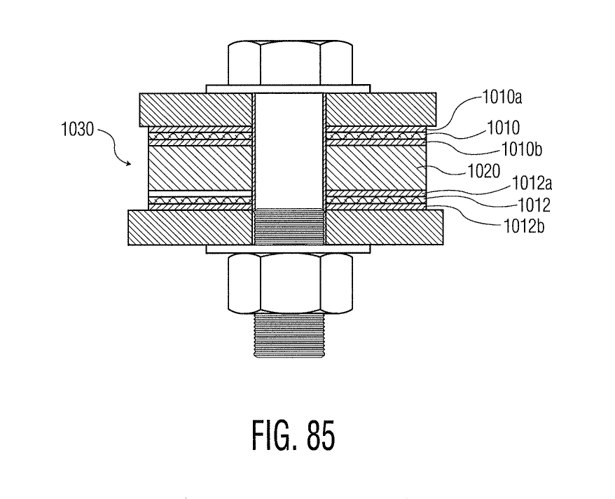

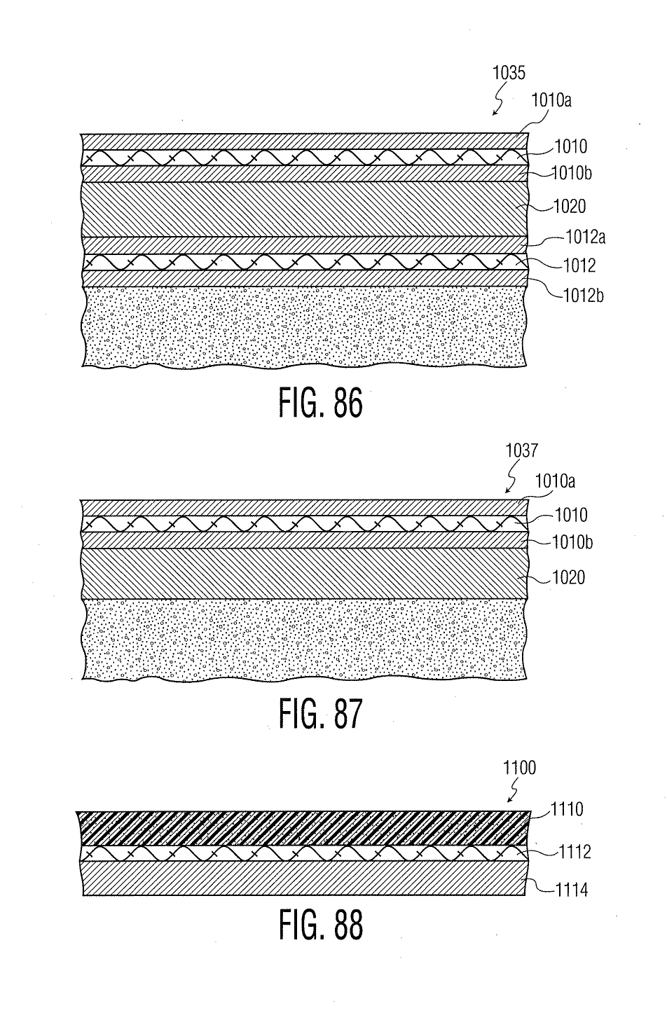

FIGS. 79, 79a, and 82-86 show yet another embodiment of the inventive material of the invention, in which the material comprises two aramid layers 1010, 1012 with an elastomeric layer 1020 therebetween shown in the simplest configuration in FIG. 79a). The applicant has found that this configuration is an effective padding for high weight or impact resistant configurations because the aramid material layers 1010, 1012, resist impact and discourage displacement of the elastomeric layer 1020. This allows for the use of very low durometer elastomers, rubbers, and gels, with durometers in the hundred to thousand ranges while still providing excellent stability.

Alternately, rather than using aramid layers, other fibers could be used, including high tensile strength fibers.

While other high tensile strength materials could be used, aramids with a tensile modulus of between 70 and 140 GPa are preferred, and nylons such as those with a tensile strength of between 6,000 and 24,000 psi are also preferred. Other material layers and fibers could substitute for the aramid layers 1010, 1012; in particular, low tensile strength fibers could be combined with higher tensile strength fibers to yield layers 1010, 1012 that would be suitable to stabilize and contain the elastomeric layer 1020. For example, cotton, kenaf, hemp, flax, jute, and sisal could be combined with certain combinations of high tensile strength fibers to form the supportive layers 1010, 1012.

In use, the first and second aramid material layers 1010, 1012 are preferably coated with a bonding layer 1010a, 1010b, 1012a, 1012b, preferably of the same material as the elastomeric material that facilitates bonding between the aramid layers 1010, 1012 and the elastomeric layer 1020, although these bonding layers are not required. Further, although equal amounts of the bonding layers 1010a, 1010b, 1012a, 1012b are shown on either side of the aramid layers 1010, 1012, the bonding layers 1010a, 1010b, 1012a, 1012b need not be evenly distributed over the aramid layers 1010, 1012.

The applicant has observed that the aramid layers 1010, 1012 distribute impact and vibration over a larger surface area of the elastomeric layer 1020. This finding has suggested using the material in heavier impact applications, such as using it as a motor mount 1030 or flooring 1035, 1037, since the aramid layers 1010, 1012 will discourage displacement of the elastomeric layer 1020, while still absorbing much of the vibration in those applications. This property could be useful in many of the above-noted applications, and in particular in impact absorbing padding, packaging, electronics padding, noise reducing panels, tape, carpet padding, and floor padding.

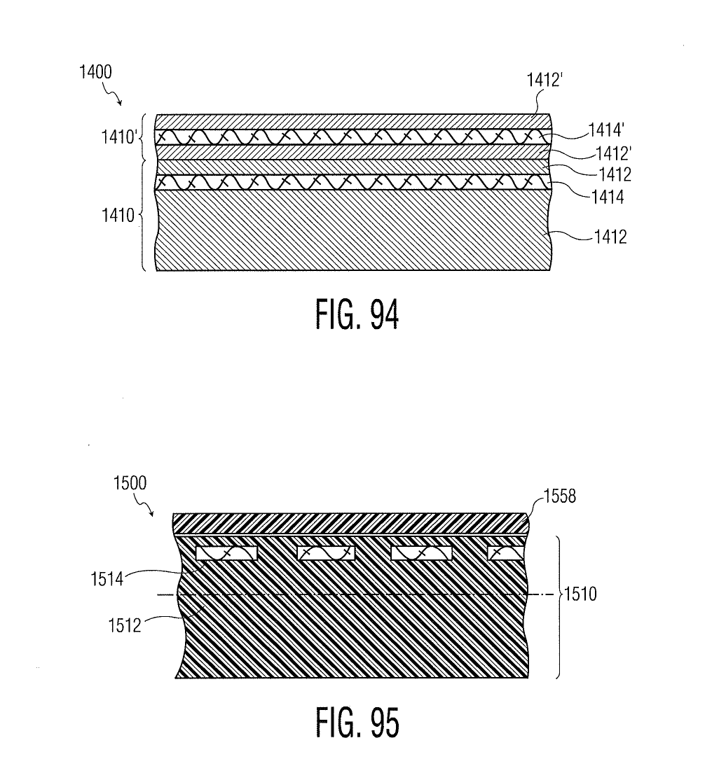

Exemplary padding materials 1400 and 1500, for example, but not limited to, body padding for athletic and military applications, are illustrated in FIGS. 94 and 95. In the embodiment illustrated in FIG. 94, the padding material 1400 includes a first vibration regulating material 1410 with a second vibration regulating material 1410′ secured thereto. The materials 1410 and 1410′ may be formed as integral materials or maybe formed separately and secured to one another, for example, using a suitable adhesive. The vibration regulating material 1410 is illustrated as including elastomeric layers 1412 and an intermediate reinforcement layer 1414 and the material 1410′ is also illustrated with elastomeric layers 1412′ and an intermediate reinforcement layer 1414′, however, either or both materials 1410, 1410′ may have different configurations as illustrated herein. If the intermediate layers 1414 and 1414′ each include woven fabrics, the materials may be rotated relative to each other such that the weaves are offset, for example, by forty-five degrees.

Laboratory tests were carried out at a prominent university to evaluate body padding in accordance with the material 1400. The material 1400 used in the testing comprised two layers of reinforcement material, each manufactured from woven Kevlar K-49, embedded within a respective elastomer layer manufactured from cured polyurethane. Each layer of woven Kevlar was approximately 3 mils thick and the polyurethane was applied to a total material thickness of 6 mm. Generally, as illustrated in FIG. 94 the inner most elastomeric layer 1412, which would be against the wearer's body, was the thickest layer. This material was compared against a paintball control vest of high density padding 6 mm thick.

In the testing, identical flat Aluminium plates were used with the different padding material pasted onto them. Nine impact locations were marked on the top. One end of the plate was firmly fixed to a work table with an overhang of about 75%. Accelerometer mounts were fabricated from Aluminum and mounted on the bottom of the plate near the middle. Uniaxial accelerometers from Bruel & Kjaer were used in the experiment. They are high precision sensors capable of measuring high level accelerations. These were connected to a Charged amplifier type 2635 which was in turn connected to a data acquisition front end (Module type 3109) which has a 25 KHz LAN interface module (type 7533) that was connected to the LAN port of a PC. The software used for data acquisition was Pulse Labshop version 10.2. There were three test runs for each case. The tests were run for impacts at nine locations.

After the raw data was collected computer programs were used to perform analysis on the effectiveness of the paddings. The top peak magnitude in the frequency spectrum was used as the performance criterion. Analyzing the results, the amplitude of vibration as measured by the accelerations were reduced in the inventive material versus the control material. It was also found that the peak frequency amplitudes, especially at resonant peaks, were reduced by the use of the inventive padding. Reductions in peak amplitudes were as much as 75% at the resonant frequencies.

In view of the results, it was determined that the inclusion of the second material 1410′, including a reinforcement layer 1414′ even without thick elastomer layers 1412′, provided an initial vibration dissipation layer which absorbed and dissipated a significant portion of the impact force, which thereby did not reach the first material 1410.

A padding material 1500 with an alternative initial vibration dissipation layer is illustrated in FIG. 95. The padding material 15400 includes a first vibration regulating material 1510 with a flexible sheet layer 1558 of high tensile material secured thereto. The materials 1510 and 1558 may be formed as integral materials or maybe formed separately and secured to one another, for example, using a suitable adhesive. The vibration regulating material 1510 is illustrated as including elastomeric layers 1512 and an intermediate reinforcement layer 1514. The sheet layer 1558 may be manufactured from various high tensile strength materials, for example, a thin sheet of polypropylene, preferably having a thickness of 0.025 mm to 2.5 mm. Either or both materials 1510, 1558 may have different configurations as illustrated herein.

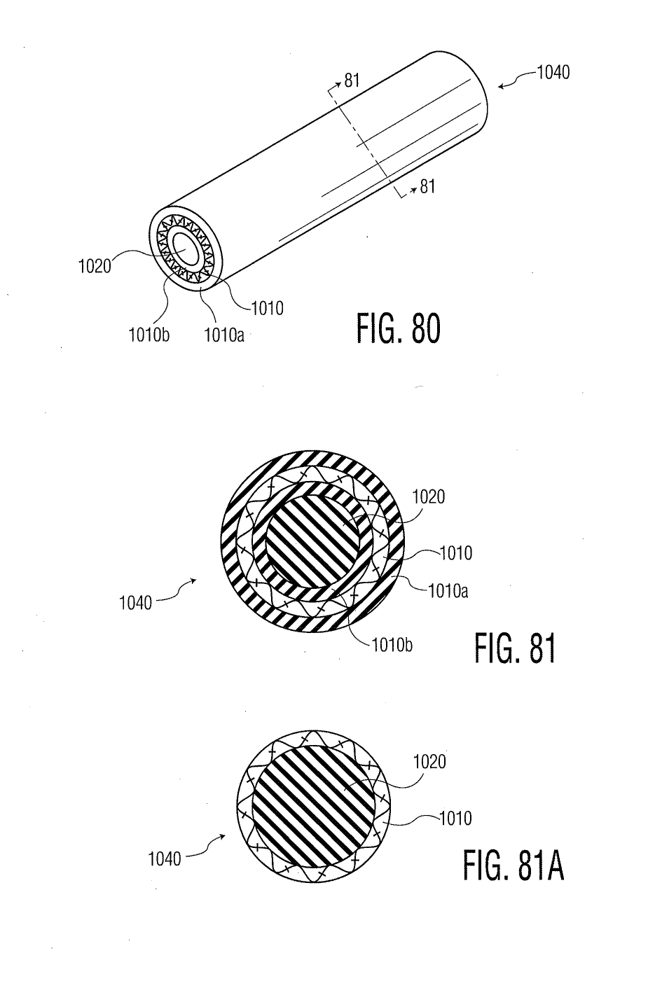

FIGS. 80, 81, 81a, and 87 show a variant of the material shown in FIG. 79, without the second layer of aramid 1012. The aramid layer 1010 could be coated with the bonding layer 1010a, 1010b or not.

In use, this material can be used as a flooring 1037, as shown in FIG. 87, as a spring in FIG. 81a, or also as a motor mount 1050. As a spring, shown in FIGS. 81 and 81a, the aramid layer 1010 contains and stabilizes the elastomeric layer 1020 when the generally shaped cylinder 1040 is in tension or compression. Such a spring could be used in any spring application.

In use as a motor mount, the material is formed as a cylinder 1040, in which the aramid layer 1010 forms an outer cylinder with an elastomer 1020 located therebetween. This cylinder 1040 is closed on itself (by gluing or welding) to form the toroidal shaped shock absorber 1050, which could be used as a motor mount.

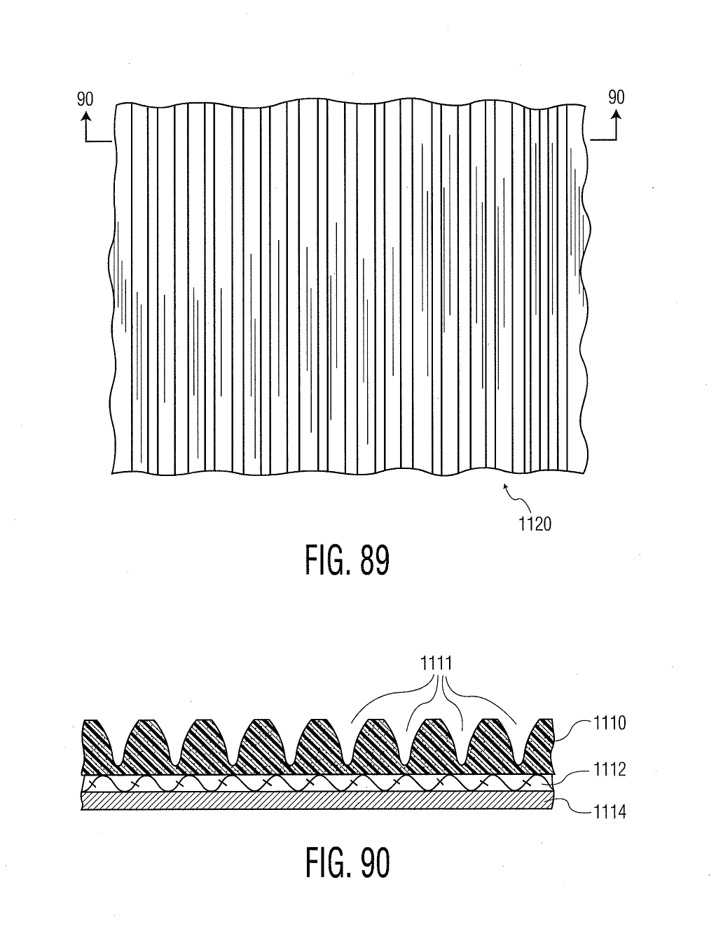

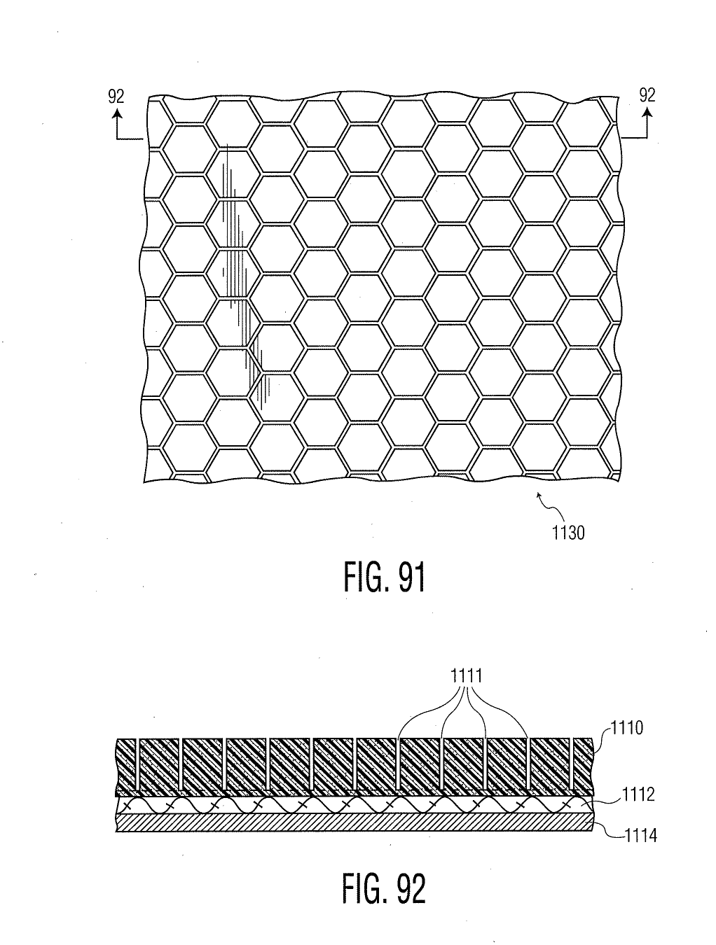

FIGS. 89-93 show another material for use with the invention. The cross-section of FIG. 90 shows the layers of the material, which comprise a foam layer 1110, aramid layer 1112, and elastomeric layer 1114. The foam layer 1110 of the present embodiment is a generally rigid layer of foam that the applicant has found is particular good at dissipating a point impact, and thus has been found particular suited for impact resistance, such as for example, as armor and protection in the sports of football, baseball, soccer, or paintball. It should be understood that the elastomeric layer 1114 is generally adjacent to, or substantially adjacent to the body being protected from impact.

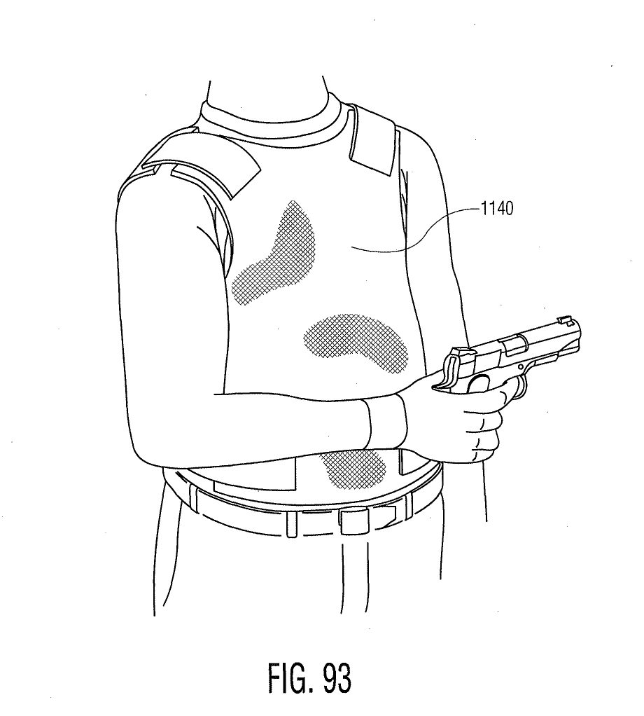

The foam layer 1110 of the present embodiment is preferably rigid and inflexible, although softer foam layers may be used. Additionally, as explained herein, the elastomer layers may be formed with a foamed structure. The rigid foam layers 1110 present a problem in that many impact-resistant applications require flexible material, i.e., paintball padding and armor that can flex around a person's body. The applicant solved this problem by forming narrow areas of weakness 1111 in the foam layer. These areas can be formed by cutting, stamping, or forming the area of predetermined weakness, but in any event, they allow for the foam layer 1110 to bend at these areas 1111. Various shapes of the areas of predetermined weakness could be used depending on the needed flexibility. As shown, parallel, hexagonal, and herringbone (diamond) areas are presently preferred. FIG. 93 shows an embodiment in which the paintball armor 1140 has the herringbone pattern.

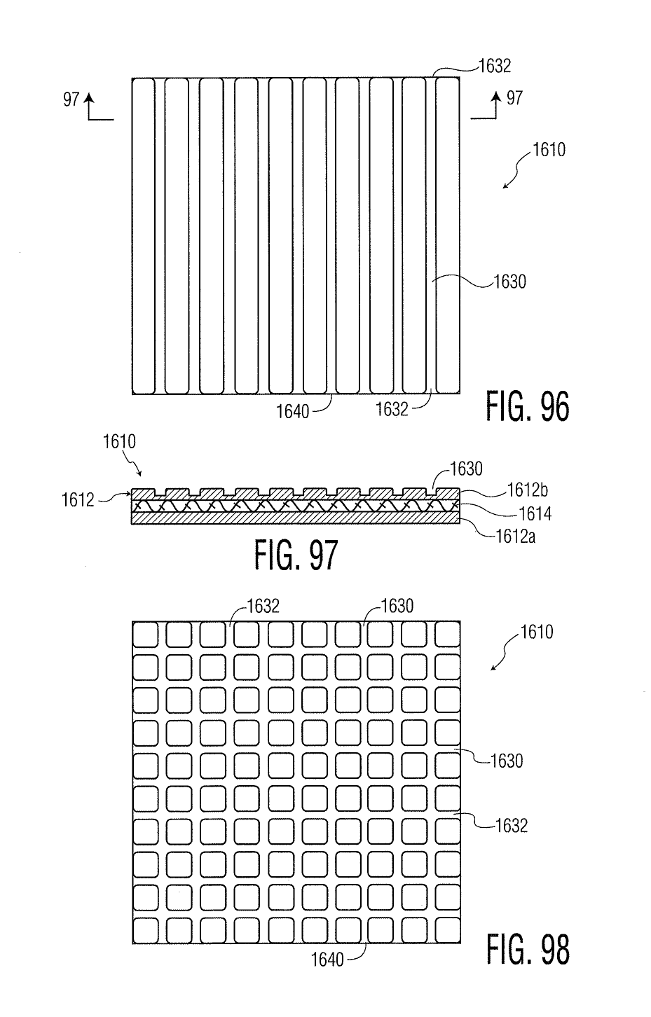

Similar patterns may be utilized in embodiments wherein one of the elastomer layers is a foamed or other structure to provide greater flexibility to the product and/or provide air flow. FIGS. 96-98 show illustrative materials 1610 wherein at least one elastomer layer includes a plurality of channels 1630. In each embodiment, the material 1610 includes an elastomer layer 1612, shown as distinct layers 1612a and 1612b, and an intermediate reinforcement layer 1614. The material 1610 may have other configurations as described herein. Channels 1630 are formed in the elastomer layer 1612b facing the user during use. In the embodiment of FIGS. 96-97, the channels 1630 extend parallel to one another. The material 1610 has a perimeter 1640 and each of the channels 1630 has end portions 1632 which extend to the perimeter 1640 and therefore provide inlets/outlets for the channels 1630, thereby promoting air flow. In the embodiment of FIG. 98, channels 1630 are provided horizontally and vertically, as illustrated in the drawing, and intersect one another. While each of the channels 1630 are illustrated with end portions 1632 along the perimeter 1640, some of the channels 1630 may terminate prior to the perimeter, with air flow still possible through the interconnected channels 1630. The applicant has also found that a fourth rigid layer comprising plastic, foam, or metal, could be added over the foam/aramid/elastomer to further dissipate impact energy.

Any of the above-mentioned layers could be soaked in, embedded in, encapsulated by, or otherwise distributed with a resistive fluid. Preferably, the resistive fluid layer is separated from the wearer/holder by at least one of the elastomer layers to minimize the direct transmission of impact to the wearer/holder.

Body armor is a frequently cited use of resistive fluids—such an application would work well with all of the vibration-reducing materials described herein because the vibration-reducing material would further protect the wearer from damaging vibration from an impact and puncture.

Illustrative resistive fluids include shear thickening fluids (STFs), or dilatants, and magnetorheological fluid (MRF).

Use as Soundproofing

The materials described herein can be used as soundproofing in many applications, for example, but not limited to: Industrial and Commercial Equipment; Heavy-Duty Machinery; Compressors, Generators, Pumps, Fans; Commercial Appliances and Equipment; HVAC Equipment; Precision Equipment/Electronics; Business Machines, Computers, Peripherals; Medical and Lab Equipment/Instruments; Telecommunications; Consumer Electronics And Appliances; Specialty Applications; Seating, Positioning, Pillows, Mattresses; Footwear; Athletic Equipment; Vehicle; Automotive and Truck; Marine and Aircraft; Bus, Coach, and RV; Personal Leisure Vehicles; Farm and Construction, Off-Highway.

The following description applies generally to many of the materials described above, but is specifically with reference to FIG. 1. The first elastomer layer 12A converts sound and vibrational energy waves into heat energy through hysteric damping, as most traditional damping materials do. As the energy waves travel through the elastomer 12A, they reach the end of the medium and interface with the high tensile strength fibrous material layer 14. The area of interface is commonly referred to as a boundary. The high tensile strength material 14 has the unique ability to radiate or carry the vibrational energy waves away from the point of entry, in addition to providing increased stiffness to the composite. Thus, when the plurality of high tensile strength fibers 18 are woven to form the cloth layer 16, vibrational energy that is not absorbed or dissipated by the first elastomer layer 12A is redistributed evenly along the material 10 by the cloth layer 16 and then further dissipated by the second elastomer layer 12B. This spreading of the energy waves over a large area by the high tensile strength fibrous layer 14, normally referred to as mechanical radiation damping, is what makes the composite so efficient at energy dissipation.

In addition to the mechanical radiation damping provided by the high tensile strength fibrous layer 14, the boundaries between the elastomer layers 12A and 12B and the high tensile strength fibrous layer 14 create several additional operative mechanisms for energy dissipation. These beneficial boundary effects include, but are not limited to reflection, transformation, dispersion, refraction, diffraction, transformation, friction, wave interference, and hysteric damping. The combination of these dissipation mechanisms working simultaneously results in a material with extremely efficient damping characteristics compared to traditional materials of the same or greater thickness.

The material 10 can include different numbers of layers, as well as varying orders of the layers compared to the base composite shown. Materials can be added to the composite such as sheet metal to aid in the absorption of specific frequencies and wave lengths of vibration energy or to add strength. Those of ordinary skill in the art will appreciate from this disclosure that the material 10 can be formed of two independent layers without departing from the scope of the present invention. Accordingly, the material 10 can be formed of a first elastomer layer 12A and a high tensile strength fibrous material layer 14, which may be woven into a cloth layer 16, that is disposed on the first elastomer 12A.

FIG. 104 shows a cross section of the use of one embodiment of the material 10 (understanding that any of the embodiments herein could be used) between a wall 20 of for example a room, and a stud 20A that the wall is mounted upon. (It should be understood that FIG. 104 is not necessarily drawn to scale). In FIG. 104, the material 10 acts to absorb, dissipate, and/or isolate vibrations through the wall 20 and thus minimize sound passage from one side of the wall 20 to the other.

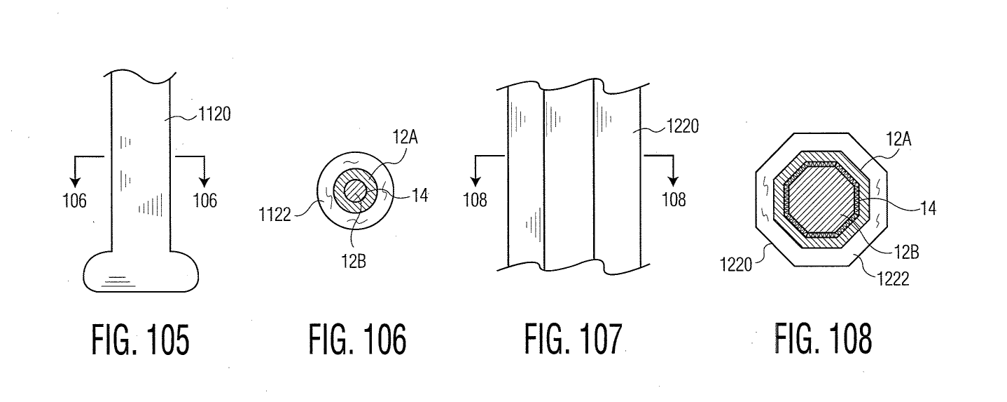

FIG. 105 is a partial side elevation of a baseball bat handle 1120. Any one of the appropriate combinations of the material embodiments described above can be inserted into the baseball bat handle 1120. Once inserted into the handle 1120 (as shown) or other sections of the bat, the material acts to both reduce vibration and sound travel through the bat. In the cross sectional view through the bat handle 1120 in FIG. 106, the material has the same cross section as that discussed with respect to FIG. 1, located within the handle's cross section 1122 that defines a cavity to contain the material 10.

FIGS. 107 and 108 show a similar elevation and cross section of a tennis racquet 1120 and its section 1222.

It should be understood that what is shown in FIGS. 105-108 are two possible configurations using the material within the handles of sporting apparatuses. Similar uses would be within golf club handles and heads, hockey sticks, lacrosse sticks, and the like. Outside of the sporting arena, the material could be used in hand or power tools or similar hand-gripped items.

Additional Use in the Prevention of Sports Injuries, Including Commotio Cordis

Certain embodiments described above and below are capable of providing at least protective equipment, garments, and the like (which may be referred to by collective terms and phrases herein throughout) that serve in the prevention of concussive effects on the heart, cardiopulmonary system, internal organs, and the like, by a received force. The concussive effects prevented by the disclosed embodiments may owe the provided functionality to the variety of layers that constitute the protective equipment, as well as the particular make-up, order and specification of the layers. These layers may have various constituents, various thicknesses, and may be provided in various combinations that may modify the performance of the protective equipment, but which are nevertheless covered by the disclosed embodiments. For example, although a high tensile strength fibrous material layer 14, such as an aramid layer, discussed herein may experience enhanced performance by having applied thereto an elastomeric coating 12a, 12b on both sides thereof, those of ordinary skill in the pertinent arts will appreciate in light of the discussion herein that such coatings 12a, 12b may be provided on only one side of the high tensile strength fibrous 14 layer or may be provided by various optional elastomeric components, or elastomeric combination in combination with other constituents or features, such as protective randomly distributed nanofibers and the like.

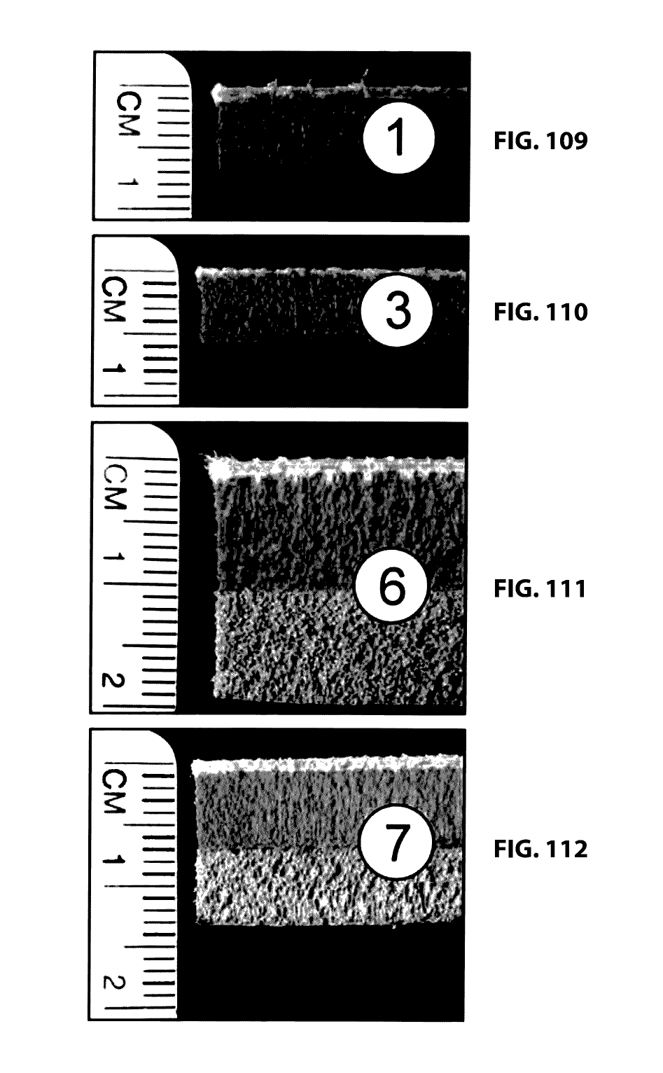

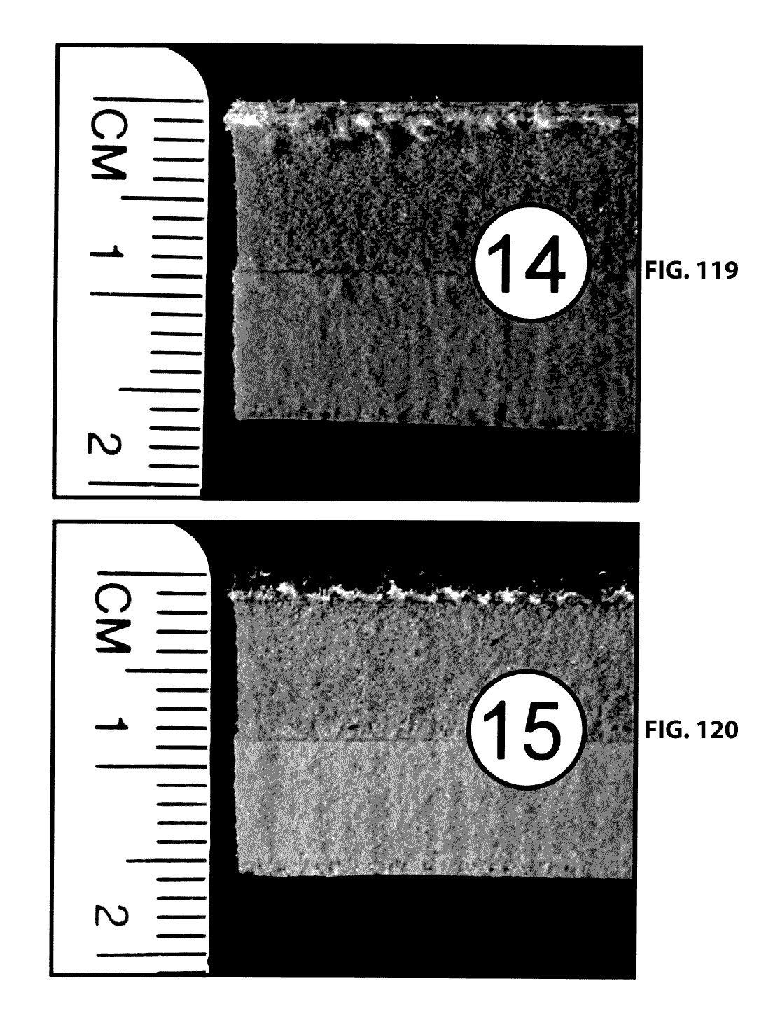

More specifically, a pad, panel, or multiple pads or panels, in addition to other arrangements (which may be referred to by collective terms or phrases herein throughout), may be provided that comprise the aforementioned coated high tensile strength fibrous layer or layers. These apparatuses, which may be hereinafter referred to collectively as panels, may, for example, include other layers in addition to a coated high tensile strength fibrous layer. For example, as set forth in FIGS. 109-120 multidurometer layer or layers, or such as may be formed of different durometer foams or multiple layers of foam of differing durometer, or memory foams, may be provided in association with a coated high tensile strength fibrous layer. By way of non-eliminating example, optimized performance may be achieved through the use of foam layer or layers having dual durometers, such as a high-density foam and low-density foam in combination. By way of example, a low-density foam aspect may have a density of twelve to thirty-two pounds and most particularly may have a density of twenty pounds per square yard, while a high-density foam may have a density of three to twelve pounds, and most particularly nine pounds per square yard. These multidensity foams may form a multidurometer layer that may serve to dissipate a received force, and which may, on a face of the protective pad the outermost foam layer, be physically associated with a coated aramid layer, which coated aramid layer may be most or least proximate in the protective equipment to the body. An exemplary arrangement may be wherein a nine-pound high-density foam forms the innermost layer of a panel, a thirty-one pound low-density foam forms a middle layer of the protective equipment, and a coated high tensile strength fibrous layer, such as an aramid, having a coating of elastomeric on both sides thereof forms the outermost layer of the protective equipment.

TABLE 1
Composition of the various chest protectors. Thicknesses of the different layers is
measured in mm.

| | | Airilon ® | | | ImpacShield ®, - | | | |
|---|---|---|---|---|---|---|---|---|
| | Accelleron ® | closed | Open | | multilayer | | | |
| | closed cell | cell low | cell | | semi-rigid | | No | |
| Chest | high density | density | memory | | polypropylene | No of | of | VF |
| protector | foam | soft foam | foam | TriDur ® | polymer | Impacts | VF | (%) |
| Control | | | | | | 80 | 43 | 54 |
| 1 | 6 | | | .35 | .33 | 33 | 11 | 33 |
| 3 | 6 | | | .35 | | 33 | 18 | 54 |
| 6 | 10 | 8 | | .35 | .33 | 25 | 2 | 8 |
| 7 | 6 | 6 | | .35 | .33 | 25 | 5 | 20 |
| 8 | 10 | 10 | | .35 | .33 | 20 | 4 | 20 |
| 9 | 10 | 10 | | .35 | .67 | 20 | 1 | 5 |
| 10 | | | 12 | .35 | | 20 | 10 | 50 |
| 11 | | | 12 | .35 | .33 | 15 | 9 | 60 |
| 12 | | | 12 | .35 | | 15 | 6 | 40 |
| 13 | 6 | | 8 | .35 | .33 | 15 | 9 | 60 |
| 14 | 10 | | 10 | .35 | .33 | 12 | 4 | 33 |
| 15 | 10 | | 10 | .35 | .67 | 12 | 5 | 42 |

As referenced above, and as illustrated in Table 1 [Test Results], the arrangement of FIGS. 109-120 may have the various layers thereof formed of different thicknesses and weights, with the varying layers, thicknesses and specifications dictating specific performance characteristics. By way of non-eliminating example, the multidurometer foam layer discussed herein may provide an eighty-four percent effective reduction in forces at a combined thickness of one-half inch, a ninety-percent effective reduction in forces at a combined thickness of three-quarters of an inch, and a ninety-five percent reduction at a combined thickness of one inch. Moreover, the coating thickness on the high tensile strength fibrous layer may vary in order to effectuate variations in performance, such as in the range of 1-3 ounces, such as 2.2 ounces, per square yard of an aramid material.

Additionally, other layers beyond those illustrated in FIGS. 109-120, may be included. For example, additional shielding may be provided at the innermost layer of a panel closest to the body, or at the outmost layer closest to the received force, in order to further shield the body from the received force. Such additional shielding may, by way of non-limiting example, comprise a single or multilayer semi-rigid or rigid polypropylene polymer. This additional layer may have a thickness, by way of non-limiting example, in the range of 0.20-1 mm, and more particularly in the range of 0.35-0.67 mm.

Yet further, the thicknesses of layers independently, as well as in combination, may be varied in certain circumstances. For example, protective equipment having panels inclusive of a multi-durometer layer, may, in certain environments, preferably have minimal thickness. For example, in the event a panel is to be inserted into a helmet, such as in a pliable helmet insert, the desired total thickness of the embodiments described in FIGS. 109-120 may be approximately four millimeters, or more preferably, in the range of three millimeters to six millimeters.

Because the disclosed embodiments may provide multidurometer layers, such as including high-density and low-density foams, which may correspondingly comprise high durometer and low durometer foams, energy absorption and/or dispersion of the provided panels is optimized. However, because of the high level of deformation suffered by low-density foam, equipment employing only low-density foam compresses so significantly at impact that it does little prevent concussive effect on the body. The disclosed embodiments provide significant comfort even including the use of a high-durometer, such as a four durometer foam, such as in the six to nine pound density range, in part because the high-durometer foam is used in combination with the low-durometer foam such that the thickness of the high-durometer foam is minimized. That is, the disclosed embodiments provide appreciably improved performance through the use of combination of foam densities, i.e., optimal performance is achieved by combining foams of different, specific densities in specific orders.

Moreover, certain of the layers provided in association with the disclosed protective equipment may have preferred characteristics due to the nature of the remaining layers. By way of non-eliminating example, elastomeric layers 12a,12b provided over the high tensile strength fibrous layer portions specifically may be colored, due to the damage that light can inflict on aramid performance. Yet further, the presence of particular layers may indicate the non-presence of other layers. For example, multiple high-density foam layers may be operationally less desirable than a multi-durometer layer disclosed herein, such as because only single or singular frequencies of impact force may be eliminated by multiple layers having similar or the same uniformity. Further, overly thick coating layers in association with the high tensile strength fibrous layer, and/or multiple high tensile strength fibrous layers, may be undesirable because forces to be dissipated are instead trapped between layers and allowed to oscillate rather than dissipate. Still further, the order of particular layers in the protective equipment discussed herein may indicate the placement or order of other layers. For example, performance may be degraded significantly if the coated high tensile strength fibrous layer is placed in the outermost portion, i.e., most adjacent to the impact, of the disclosed panels.

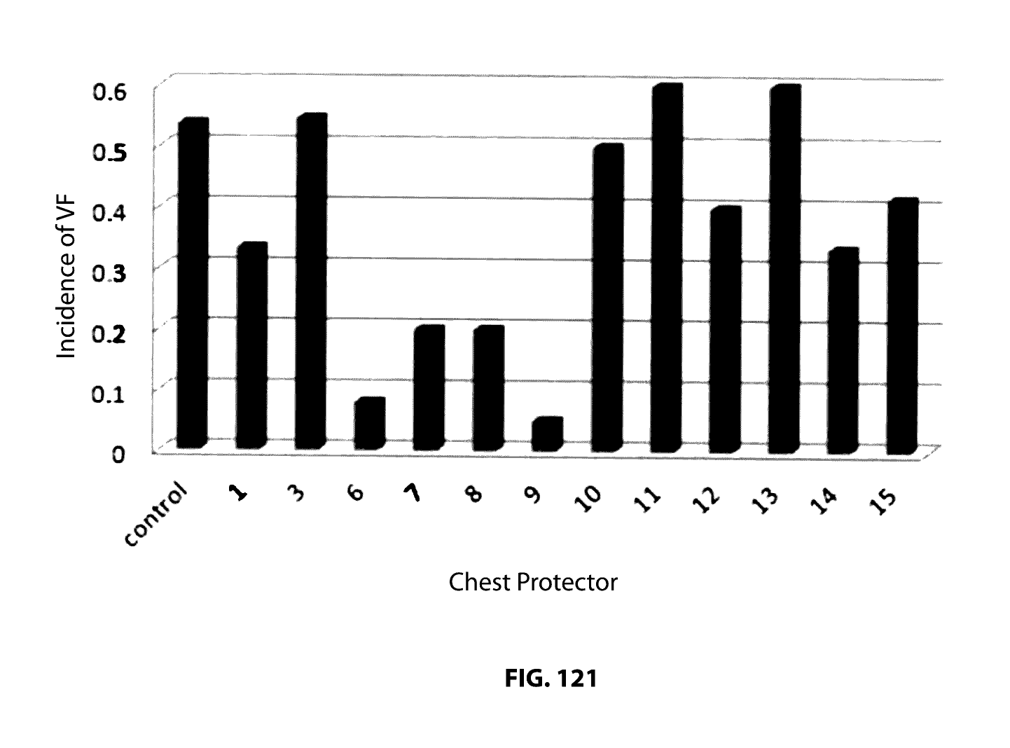

Particular embodiments of the disclosed invention, shown for example in FIGS. 109-120, were tested at the Tufts Medical Center with regard to their potential effectiveness in preventing sudden cardiac death by chest wall impact (i.e. commotio cordis) in sports. Multiple studies were performed on various combinations, compositions and thicknesses of 4 inch by 4 inch panels comprised of the materials described herein, including closed cell high density foam, closed cell low density soft foam and open cell memory foam, that were adhered to a flexible elastomeric coated aramid that was bonded to a semi-rigid polypropylene polymer. The results of these studies is presented in Table 1, above, and FIG. 121.

Although prior studies of commercially available chest wall protectors failed to prevent ventricular fibrillation (VF), this study demonstrated that it is reasonable to expect that chest protector designs incorporating embodiments of the present invention to be effective in the prevention of commotion cordis on the playing field. To conduct the study, juvenile male swine, 12 to 16 weeks old and weighing 15 to 25 kg were sedated and then anesthetized. Left ventricular pressure catheters were placed in the left ventricle and the animals were then positioned prone in a sling to approximate physiologic blood flow and cardiac hemodynamics. Chest wall impact was produced by a lacrosse ball mounted on a lightweight aluminum shaft. The impact object was directed, with echocardiographic guidance, to strike the animal perpendicular to the chest wall, directly over the center of the heart during the vulnerable time window for VF. All impacts were at 40 mph and impacts outside of the necessary time window were excluded from analysis. The study assessed the outcome of four sequential and iterative series of experiments grouped around sets of chest protectors. Primary endpoint was the incidence of VF with chest wall strikes and secondary endpoints included a combined endpoint of VF and nonsustained VF, ST segment elevation, and peek LV pressure and LV dP/dT produced by ball impact.

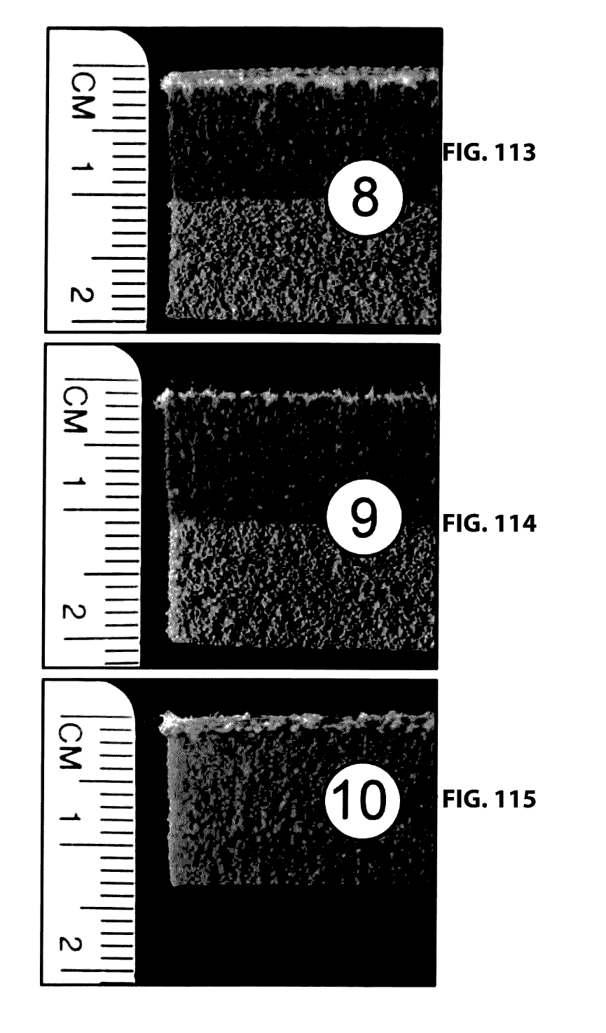

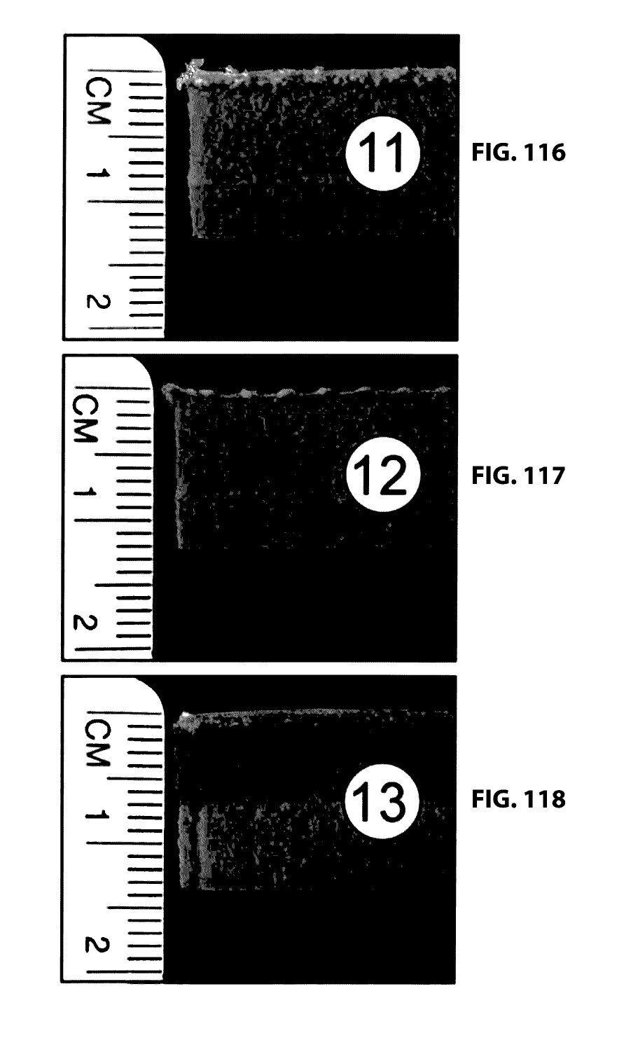

Unexpectedly, whereas prior studies conducted on commercially available chest protectors for at least baseball and lacrosse were not found to reduce the risk of VF, chest protector designs incorporating embodiments of the invention described herein were found to likely be effective in the prevention of commotio cordis on the playing field. Twelve embodiments of the present invention, in the form of 4 inch by 4 inch squares were tested versus a control, wherein impacts were administered to swine without a chest protector. In the control, wherein impacts were administered to swine without a chest protector, VF was caused in 43 of 80 impacts (54%). Four chest protectors (numbers 6 (FIG. 111), 7 (FIG. 112), 8 (FIG. 113) and 9 (FIG. 114) significantly decreased the incidence of VF with ball impacts, including number 9 (FIG. 114) (21 mm thickness) which as seen in FIG. 121 reduced the incidence of VF down to 5%. Chest protectors 6 (FIG. 111) (19 mm thickness), 7 (FIG. 112) (12 mm thickness) and 8 (FIG. 113) (21 mm thickness) reduced the VF incidence to 8%, 20% and 20% respectively, as shown in FIG. 121. All four chest protectors contained the same materials—semi rigid polypropylene polymer, flexible coated aramid, closed cell high density elastomer and closed cell, low density elastomer. After adjustment for animal weight, three chest protectors (6 (FIG. 111), 8 (FIG. 113) and 9 (FIG. 114 remained significant. As shown in FIG. 121, chest protector 9 (FIG. 114) had the lowest incidence of VF (5%), compared to control impacts of 56%. All chest protectors except numbers 1 (FIG. 109) and 3 (FIG. 110) lowered the peak LV pressure induced by the impact to 398 mmHg to 490 mmHg (unadjusted p-values from <0.0001 to 0.04). After adjustment for weight for chest protectors 6-8 (FIGS. 113-113) and 11-15 (FIGS. 116-120), the reduction remained significant. In control impacts the change in pressure over time (dP/dT) was 365. All chest protectors except 1 (FIG. 109), 3 (FIG. 110) and 10 (FIG. 115) significantly reduced the dP/dT. After adjustment for weight only chest protectors 9 (FIG. 114) and 11-15 (FIGS. 116-120) remained significant.

As shown in FIG. 121, four samples, varying in thickness, of semi rigid polypropylene polymer (of 0.35 and 0.67 mm thickness), flexible coated aramid, closed cell high density elastomer and closed cell and low density elastomer statistically reduced VF compared to no chest protector. As shown in FIG. 121, the maximal texted thickness combination reduced the incidence of VF from 54% to 5% and two thinner combinations of the same materials reduced VF compared to no chest protector. As further seen in FIG. 121, nine protectors did not significantly reduce VF.

As demonstrated, in a method of selecting a preferred make-up of a multi-layer, multidurometer material that may include multiple layers of foam with different durometers, a coated high tensile strength fibrous layer, and optionally a rigid polyurethane layer, the selection of the durometers and thicknesses of the foam and aramid layers may be in a manner that effectively dissipates a broad spectrum of frequencies of received force. Or, the durometers or thicknesses of the foams and the high tensile strength fibrous layer may be selected to dissipate a specific range of frequencies of received force.

Those skilled in the art will appreciate that various different aramids may be employed based upon the desired protective effects. For example, Kevlar K49 may be employed to optimize vibration absorption; K79 may be employed to minimize stabbing forces; and K29 and K129 may be provided to maximize protection again point impact or ballistics forces.

Those skilled in the art will also appreciate various particular embodiments that may be indicated by the aspects discussed herein. For example, the disclosed protective equipment may be included in an athletic shirt, which may be lightweight and/or have wicking properties, and wherein such wicking properties do not adversely affect the performance of the high tensile strength fibrous layer, at least in part due to the presence of the coating on the layer; the protective equipment may comprise an athletic chest protector, such as may be used in lacrosse, cricket, baseball, football, soccer, softball, or the like; or the protective equipment may be provided as a wearable harness, such as through the use of Velcro straps or the like. The protective aspects may be stitched into equipment or garments, inserted into pre-formed pouches, or otherwise integrated with wearable items. The protective equipment may further be utilized in athletic helmets or headbands, such as for example baseball, football, soccer, lacrosse, or the like.

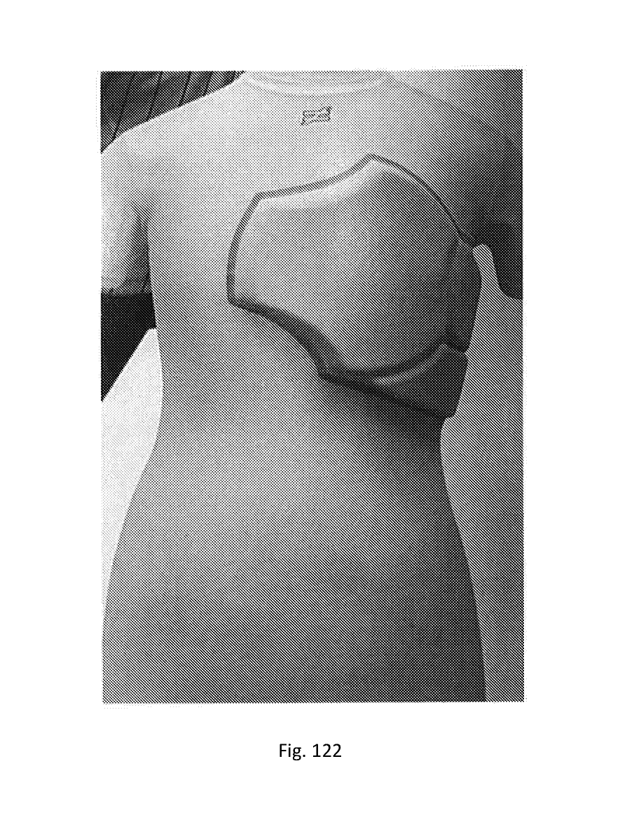

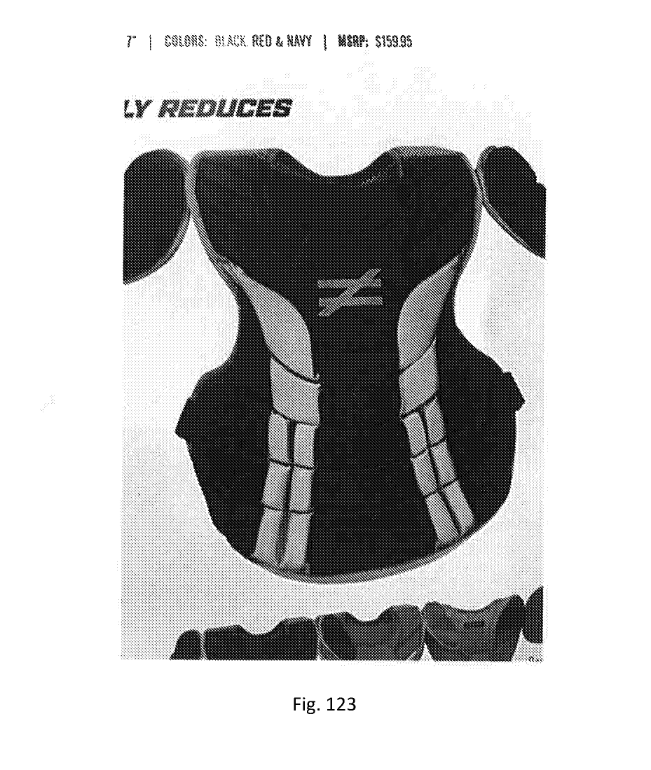

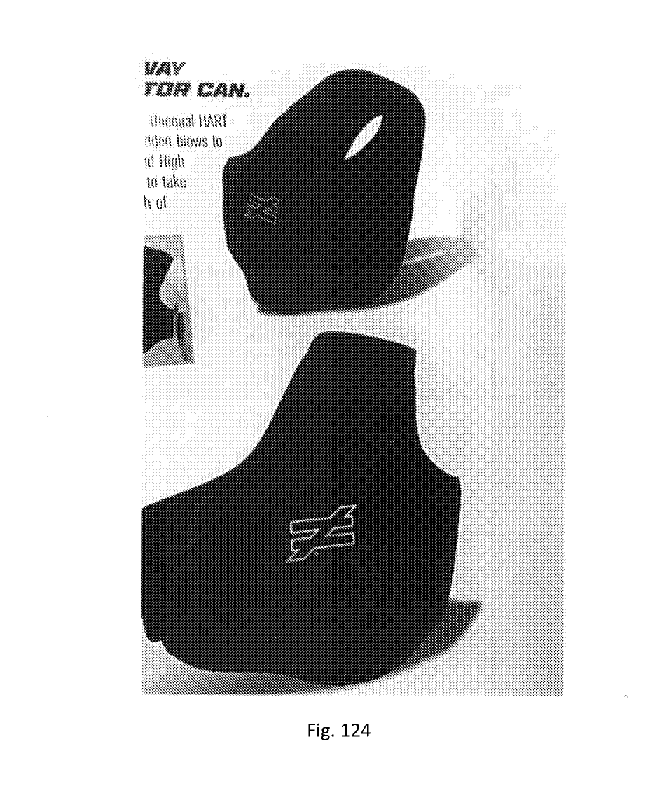

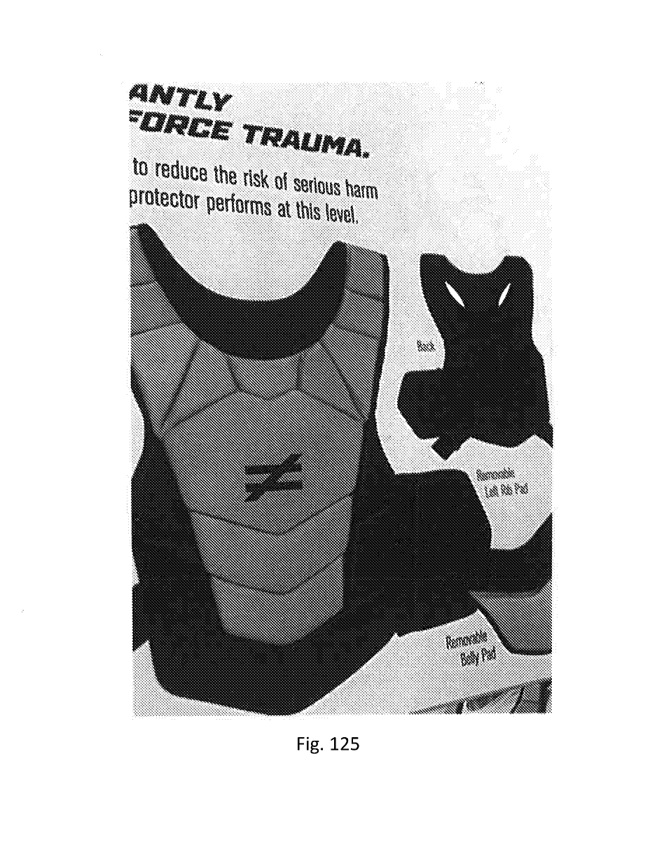

Additionally, a single pad or a panel may be provided, as may be multiple pads or panels, such as in an interlocking format, such as in order to optimize flexibility and mobility in various contexts. By way of non-eliminating example, FIG. 122 illustrates protective equipment for association with an athletics shirt, such as may be worn by a baseball pitcher, in which three panels are interlocked within a sports shirt in order to allow maximum mobility for the athlete wearing the shirt.

More particularly, and as illustrated in FIG. 122, the disclosed heart protective panel/padding system may be incorporated into an upper garment, such as a shirt. By way of non-limiting example, the shirt may be for use as an under garment, and/or may thus be of a t-shirt profile, a unitard profile, a sleeveless shirt profile, or the like. Of course, the shirt may also be an over-garment, such as a t-shirt, long sleeve shirt, sweatshirt, tank shirt, or the like. As shown and discussed in further detail herein throughout, the pads may be sized and shaped so as to allow optimal body movement when wearing the shirt having the padded system therein, at least in that the pads may be “fitted” in such a manner so as to correspond to each other and to the musculoskeletal groups of the area of the body over which the padding is to be placed, i.e., over the cardiovascular front and side areas. Additionally, the profile of the interlocking fitted padding shown is exemplary only, that is, for example, other interlocking methods may be used, other numbers of pads may be used, and so on.

Yet further, where the number of pads in the cardiovascular padding system is greater than one, as shown, various pads of the cardiovascular protection system embodiment may be formed of differing materials, as may be the cardiovascular pads in relation to other pads in a protective garment; that is, the individual pads of a multi-pad system may not all share the same material/size/shape profile. Those skilled in the art will further appreciate that, in a multiple panel and/or interlocking panel context, all panels may not be uniform in size or shape, and different ones of the panels may be provided differently in order to optimize protective coverage. By way of non-eliminating example, the two smaller more rectangular pads shown in the three panel combination of FIG. 122 may be separately provided from the larger protective panel shown in that figure. For example, the two “side” panels may be provided via a Velcro feature, wherein, a catcher's chest protector, the two side panels may be Velcroed onto a chest protector including the larger panel, and wherein the location of such attachment may vary in order to best protect the wearer's heart. Accordingly, chest protectors and like equipment having an integrated protective pad or pads may have additional detachable protective equipment pads that further protect side or other portions of the body, and such detachable pads may be connectable via Velcro, snaps, zippers, or like detachable features.

Moreover, the pads may be in the lowest profile format that functions for a given context, i.e. the pads may be of the minimal depth allowable to protect the cardiovascular system, such as so as to provide optimal performance in protection from commotio cordis. Accordingly, the material profile of individual pad layers may be optimally selected, as discussed herein throughout, so as to minimize the total depth of one or more of the pads. Further, and in order to minimize the profile of the pads, the shirt and/or pocket into which the pads are placed may be substantially fitted to the torso of the wearer, either uniquely to a given user or generally to categories of user body types, so as to minimize the depth profile of the pads with regard to the body of the wearer. A shirt, such as that illustrated in FIGS. 123-125, may be employed for, by way of non-limiting example, baseball, lacrosse, or martial arts, such as in order to prevent a blow to the cardiovascular system from a ball, a stick, a bat, a fellow player, or the like.

FIG. 123 illustrates with particularity a chest protector, such as may be worn during baseball or softball competitions. In the illustration, the center pad, i.e., the large pad at the upper middle of the chest protector, may provide commotio cordis protection. Further, only select, discrete units of padding elsewhere in the chest protector, such as the pads labeled 503 and 504, may also be formed using the materials discussed herein so as to optimally prevent commotio cordis. The remaining pads in the chest protector may have a different makeup, such as low density foam, to allow for decreased expense of the overall chest protector. The chest protector illustrated may be formed of a material so as to allow comfortable use during athletic activities. For example, the chest protector may include flex points of decreased or no protective padding, both to allow for the interlocking of the commotio cordis padding discussed throughout, and additionally to improve performance of other discrete aspects of padding throughout the chest protector, such as to allow for optimal movement.

FIG. 124 illustrates a padding system that may be worn, for example, over or under other clothing of the user. In the exemplary embodiment of FIG. 124, the padding system is provided within a “sling” format, wherein two Velcro attachments may secure the padding system both around the torso and over the shoulder. The skilled artisan will appreciate, in light of the discussion herein, that other manner of securing the padding system to the body may be used. Moreover, in the illustration, additional interlocking pads are not shown fitted to the large central pad, although such interlocking pads may be present as discussed herein throughout.

Of note, a Velcro attachment or other means may allow for adjustability of the exemplary padding system, such as to allow for the padding system to consistently be placed over the cardiac area of the user. The illustrated pad may be useful in, for example, baseball, lacrosse, martial arts, or other sports where there is danger to the cardiac area. Yet further, and as is the case with other pads disclosed throughout, such as the t-shirt based padding system, the low profile of the exemplary padding system may allow for the padding system to be worn under other padding systems, such as under chest and shoulder pads for football, by way of non-limiting example.

Those skilled in the art will appreciate, for example, that other connection aspects may be provided as mentioned above. For example, so called hook and eye connectors may be present, string/lacing connectors that may be tightened may be present, or the like. Further, the padding system may be formed so as to allow for optimal use during sports. For example, the fabric used to maintain the padding system may be lightweight and breathable, such as with a mesh backing, to keep players cool and dry. Accordingly, wicking material may additionally or alternatively be used.

FIG. 125 illustrates an alternative embodiment of a chest protector padding system. The illustrated embodiment uses aspects of other embodiments, such as a chest protector having a significant central pad, with interlocked secondary “rib” protector pads, in conjunction with variable attachment mechanisms. In the illustration, a multi-Velcro strap system is shown, although the skilled artisan will appreciate that a hook and eye system, an elastic or string tightening system, or like system may be used.

In additional and alternative embodiments, any equipment comprised of the layers discussed herein throughout may additionally be comprised of other layers or protective aspects. By way of non-limiting example, a chest protector may include a pad or pads in accordance with the disclosed aspects only in physical locations correspondent to a prospective commotio cordis event, and may have known, i.e., low density, foam types at other portions of the chest protector, as would be typical of chest protectors in the known art.

It is recognized by those skilled in the art, that changes may be made to the above-described embodiments of the invention without departing from the broad inventive concept thereof. For example, the material 10 may include additional layers (e.g., five or more layers) without departing from the scope of the claimed present invention. It is understood, therefore, that this invention is not limited to the particular embodiments disclosed, but is intended to cover all modifications which are within the spirit and scope of the invention as defined by the appended claims and/or shown in the attached drawings.

1. A force dispersing pad adapted for inclusion in an article of protective gear for a user, said pad comprising:
an outer perimeter and multi-layer composite configuration comprising:
a first elastomeric layer;
a second elastomeric layer; and
a reinforced elastomeric composite suitable to dissipate and redirect energy, comprising: a high tensile strength fibrous material, wherein the high tensile strength fibrous material defines a major material surface, disperses energy to facilitate energy dampening and is generally non-elastic in a direction generally perpendicular to the major material surface; and a third elastomeric material layer that is coupled to and substantially contiguous with a first side of the high tensile strength fibrous material.

2. The force dispersing pad of claim 1, wherein the reinforced elastomeric composite further comprises a fourth elastomeric material layer that is coupled to and substantially contiguous with a second side of the high tensile strength fibrous material.

3. The force dispersing pad of claim 2, wherein the third and fourth elastomeric materials are selected from the group consisting of polyurethane, urethane rubbers, silicone rubbers, nitrile rubbers, butyl rubbers, acrylic rubbers, natural rubbers and styrene-butadiene rubbers.

4. The force dispersing pad of claim 1, wherein the first and second elastomeric layers are comprised of a closed cell foam.

5. The force dispersing pad of claim 1, wherein the first elastomeric layer is comprised of a high density, closed cell foam and the second elastomeric layer is comprised of a low density, closed cell foam.

6. The force dispersing pad of claim 5, wherein the first elastomeric layer is between 8 mm and 10 mm in thickness and the second elastomeric layer is between 8 mm and 10 mm in thickness.

7. The force dispersing pad of claim 1, wherein the pad further comprises a rigid outer layer that comprises a major material surface and distributes energy in a direction generally parallel to the material surface of the rigid outer layer.

8. The force dispersing pad of claim 8, wherein the rigid outer layer is between 0.30 and 0.70 mm in thickness.

9. The force dispersing pad of claim 1, wherein said pad is configured for inclusion into an article of protective gear selected from the group consisting of shirt, pant, shorts or wearable chest protector.

10. The force dispersing pad of claim 1, wherein the high tensile strength fibrous material of said pad is selected from the group consisting of aramid fibers or fiberglass.

11. The force dispersing pad of claim 1, wherein the aramid fibers comprise KEVLAR.

12. A force dispersing pad adapted for inclusion in an article of protective gear for a user, said pad comprising:
an outer perimeter and multi-layer composite configuration comprising:
a first elastomeric layer comprised of a closed cell foam;
a second elastomeric layer comprised of a closed cell foam;
a reinforced elastomeric composite suitable to dissipate and redirect energy, comprising: a high tensile strength fibrous material, wherein the high tensile strength fibrous material defines a major material surface, disperses energy to facilitate energy dampening and is generally non-elastic in a direction generally perpendicular to the major material surface; a third elastomeric material layer that is coupled to and substantially contiguous with a first side of the high tensile strength fibrous material, and a fourth elastomeric layer that is coupled to and substantially contiguous with a second side of the high tensile strength fibrous material.

13. The force dispersing pad of claim 12, wherein the third and fourth elastomeric materials are selected from the group consisting of polyurethane, urethane rubbers, silicone rubbers, nitrile rubbers, butyl rubbers, acrylic rubbers, natural rubbers and styrene-butadiene rubbers.

14. The force dispersing pad of claim 12, wherein the first elastomeric layer is comprised of a high density closed cell foam and the second elastomeric layer is comprised of a low density closed cell foam.

15. The force dispersing pad of claim 12, wherein the first elastomeric layer is between 8 mm and 10 mm in thickness, the second elastomeric layer is between 8 mm and 10 mm in thickness and the high tensile strength fibrous material layer combined with the third and fourth elastomeric layers is between 0.33 and 0.38 mm in thickness.

16. The force dispersing pad of claim 12, wherein the pad further comprises a rigid outer layer that comprises a major material surface and distributes energy in a direction generally parallel to the material surface of the rigid outer layer.

17. The force dispersing pad of claim 16, wherein the rigid outer layer is between 0.30 mm and 0.70 mm in thickness.

18. The force dispersing pad of claim 16, wherein the rigid outer layer is between 0.30 mm and 0.70 mm in thickness, the first elastomeric layer is between 8 mm and 10 mm in thickness, the second elastomeric layer is between 8 mm and 10 mm in thickness and the high tensile strength fibrous material layer combined with the third and fourth elastomeric layers is between 0.33 mm and 0.38 mm in thickness.

19. The force dispersing pad of claim 12, wherein said pad is configured for inclusion in an article of protective gear selected from the group consisting of shirt, pant, shorts or wearable chest protector.

20. The force dispersing pad of claim 12, wherein the high tensile strength fibrous material of said pad is selected from the group consisting of aramid fibers or fiberglass.

21. The force dispersing pad of claim 12, wherein the aramid fibers comprise KEVLAR.

22. A force dispersing pad adapted for inclusion in an article of protective gear for a user, said pad comprising:
an outer perimeter and multi-layer composite configuration comprising:
a rigid outer layer, wherein the rigid outer layer comprises a major material surface and distributes energy in a direction generally parallel to the material surface of the rigid outer layer;
a first elastomeric layer comprised of a closed cell, high density foam;
a second elastomeric layer comprised of a closed cell, low density foam;
a reinforced elastomeric composite suitable to dissipate and redirect energy, comprising: a high tensile strength fibrous material, wherein the high tensile strength fibrous material defines a major material surface, disperses energy to facilitate energy dampening and is generally non-elastic in a direction generally perpendicular to the major material surface; a third elastomeric material layer that is coupled to and substantially contiguous with a first side of the high tensile strength fibrous material, and a fourth elastomeric layer that is coupled to and substantially contiguous with a second side of the high tensile strength fibrous material.

23. The force dispersing pad of claim 22, wherein the third and fourth elastomeric materials are selected from the group consisting of polyurethane, urethane rubbers, silicone rubbers, nitrile rubbers, butyl rubbers, acrylic rubbers, natural rubbers and styrene-butadiene rubbers.

24. The force dispersing pad of claim 22, wherein the first elastomeric layer is between 8 mm and 10 mm in thickness, the second elastomeric layer is between 8 mm and 10 mm in thickness and the high tensile strength fibrous material layer combined with the third and fourth elastomeric layers is between 0.33 mm and 0.38 mm in thickness.

25. The force dispersing pad of claim 22, wherein the first elastomeric layer is between 8 mm and 10 mm in thickness and the second elastomeric layer is between 8 mm and 10 mm in thickness.

26. The force dispersing pad of claim 22, wherein the rigid outer layer is between 0.30 mm and 0.70 mm in thickness.

27. The force dispersing pad of claim 22, wherein the rigid outer layer is between 0.30 mm and 0.70 mm in thickness, the first elastomeric layer is between 8 mm and 10 mm in thickness, the second elastomeric layer is between 8 mm and 10 mm in thickness and the high tensile strength fibrous material layer combined with the third and fourth elastomeric layers is between 0.33 mm and 0.38 mm in thickness.

28. The force dispersing pad of claim 12, wherein said pad is configured for inclusion into an article of protective gear selected from the group consisting of shirt, pant, shorts or wearable chest protector.

29. The force dispersing pad of claim 12, wherein the high tensile strength fibrous material of said pad is selected from the group consisting of aramid fibers or fiberglass.

30. The force dispersing pad of claim 12, wherein the aramid fibers comprise KEVLAR.
